(19) United States
(12) Patent Application Publication
(10) Pub. No.: US 2023/0028318 A1
(43) Pub. Date: Jan. 26, 2023

(54) FLUOROGENIC AMINO ACIDS

(71) Applicant: President and Fellows of Harvard College, Cambridge, MA (US)

(72) Inventors: Erkin Kuru, Cambridge, MA (US); Jonathan Rittichier, Cambridge, MA (US); George M. Church, Cambridge, MA (US)

(73) Assignee: President and Fellows of Harvard College, Cambridge, MA (US)

(21) Appl. No.: 17/774,095

(22) PCT Filed: Nov. 6, 2020
(86) PCT No.: PCT/US2020/059373

§ 371 Date: May 3, 2022

Related U.S. Application Data
(60) Provisional application No. 62/932,961, filed on Nov. 8, 2019.

(51) Int. Cl. C09B 55/00; C09B 11/06; C09B 11/12; C09B 23/04; C09B 57/00

(52) U.S. Cl. CPC C09B 55/002; C09B 11/06; C09B 11/12; C09B 23/04; C09B 57/00

(57) ABSTRACT

Provided herein are compounds (i.e., fluorogenic amino acids (FgAAs), e.g., compounds of Formulae (I), (II), (III), and (IV)) that can be used in fluorescent labeling of biomolecules (e.g., proteins) and/or cells. Also described herein are methods of labeling and detecting biomolecules and/or cells by incorporating the FgAA compounds described herein into the biomolecules and/or cells (e.g., by enzymatic incorporation). Also provided herein are biomolecules, cells, compositions, and kits comprising the FgAA compounds described herein.

### RELATED APPLICATIONS

This application claims priority under 35 U.S.C. § 119(e) to U.S. Provisional Patent Application, U.S. Ser. No. 62/932,961, filed Nov. 8, 2019; the entire contents of which is incorporated herein by reference.

### GOVERNMENT SUPPORT

This invention was made with government support under DE-FG02-02ER6344 awarded by the Department of Energy. The government has certain rights in the invention.

### BACKGROUND OF THE INVENTION

Advances in imaging and labeling technologies, such as the adaptation of fluorescent protein (FP) fusions to label and track proteins in vivo, have consistently transformed basic biological and medical sciences. Recent improvements in optical imaging technologies allow for spatiotemporal tracking of single proteins in live cells, but this effort remains limited by the substantial size, slow kinetics, and specific maturation requirements of current fluorogenic protein labels.

To address these challenges, small, rapidly-maturing labeling reagents have been developed for labeling biomolecules and other macromolecules. The central problem of such biomolecular labeling approaches, however, is the high background signal originating from unbound probes. In contrast, small probes that activate, or “turn on,” only upon incorporation into biomolecules or macromolecules, solve this problem by minimizing or eliminating the background noise of the compounds. Sometimes known as fluorescent molecular rotors (FMRS), these fluorophores have an emission intensity that is sensitive to the ability of the environment the fluorophore is in to restrict bond rotation (sometimes referred to as “spatial hindrance”). These probes allow monitoring biomolecules and cells in real time and with minimal perturbation. Therefore, these designs have applications in diverse areas, including in protein and cellular imaging.

### SUMMARY OF THE INVENTION

New fluorogenic amino acids (FgAAs) based on the fluorescent molecular rotor (FMR) concept described above have important application in biomolecular/cellular detection and imaging. As an example, fluorogenic amino acid (FgAAs) FMRS have been described for labeling biomolecules in bacterial cell walls. See, e.g., Hsu et al. “Fluorogenic D-amino acids enable real-time monitoring of peptidoglycan biosynthesis and high-throughput transpeptidation assays” Nature Chemistry 2019, 11, 335-341. These fluorogenic amino acids have been incorporated, for example, into the peptidoglycan (PG) layer of bacterial cell walls via transpeptidation and used to visualize and detect the cells. In one aspect, provided herein are new fluorogenic amino acids (FgAAs) that can be used in biomolecular/cellular detection and imaging.

Provided herein are compounds (i.e., fluorogenic amino acids (FgAAs), e.g., compounds of Formulae (I), (II), (III), and (IV)) that can be used in the fluorescent labeling of biomolecules (e.g., proteins) and/or cells. In certain embodiments, the fluorescent properties of the compounds are activated when the compounds are spatially constrained (i.e., when internal bond rotations of the compounds are restrained). For example, in certain embodiments, the compounds become spatially constrained and therefore fluoresce upon incorporation into biomolecules. Also described herein are methods of labeling and detecting biomolecules and/or cells by incorporating the FgAA compounds described herein into biomolecules and/or cells (e.g., by enzymatic incorporation).

In one aspect, provided herein are FgAA compounds of Formula (I):

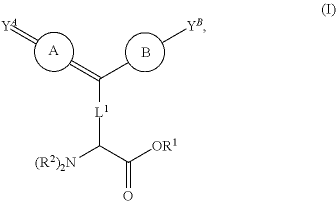

and salts, tautomers, and isotopically labeled derivatives thereof, wherein Ring A, Ring B, Y^{A}, Y^{B}, L¹, R¹, and R² are as defined herein.

For example, in certain embodiments, the compound of Formula (I) is selected from the group consisting of:

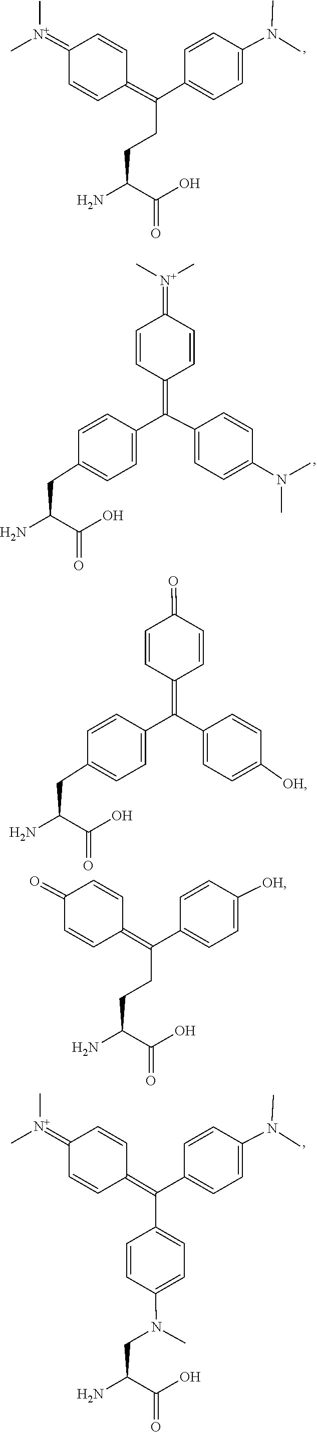

and salts, tautomers, and isotopically labeled derivatives thereof.

Also provided herein are FgAA compounds of Formula (II):

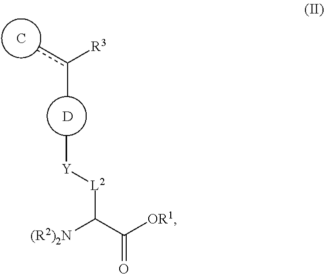

and salts, tautomers, and isotopically labeled derivatives thereof, wherein Ring C, Ring D, R³, Y, L², R¹, and R² are as defined herein.

For example, in certain embodiments, the compound of Formula (II) is selected from the group consisting of:

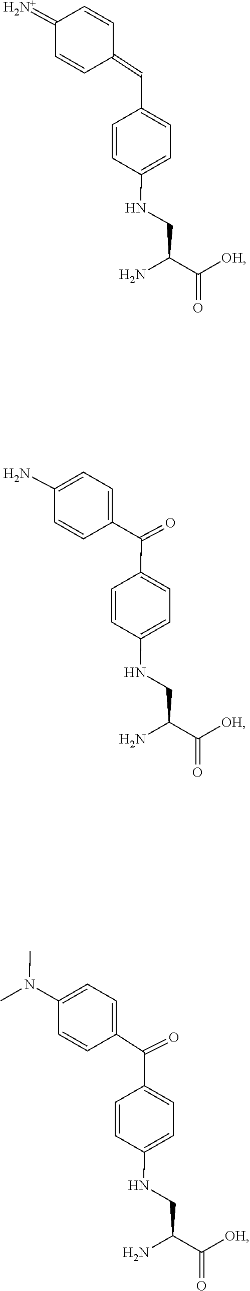 [SMILES: N[C@@H](CNc1ccc(C=C2C=CC(=[NH2+])C=C2)cc1)C(=O)O ; Nc1ccc(C(=O)c2ccc(NC[C@H](N)C(=O)O)cc2)cc1 ; CN(C)c1ccc(C(=O)c2ccc(NC[C@H](N)C(=O)O)cc2)cc1]

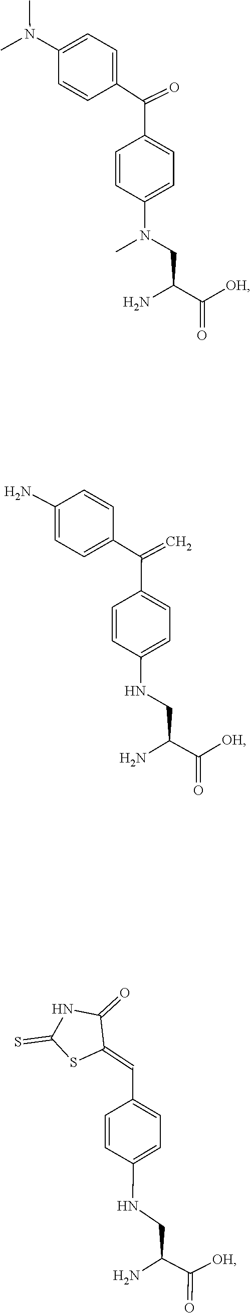 [SMILES: CN(C)c1ccc(C(=O)c2ccc(N(C)C[C@H](N)C(=O)O)cc2)cc1 ; C=C(c1ccc(N)cc1)c1ccc(NC[C@H](N)C(=O)O)cc1 ; N[C@@H](CNc1ccc(/C=C2\SC(=S)NC2=O)cc1)C(=O)O]

and salts, tautomers, and isotopically labeled derivatives thereof.

Also provided herein are compounds of Formulae (III) and (IV), and salts, tautomers, and isotopically labeled derivatives thereof, described in the Detailed Description.

Also provided herein are compositions and kits comprising the FgAA compounds described herein (e.g., compounds of Formulae (I), (II), (III), and (IV)). In certain embodiments, a composition comprises a compound provided herein and a solution or excipient. In certain embodiments, a kit comprises a compound provided herein, or a composition thereof, and optionally one or more chemical reagents or enzymes (e.g., for incorporating the compound into a biomolecule and/or cell). In certain embodiments, the biomolecule is a protein, polypeptide, glycan, peptidoglycan, or nucleic acid.

As described herein, the FgAA compounds described herein (e.g., compounds of Formulae (I), (II), (III), and (IV)) may “turn on” (i.e., fluoresce) upon incorporation into biomolecules and/or cells, thereby allowing for the florescent detection and imaging of the biomolecules and/or cells. Provided herein are methods of labeling a biomolecule (e.g., protein, polypeptide, glycan, peptidoglycan, nucleic acid) and/or cell, the method comprising exposing the biomolecule and/or cell to a compound of Formula (I), (II), (III), or (IV), or a salt, tautomer, or isotopically labeled derivative thereof. The labeling can be achieved, for example, via chemical incorporation, enzymatic incorporation, or ribosomal incorporation. In certain embodiments, the compound is covalently incorporated into the biomolecule and/or cell (e.g., through enzymatic incorporation). In certain embodiments, a peptidoglycan is labeled with a compound provided herein via transpeptidation with a transpeptidase enzyme (e.g., D,D-transpeptidase or L,D-transpeptidase). In certain embodiments, the peptidoglycan is in a cell (e.g., in a cell wall).

After labeling a biomolecule and/or cell with a FgAA compound described herein, the fluorescence of the resulting labeled biomolecule or cell can be observed and/or measured. Therefore, provided herein is a method of detecting a biomolecule and/or cell comprising:
(a) labeling the biomolecule and/or cell via any one of the methods described herein; and
(b) measuring or observing the fluorescence of the biomolecule and/or cell.

Also provided herein are methods of detecting a labeled biomolecule or cell described herein, the methods comprising measuring or observing the fluorescence of the biomolecule and/or cell.

Also provided herein are biomolecules (e.g., proteins, polypeptides, glycans, peptidoglycans, nucleic acids) (“labeled biomolecules”) and cells comprising the FgAA compounds described herein (e.g., compounds of Formulae (I), (II), (III), and (IV)). In certain embodiments, the labeled biomolecule comprises a compound provided herein covalently incorporated into the biomolecule. In certain embodiments, a labeled cell provided herein comprises a labeled biomolecule described herein (e.g., in the wall of the cell).

The details of certain embodiments of the invention are set forth herein. Other features, objects, and advantages of the invention will be apparent from the Detailed Description, Figures, Examples, and Claims.

### Definitions

### Chemical Definitions

Definitions of specific functional groups and chemical terms are described in more detail below. The chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March, March's Advanced Organic Chemistry, 5^{th} Edition, John Wiley & Sons, Inc., New York, 2001; Larock, Comprehensive Organic Transformations, VCH Publishers, Inc., New York, 1989; and Carruthers, Some Modern Methods of Organic Synthesis, 3^{rd} Edition, Cambridge University Press, Cambridge, 1987.

Compounds described herein can comprise one or more asymmetric centers, and thus can exist in various stereoisomeric forms, e.g., enantiomers and/or diastereomers. For example, the compounds described herein can be in the form of an individual enantiomer, diastereomer, or geometric isomer, or can be in the form of a mixture of stereoisomers, including racemic mixtures and mixtures enriched in one or more stereoisomer. Isomers can be isolated from mixtures by methods known to those skilled in the art, including chiral high pressure liquid chromatography (HPLC) and the formation and crystallization of chiral salts; or preferred isomers can be prepared by asymmetric syntheses. See, for example, Jacques et al., Enantiomers, Racemates and Resolutions (Wiley Interscience, New York, 1981); Wilen et al., Tetrahedron 33:2725 (1977); Eliel, E. L. Stereochemistry of Carbon Compounds (McGraw-Hill, N Y, 1962); and Wilen, S. H., Tables of Resolving Agents and Optical Resolutions p. 268 (E. L. Eliel, Ed., Univ. of Notre Dame Press, Notre Dame, Ind. 1972). The invention additionally encompasses compounds as individual isomers substantially free of other isomers, and alternatively, as mixtures of various isomers.

In a formula, [symbol] is a single bond where the stereochemistry of the moieties immediately attached thereto is not specified, [symbol] is absent or a single bond, and [symbol] or [symbol] is a single or double bond.

Unless otherwise stated, structures depicted herein are also meant to include compounds that differ only in the presence of one or more isotopically enriched atoms. For example, compounds having the present structures except for the replacement of hydrogen by deuterium or tritium, replacement of ¹⁹F with ¹⁸F, or the replacement of ¹²C with ¹³C or ¹⁴C are within the scope of the disclosure. Such compounds are useful, for example, as analytical tools or probes in biological assays.

When a range of values is listed, it is intended to encompass each value and sub-range within the range. For example “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “aliphatic” refers to alkyl, alkenyl, alkynyl, and carbocyclic groups. Likewise, the term “heteroaliphatic” refers to heteroalkyl, heteroalkenyl, heteroalkynyl, and heterocyclic groups.

The term “alkyl” refers to a radical of a straight-chain or branched saturated hydrocarbon group having from 1 to 10 carbon atoms (“C₁₋₁₀ alkyl”). In some embodiments, an alkyl group has 1 to 9 carbon atoms (“C₁₋₉ alkyl”). In some embodiments, an alkyl group has 1 to 8 carbon atoms (“C₁₋₈ alkyl”). In some embodiments, an alkyl group has 1 to 7 carbon atoms (“C₁₋₇ alkyl”). In some embodiments, an alkyl group has 1 to 6 carbon atoms (“C₁₋₆ alkyl”). In some embodiments, an alkyl group has 1 to 5 carbon atoms (“C₁₋₅ alkyl”). In some embodiments, an alkyl group has 1 to 4 carbon atoms (“C₁₋₄ alkyl”). In some embodiments, an alkyl group has 1 to 3 carbon atoms (“C₁₋₃ alkyl”). In some embodiments, an alkyl group has 1 to 2 carbon atoms (“C₁₋₂ alkyl”). In some embodiments, an alkyl group has 1 carbon atom (“C₁ alkyl”). In some embodiments, an alkyl group has 2 to 6 carbon atoms (“C₂₋₆ alkyl”). Examples of C₁₋₆ alkyl groups include methyl (C₁), ethyl (C₂), propyl (C₃) (e.g., n-propyl, isopropyl), butyl (C₄) (e.g., n-butyl, tert-butyl, sec-butyl, iso-butyl), pentyl (C₅) (e.g., n-pentyl, 3-pentanyl, amyl, neopentyl, 3-methyl-2-butanyl, tertiary amyl), and hexyl (C₆) (e.g., n-hexyl). Additional examples of alkyl groups include n-heptyl (C₇), n-octyl (C₃), and the like. Unless otherwise specified, each instance of an alkyl group is independently unsubstituted (an “unsubstituted alkyl”) or substituted (a “substituted alkyl”) with one or more substituents (e.g., halogen, such as F). In certain embodiments, the alkyl group is an unsubstituted C₁₋₁₀ alkyl (such as unsubstituted C₁₋₆ alkyl, e.g., —CH₃ (Me), unsubstituted ethyl (Et), unsubstituted propyl (Pr, e.g., unsubstituted n-propyl (n-Pr), unsubstituted isopropyl (i-Pr)), unsubstituted butyl (Bu, e.g., unsubstituted n-butyl (n-Bu), unsubstituted tert-butyl (tert-Bu or t-Bu), unsubstituted sec-butyl (sec-Bu), unsubstituted isobutyl (i-Bu)). In certain embodiments, the alkyl group is a substituted C₁₋₁₀ alkyl (such as substituted C₁₋₆ alkyl, e.g., —CF₃, Bn).

The term “haloalkyl” is a substituted alkyl group, wherein one or more of the hydrogen atoms are independently replaced by a halogen, e.g., fluoro, bromo, chloro, or iodo. In some embodiments, the haloalkyl moiety has 1 to 8 carbon atoms (“C₁₋₈ haloalkyl”). In some embodiments, the haloalkyl moiety has 1 to 6 carbon atoms (“C₁₋₆ haloalkyl”). In some embodiments, the haloalkyl moiety has 1 to 4 carbon atoms (“C₁₋₄ haloalkyl”). In some embodiments, the haloalkyl moiety has 1 to 3 carbon atoms (“C₁₋₃ haloalkyl”). In some embodiments, the haloalkyl moiety has 1 to 2 carbon atoms (“C₁₋₂ haloalkyl”). Examples of haloalkyl groups include —CHF₂, —CH₂F, —CF₃, —CH₂CF₃, —CF₂CF₃, —CF₂CF₂CF₃, —CCl₃, —CFCl₂, —CF₂C₁, and the like.

The term “heteroalkyl” refers to an alkyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkyl group refers to a saturated group having from 1 to 10 carbon atoms and 1 or more heteroatoms within the parent chain (“heteroC₁₋₁₀ alkyl”). In some embodiments, a heteroalkyl group is a saturated group having 1 to 9 carbon atoms and 1 or more heteroatoms within the parent chain (“heteroC₁₋₉ alkyl”). In some embodiments, a heteroalkyl group is a saturated group having 1 to 8 carbon atoms and 1 or more heteroatoms within the parent chain (“heteroC₁₋₈ alkyl”). In some embodiments, a heteroalkyl group is a saturated group having 1 to 7 carbon atoms and 1 or more heteroatoms within the parent chain (“hetero₁₋₇ alkyl”). In some embodiments, a heteroalkyl group is a saturated group having 1 to 6 carbon atoms and 1 or more heteroatoms within the parent chain (“heteroC₁₋₆ alkyl”). In some embodiments, a heteroalkyl group is a saturated group having 1 to 5 carbon atoms and 1 or 2 heteroatoms within the parent chain (“heteroC₁₋₅ alkyl”). In some embodiments, a heteroalkyl group is a saturated group having 1 to 4 carbon atoms and 1 or 2 heteroatoms within the parent chain (“heteroC₁₋₄ alkyl”). In some embodiments, a heteroalkyl group is a saturated group having 1 to 3 carbon atoms and 1 heteroatom within the parent chain (“heteroC₁₋₃ alkyl”). In some embodiments, a heteroalkyl group is a saturated group having 1 to 2 carbon atoms and 1 heteroatom within the parent chain (“heteroC₁₋₂ alkyl”). In some embodiments, a heteroalkyl group is a saturated group having 1 carbon atom and 1 heteroatom (“heteroC₁ alkyl”). In some embodiments, a heteroalkyl group is a saturated group having 2 to 6 carbon atoms and 1 or 2 heteroatoms within the parent chain (“heteroC₂₋₆ alkyl”). Unless otherwise specified, each instance of a heteroalkyl group is independently unsubstituted (an “unsubstituted heteroalkyl”) or substituted (a “substituted heteroalkyl”) with one or more substituents. In certain embodiments, the heteroalkyl group is an unsubstituted heteroC₁₋₁₀ alkyl. In certain embodiments, the heteroalkyl group is a substituted heteroC₁₋₁₀ alkyl.

The term “alkenyl” refers to a radical of a straight-chain or branched hydrocarbon group having from 2 to 10 carbon atoms and one or more carbon-carbon double bonds (e.g., 1, 2, 3, or 4 double bonds). In some embodiments, an alkenyl group has 2 to 9 carbon atoms (“C₂₋₉ alkenyl”). In some embodiments, an alkenyl group has 2 to 8 carbon atoms (“C₂₋₈ alkenyl”). In some embodiments, an alkenyl group has 2 to 7 carbon atoms (“C₂₋₇ alkenyl”). In some embodiments, an alkenyl group has 2 to 6 carbon atoms (“C₂₋₆ alkenyl”). In some embodiments, an alkenyl group has 2 to 5 carbon atoms (“C₂₋₅ alkenyl”). In some embodiments, an alkenyl group has 2 to 4 carbon atoms (“C₂₋₄ alkenyl”). In some embodiments, an alkenyl group has 2 to 3 carbon atoms (“C₂₋₃ alkenyl”). In some embodiments, an alkenyl group has 2 carbon atoms (“C₂ alkenyl”). The one or more carbon-carbon double bonds can be internal (such as in 2-butenyl) or terminal (such as in 1-butenyl). Examples of C₂₋₄ alkenyl groups include ethenyl (C₂), 1-propenyl (C₃), 2-propenyl (C₃), 1-butenyl (C₄), 2-butenyl (C₄), butadienyl (C₄), and the like. Examples of C₂₋₆ alkenyl groups include the aforementioned C₂₋₄ alkenyl groups as well as pentenyl (C₅), pentadienyl (C₅), hexenyl (C₆), and the like. Additional examples of alkenyl include heptenyl (C₇), octenyl (C₈), octatrienyl (C₈), and the like. Unless otherwise specified, each instance of an alkenyl group is independently unsubstituted (an “unsubstituted alkenyl”) or substituted (a “substituted alkenyl”) with one or more substituents. In certain embodiments, the alkenyl group is an unsubstituted C₂₋₁₀ alkenyl. In certain embodiments, the alkenyl group is a substituted C₂₋₁₀ alkenyl. In an alkenyl group, a C═C double bond for which the stereochemistry is not specified (e.g., —CH═CHCH₃ or

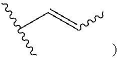

may be an (E)- or (Z)-double bond.

The term “heteroalkenyl” refers to an alkenyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkenyl group refers to a group having from 2 to 10 carbon atoms, at least one double bond, and 1 or more heteroatoms within the parent chain (“heteroC₂₋₁₀ alkenyl”). In some embodiments, a heteroalkenyl group has 2 to 9 carbon atoms at least one double bond, and 1 or more heteroatoms within the parent chain (“heteroC₂₋₉ alkenyl”). In some embodiments, a heteroalkenyl group has 2 to 8 carbon atoms, at least one double bond, and 1 or more heteroatoms within the parent chain (“heteroC₂-s alkenyl”). In some embodiments, a heteroalkenyl group has 2 to 7 carbon atoms, at least one double bond, and 1 or more heteroatoms within the parent chain (“heteroC₂₋₇ alkenyl”). In some embodiments, a heteroalkenyl group has 2 to 6 carbon atoms, at least one double bond, and 1 or more heteroatoms within the parent chain (“heteroC₂₋₆ alkenyl”). In some embodiments, a heteroalkenyl group has 2 to 5 carbon atoms, at least one double bond, and 1 or 2 heteroatoms within the parent chain (“heteroC₂-s alkenyl”). In some embodiments, a heteroalkenyl group has 2 to 4 carbon atoms, at least one double bond, and 1 or 2 heteroatoms within the parent chain (“heteroC₂₋₄ alkenyl”). In some embodiments, a heteroalkenyl group has 2 to 3 carbon atoms, at least one double bond, and 1 heteroatom within the parent chain (“heteroC₂₋₃ alkenyl”). In some embodiments, a heteroalkenyl group has 2 to 6 carbon atoms, at least one double bond, and 1 or 2 heteroatoms within the parent chain (“heteroC₂₋₆ alkenyl”). Unless otherwise specified, each instance of a heteroalkenyl group is independently unsubstituted (an “unsubstituted heteroalkenyl”) or substituted (a “substituted heteroalkenyl”) with one or more substituents. In certain embodiments, the heteroalkenyl group is an unsubstituted heteroC₂₋₁₀ alkenyl. In certain embodiments, the heteroalkenyl group is a substituted heteroC₂₋₁₀ alkenyl.

The term “alkynyl” refers to a radical of a straight-chain or branched hydrocarbon group having from 2 to 10 carbon atoms and one or more carbon-carbon triple bonds (e.g., 1, 2, 3, or 4 triple bonds) (“C₂₋₁₀ alkynyl”). In some embodiments, an alkynyl group has 2 to 9 carbon atoms (“C₂₋₉ alkynyl”). In some embodiments, an alkynyl group has 2 to 8 carbon atoms (“C₂₋₈ alkynyl”). In some embodiments, an alkynyl group has 2 to 7 carbon atoms (“C₂₋₇ alkynyl”). In some embodiments, an alkynyl group has 2 to 6 carbon atoms (“C₂₋₆ alkynyl”). In some embodiments, an alkynyl group has 2 to 5 carbon atoms (“C₂₋₅ alkynyl”). In some embodiments, an alkynyl group has 2 to 4 carbon atoms (“C₂₋₄ alkynyl”). In some embodiments, an alkynyl group has 2 to 3 carbon atoms (“C₂₋₃ alkynyl”). In some embodiments, an alkynyl group has 2 carbon atoms (“C₂ alkynyl”). The one or more carbon-carbon triple bonds can be internal (such as in 2-butynyl) or terminal (such as in 1-butynyl). Examples of C₂₋₄ alkynyl groups include, without limitation, ethynyl (C₂), 1-propynyl (C₃), 2-propynyl (C₃), 1-butynyl (C₄), 2-butynyl (C₄), and the like. Examples of C₂₋₆ alkenyl groups include the aforementioned C₂₋₄ alkynyl groups as well as pentynyl (C₅), hexynyl (C₆), and the like. Additional examples of alkynyl include heptynyl (C₇), octynyl (C₈), and the like. Unless otherwise specified, each instance of an alkynyl group is independently unsubstituted (an “unsubstituted alkynyl”) or substituted (a “substituted alkynyl”) with one or more substituents. In certain embodiments, the alkynyl group is an unsubstituted C₂₋₁₀ alkynyl. In certain embodiments, the alkynyl group is a substituted C₂₋₁₀ alkynyl.

The term “heteroalkynyl” refers to an alkynyl group, which further includes at least one heteroatom (e.g., 1, 2, 3, or 4 heteroatoms) selected from oxygen, nitrogen, or sulfur within (i.e., inserted between adjacent carbon atoms of) and/or placed at one or more terminal position(s) of the parent chain. In certain embodiments, a heteroalkynyl group refers to a group having from 2 to 10 carbon atoms, at least one triple bond, and 1 or more heteroatoms within the parent chain (“heteroC₂₋₁₀ alkynyl”). In some embodiments, a heteroalkynyl group has 2 to 9 carbon atoms, at least one triple bond, and 1 or more heteroatoms within the parent chain (“heteroC₂₋₉ alkynyl”). In some embodiments, a heteroalkynyl group has 2 to 8 carbon atoms, at least one triple bond, and 1 or more heteroatoms within the parent chain (“heteroC₂-8 alkynyl”). In some embodiments, a heteroalkynyl group has 2 to 7 carbon atoms, at least one triple bond, and 1 or more heteroatoms within the parent chain (“heteroC₂₋₇ alkynyl”). In some embodiments, a heteroalkynyl group has 2 to 6 carbon atoms, at least one triple bond, and 1 or more heteroatoms within the parent chain (“heteroC₂₋₆ alkynyl”). In some embodiments, a heteroalkynyl group has 2 to 5 carbon atoms, at least one triple bond, and 1 or 2 heteroatoms within the parent chain (“heteroC₂₋₅ alkynyl”). In some embodiments, a heteroalkynyl group has 2 to 4 carbon atoms, at least one triple bond, and 1 or 2 heteroatoms within the parent chain (“heteroC₂₋₄ alkynyl”). In some embodiments, a heteroalkynyl group has 2 to 3 carbon atoms, at least one triple bond, and 1 heteroatom within the parent chain (“heteroC₂₋₃ alkynyl”). In some embodiments, a heteroalkynyl group has 2 to 6 carbon atoms, at least one triple bond, and 1 or 2 heteroatoms within the parent chain (“heteroC₂₋₆ alkynyl”). Unless otherwise specified, each instance of a heteroalkynyl group is independently unsubstituted (an “unsubstituted heteroalkynyl”) or substituted (a “substituted heteroalkynyl”) with one or more substituents. In certain embodiments, the heteroalkynyl group is an unsubstituted heteroC₂₋₁₀ alkynyl. In certain embodiments, the heteroalkynyl group is a substituted heteroC₂₋₁₀ alkynyl.

The term “carbocyclyl” or “carbocyclic” refers to a radical of a non-aromatic cyclic hydrocarbon group having from 3 to 14 ring carbon atoms (“C₃₋₁₄ carbocyclyl”) and zero heteroatoms in the non-aromatic ring system. In some embodiments, a carbocyclyl group has 3 to 10 ring carbon atoms (“C₃₋₁₀ carbocyclyl”). In some embodiments, a carbocyclyl group has 3 to 8 ring carbon atoms (“C₃₋₈ carbocyclyl”). In some embodiments, a carbocyclyl group has 3 to 7 ring carbon atoms (“C₃₋₇ carbocyclyl”). In some embodiments, a carbocyclyl group has 3 to 6 ring carbon atoms (“C₃₋₆ carbocyclyl”). In some embodiments, a carbocyclyl group has 4 to 6 ring carbon atoms (“C₄₋₆ carbocyclyl”). In some embodiments, a carbocyclyl group has 5 to 6 ring carbon atoms (“C₅₋₆ carbocyclyl”). In some embodiments, a carbocyclyl group has 5 to 10 ring carbon atoms (“C₅₋₁₀ carbocyclyl”). Exemplary C₃₋₆ carbocyclyl groups include, without limitation, cyclopropyl (C₃), cyclopropenyl (C₃), cyclobutyl (C₄), cyclobutenyl (C₄), cyclopentyl (C₅), cyclopentenyl (C₅), cyclohexyl (C₆), cyclohexenyl (C₆), cyclohexadienyl (C₆), and the like. Exemplary C₃₋₈ carbocyclyl groups include, without limitation, the aforementioned C₃₋₆ carbocyclyl groups as well as cycloheptyl (C₇), cycloheptenyl (C₇), cycloheptadienyl (C₇), cycloheptatrienyl (C₇), cyclooctyl (C₈), cyclooctenyl (C₈), bicyclo[2.2.1]heptanyl (C₇), bicyclo[2.2.2]octanyl (C₈), and the like. Exemplary C₃₋₁₀ carbocyclyl groups include, without limitation, the aforementioned C₃₋₈ carbocyclyl groups as well as cyclononyl (C₉), cyclononenyl (C₉), cyclodecyl (C₁₀), cyclodecenyl (C₁₀), octahydro-1H-indenyl (C₉), decahydronaphthalenyl (C₁₀), spiro[4.5]decanyl (C₁₀), and the like. As the foregoing examples illustrate, in certain embodiments, the carbocyclyl group is either monocyclic (“monocyclic carbocyclyl”) or polycyclic (e.g., containing a fused, bridged or spiro ring system such as a bicyclic system (“bicyclic carbocyclyl”) or tricyclic system (“tricyclic carbocyclyl”)) and can be saturated or can contain one or more carbon-carbon double or triple bonds. “Carbocyclyl” also includes ring systems wherein the carbocyclyl ring, as defined above, is fused with one or more aryl or heteroaryl groups wherein the point of attachment is on the carbocyclyl ring, and in such instances, the number of carbons continue to designate the number of carbons in the carbocyclic ring system. Unless otherwise specified, each instance of a carbocyclyl group is independently unsubstituted (an “unsubstituted carbocyclyl”) or substituted (a “substituted carbocyclyl”) with one or more substituents. In certain embodiments, the carbocyclyl group is an unsubstituted C₃₋₁₄ carbocyclyl. In certain embodiments, the carbocyclyl group is a substituted C₃₋₁₄ carbocyclyl.

In some embodiments, “carbocyclyl” is a monocyclic, saturated carbocyclyl group having from 3 to 14 ring carbon atoms (“C₃₋₁₄ cycloalkyl”). In some embodiments, a cycloalkyl group has 3 to 10 ring carbon atoms (“C₃₋₁₀ cycloalkyl”). In some embodiments, a cycloalkyl group has 3 to 8 ring carbon atoms (“C₃₋₈ cycloalkyl”). In some embodiments, a cycloalkyl group has 3 to 6 ring carbon atoms (“C₃₋₆ cycloalkyl”). In some embodiments, a cycloalkyl group has 4 to 6 ring carbon atoms (“C₄₋₆ cycloalkyl”). In some embodiments, a cycloalkyl group has 5 to 6 ring carbon atoms (“C₅₋₆ cycloalkyl”). In some embodiments, a cycloalkyl group has 5 to 10 ring carbon atoms (“C₅₋₁₀ cycloalkyl”). Examples of C₅6 cycloalkyl groups include cyclopentyl (C₅) and cyclohexyl (C₅). Examples of C₃₋₆ cycloalkyl groups include the aforementioned C₅₋₆ cycloalkyl groups as well as cyclopropyl (C₃) and cyclobutyl (C₄). Examples of C₃₋₈ cycloalkyl groups include the aforementioned C₃₋₆ cycloalkyl groups as well as cycloheptyl (C₇) and cyclooctyl (C₈). Unless otherwise specified, each instance of a cycloalkyl group is independently unsubstituted (an “unsubstituted cycloalkyl”) or substituted (a “substituted cycloalkyl”) with one or more substituents. In certain embodiments, the cycloalkyl group is an unsubstituted C₃₋₁₄ cycloalkyl. In certain embodiments, the cycloalkyl group is a substituted C₃₋₁₄ cycloalkyl.

The term “heterocyclyl” or “heterocyclic” refers to a radical of a 3- to 14-membered non-aromatic ring system having ring carbon atoms and 1 to 4 ring heteroatoms, wherein each heteroatom is independently selected from nitrogen, oxygen, and sulfur (“3-14 membered heterocyclyl”). In heterocyclyl groups that contain one or more nitrogen atoms, the point of attachment can be a carbon or nitrogen atom, as valency permits. A heterocyclyl group can either be monocyclic (“monocyclic heterocyclyl”) or polycyclic (e.g., a fused, bridged or spiro ring system such as a bicyclic system (“bicyclic heterocyclyl”) or tricyclic system (“tricyclic heterocyclyl”)), and can be saturated or can contain one or more carbon-carbon double or triple bonds. Heterocyclyl polycyclic ring systems can include one or more heteroatoms in one or both rings. “Heterocyclyl” also includes ring systems wherein the heterocyclyl ring, as defined above, is fused with one or more carbocyclyl groups wherein the point of attachment is either on the carbocyclyl or heterocyclyl ring, or ring systems wherein the heterocyclyl ring, as defined above, is fused with one or more aryl or heteroaryl groups, wherein the point of attachment is on the heterocyclyl ring, and in such instances, the number of ring members continue to designate the number of ring members in the heterocyclyl ring system. Unless otherwise specified, each instance of heterocyclyl is independently unsubstituted (an “unsubstituted heterocyclyl”) or substituted (a “substituted heterocyclyl”) with one or more substituents. In certain embodiments, the heterocyclyl group is an unsubstituted 3-14 membered heterocyclyl. In certain embodiments, the heterocyclyl group is a substituted 3-14 membered heterocyclyl.

In some embodiments, a heterocyclyl group is a 5-10 membered non-aromatic ring system having ring carbon atoms and 1-4 ring heteroatoms, wherein each heteroatom is independently selected from nitrogen, oxygen, and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen, and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen, and sulfur (“5-6 membered heterocyclyl”). In some embodiments, the 5-6 membered heterocyclyl has 1-3 ring heteroatoms selected from nitrogen, oxygen, and sulfur. In some embodiments, the 5-6 membered heterocyclyl has 1-2 ring heteroatoms selected from nitrogen, oxygen, and sulfur. In some embodiments, the 5-6 membered heterocyclyl has 1 ring heteroatom selected from nitrogen, oxygen, and sulfur.

Exemplary 3-membered heterocyclyl groups containing 1 heteroatom include, without limitation, azirdinyl, oxiranyl, and thiiranyl. Exemplary 4-membered heterocyclyl groups containing 1 heteroatom include, without limitation, azetidinyl, oxetanyl, and thietanyl. Exemplary 5-membered heterocyclyl groups containing 1 heteroatom include, without limitation, tetrahydrofuranyl, dihydrofuranyl, tetrahydrothiophenyl, dihydrothiophenyl, pyrrolidinyl, dihydropyrrolyl, and pyrrolyl-2,5-dione. Exemplary 5-membered heterocyclyl groups containing 2 heteroatoms include, without limitation, dioxolanyl, oxathiolanyl and dithiolanyl. Exemplary 5-membered heterocyclyl groups containing 3 heteroatoms include, without limitation, triazolinyl, oxadiazolinyl, and thiadiazolinyl. Exemplary 6-membered heterocyclyl groups containing 1 heteroatom include, without limitation, piperidinyl, tetrahydropyranyl, dihydropyridinyl, and thianyl. Exemplary 6-membered heterocyclyl groups containing 2 heteroatoms include, without limitation, piperazinyl, morpholinyl, dithianyl, and dioxanyl. Exemplary 6-membered heterocyclyl groups containing 3 heteroatoms include, without limitation, triazinanyl. Exemplary 7-membered heterocyclyl groups containing 1 heteroatom include, without limitation, azepanyl, oxepanyl and thiepanyl. Exemplary 8-membered heterocyclyl groups containing 1 heteroatom include, without limitation, azocanyl, oxecanyl and thiocanyl. Exemplary bicyclic heterocyclyl groups include, without limitation, indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H-furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-1H-pyrrolo[2,3-b]pyridinyl, 4,5,6,7-tetrahydrofuro[3,2-c]pyridinyl, 4,5,6,7-tetrahydrothieno[3,2-b]pyridinyl, 1,2,3,4-tetrahydro-1,6-naphthyridinyl, and the like.

The term “aryl” refers to a radical of a monocyclic or polycyclic (e.g., bicyclic or tricyclic) 4n+2 aromatic ring system (e.g., having 6, 10, or 14 xT electrons shared in a cyclic array) having 6-14 ring carbon atoms and zero heteroatoms provided in the aromatic ring system (“C₆₋₁₄ aryl”). In some embodiments, an aryl group has 6 ring carbon atoms (“C₆ aryl”; e.g., phenyl). In some embodiments, an aryl group has 10 ring carbon atoms (“C₁₀ aryl”; e.g., naphthyl such as 1-naphthyl and 2-naphthyl). In some embodiments, an aryl group has 14 ring carbon atoms (“C₁₄ aryl”; e.g., anthracyl). “Aryl” also includes ring systems wherein the aryl ring, as defined above, is fused with one or more carbocyclyl or heterocyclyl groups wherein the radical or point of attachment is on the aryl ring, and in such instances, the number of carbon atoms continue to designate the number of carbon atoms in the aryl ring system. Unless otherwise specified, each instance of an aryl group is independently unsubstituted (an “unsubstituted aryl”) or substituted (a “substituted aryl”) with one or more substituents. In certain embodiments, the aryl group is an unsubstituted C₆₋₁₄ aryl. In certain embodiments, the aryl group is a substituted C₆₋₁₄ aryl.

“Aralkyl” is a subset of “alkyl” and refers to an alkyl group substituted by an aryl group, wherein the point of attachment is on the alkyl moiety.

The term “heteroaryl” refers to a radical of a 5-14 membered monocyclic or polycyclic (e.g., bicyclic, tricyclic) 4n+2 aromatic ring system (e.g., having 6, 10, or 14 π electrons shared in a cyclic array) having ring carbon atoms and 1-4 ring heteroatoms provided in the aromatic ring system, wherein each heteroatom is independently selected from nitrogen, oxygen, and sulfur (“5-14 membered heteroaryl”). In heteroaryl groups that contain one or more nitrogen atoms, the point of attachment can be a carbon or nitrogen atom, as valency permits. Heteroaryl polycyclic ring systems can include one or more heteroatoms in one or both rings. “Heteroaryl” includes ring systems wherein the heteroaryl ring, as defined above, is fused with one or more carbocyclyl or heterocyclyl groups wherein the point of attachment is on the heteroaryl ring, and in such instances, the number of ring members continue to designate the number of ring members in the heteroaryl ring system. “Heteroaryl” also includes ring systems wherein the heteroaryl ring, as defined above, is fused with one or more aryl groups wherein the point of attachment is either on the aryl or heteroaryl ring, and in such instances, the number of ring members designates the number of ring members in the fused polycyclic (aryl/heteroaryl) ring system. Polycyclic heteroaryl groups wherein one ring does not contain a heteroatom (e.g., indolyl, quinolinyl, carbazolyl, and the like) the point of attachment can be on either ring, i.e., either the ring bearing a heteroatom (e.g., 2-indolyl) or the ring that does not contain a heteroatom (e.g., 5-indolyl).

In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, and sulfur (“5-6 membered heteroaryl”). In some embodiments, the 5-6 membered heteroaryl has 1-3 ring heteroatoms selected from nitrogen, oxygen, and sulfur. In some embodiments, the 5-6 membered heteroaryl has 1-2 ring heteroatoms selected from nitrogen, oxygen, and sulfur. In some embodiments, the 5-6 membered heteroaryl has 1 ring heteroatom selected from nitrogen, oxygen, and sulfur. Unless otherwise specified, each instance of a heteroaryl group is independently unsubstituted (an “unsubstituted heteroaryl”) or substituted (a “substituted heteroaryl”) with one or more substituents. In certain embodiments, the heteroaryl group is an unsubstituted 5-14 membered heteroaryl. In certain embodiments, the heteroaryl group is a substituted 5-14 membered heteroaryl.

Exemplary 5-membered heteroaryl groups containing 1 heteroatom include, without limitation, pyrrolyl, furanyl, and thiophenyl. Exemplary 5-membered heteroaryl groups containing 2 heteroatoms include, without limitation, imidazolyl, pyrazolyl, oxazolyl, isoxazolyl, thiazolyl, and isothiazolyl. Exemplary 5-membered heteroaryl groups containing 3 heteroatoms include, without limitation, triazolyl, oxadiazolyl, and thiadiazolyl. Exemplary 5-membered heteroaryl groups containing 4 heteroatoms include, without limitation, tetrazolyl. Exemplary 6-membered heteroaryl groups containing 1 heteroatom include, without limitation, pyridinyl. Exemplary 6-membered heteroaryl groups containing 2 heteroatoms include, without limitation, pyridazinyl, pyrimidinyl, and pyrazinyl. Exemplary 6-membered heteroaryl groups containing 3 or 4 heteroatoms include, without limitation, triazinyl and tetrazinyl, respectively. Exemplary 7-membered heteroaryl groups containing 1 heteroatom include, without limitation, azepinyl, oxepinyl, and thiepinyl. Exemplary 5,6-bicyclic heteroaryl groups include, without limitation, indolyl, isoindolyl, indazolyl, benzotriazolyl, benzothiophenyl, isobenzothiophenyl, benzofuranyl, benzoisofuranyl, benzimidazolyl, benzoxazolyl, benzisoxazolyl, benzoxadiazolyl, benzthiazolyl, benzisothiazolyl, benzthiadiazolyl, indolizinyl, and purinyl. Exemplary 6,6-bicyclic heteroaryl groups include, without limitation, naphthyridinyl, pteridinyl, quinolinyl, isoquinolinyl, cinnolinyl, quinoxalinyl, phthalazinyl, and quinazolinyl. Exemplary tricyclic heteroaryl groups include, without limitation, phenanthridinyl, dibenzofuranyl, carbazolyl, acridinyl, phenothiazinyl, phenoxazinyl, and phenazinyl.

“Heteroaralkyl” is a subset of “alkyl” and refers to an alkyl group substituted by a heteroaryl group, wherein the point of attachment is on the alkyl moiety.

The term “unsaturated bond” refers to a double or triple bond.

The term “unsaturated” or “partially unsaturated” refers to a moiety that includes at least one double or triple bond.

The term “saturated” refers to a moiety that does not contain a double or triple bond, i.e., the moiety only contains single bonds.

Affixing the suffix “-ene” to a group indicates the group is a divalent moiety, e.g., alkylene is the divalent moiety of alkyl, alkenylene is the divalent moiety of alkenyl, alkynylene is the divalent moiety of alkynyl, heteroalkylene is the divalent moiety of heteroalkyl, heteroalkenylene is the divalent moiety of heteroalkenyl, heteroalkynylene is the divalent moiety of heteroalkynyl, carbocyclylene is the divalent moiety of carbocyclyl, heterocyclylene is the divalent moiety of heterocyclyl, arylene is the divalent moiety of aryl, and heteroarylene is the divalent moiety of heteroaryl.

A group is optionally substituted unless expressly provided otherwise. The term “optionally substituted” refers to being substituted or unsubstituted. In certain embodiments, alkyl, alkenyl, alkynyl, heteroalkyl, heteroalkenyl, heteroalkynyl, carbocyclyl, heterocyclyl, aryl, and heteroaryl groups are optionally substituted. “Optionally substituted” refers to a group which may be substituted or unsubstituted (e.g., “substituted” or “unsubstituted” alkyl, “substituted” or “unsubstituted” alkenyl, “substituted” or “unsubstituted” alkynyl, “substituted” or “unsubstituted” heteroalkyl, “substituted” or “unsubstituted” heteroalkenyl, “substituted” or “unsubstituted” heteroalkynyl, “substituted” or “unsubstituted” carbocyclyl, “substituted” or “unsubstituted” heterocyclyl, “substituted” or “unsubstituted” aryl or “substituted” or “unsubstituted” heteroaryl group). In general, the term “substituted” means that at least one hydrogen present on a group is replaced with a permissible substituent, e.g., a substituent which upon substitution results in a stable compound, e.g., a compound which does not spontaneously undergo transformation such as by rearrangement, cyclization, elimination, or other reaction. Unless otherwise indicated, a “substituted” group has a substituent at one or more substitutable positions of the group, and when more than one position in any given structure is substituted, the substituent is either the same or different at each position. The term “substituted” is contemplated to include substitution with all permissible substituents of organic compounds, and includes any of the substituents described herein that results in the formation of a stable compound. The present invention contemplates any and all such combinations in order to arrive at a stable compound. For purposes of this invention, heteroatoms such as nitrogen may have hydrogen substituents and/or any suitable substituent as described herein which satisfy the valencies of the heteroatoms and results in the formation of a stable moiety. The invention is not intended to be limited in any manner by the exemplary substituents described herein.

Exemplary carbon atom substituents include, but are not limited to, halogen, —CN, —NO₂, —N₃, —SO₂H, —SO₃H, —OH, —OR^{aa}, —ON(R^{bb})₂, —N(R^{bb})₂, —N(R^{bb})₃⁺X⁻, —N(OR^{cc})R^{bb}, —SH, —SR^{aa}, —SSR^{cc}, —C(═O)R^{aa}, —CO₂H, —CHO, —C(OR^{cc})₃, —CO₂R^{aa}, —OC(═O)R^{aa}, —OCO₂R^{aa}, —C(═O)N(R^{bb})₂, —OC(═O)N(R^{bb})₂, —NR^{bb}C(═O)R—, —NR^{bb}CO₂R^{aa}, —NR^{bb}C(═O)N(R^{bb})₂, —C(═NR^{bb})R^{aa}, —C(═NR^{bb})OR^{aa}, —OC(═NR^{bb})R^{aa}, —OC(═NR^{bb})OR^{aa}, —C(═NR^{bb})N(R^{bb})₂, —OC(═NR^{bb})N(R^{bb})₂, —NR^{bb}C(═NR^{bb})N(R^{bb})₂, —C(═O)NR^{bb}SO₂R^{aa}, —NR^{bb}SO₂R^{aa}, —SO₂N(R^{bb})₂, —SO₂R^{aa}, —SO₂OR^{aa}, —OSO₂R^{aa}, —S(═O)R^{aa}, —OS(═O)R^{aa}, —Si(R^{aa})₃, —OSi(R^{aa})₃—C(═S)N(R^{bb})₂, —C(═O)SR^{aa}, —C(═S)SR^{aa}, —SC(═S)SR^{aa}, —SC(═O)SR^{aa}, —OC(═O)SR^{aa}, —SC(═O)OR^{aa}, —SC(═O)R^{aa}, —P(═O)(R^{aa})₂, —P(═O)(OR^{cc})₂, —OP(═O)(R^{aa})₂, —OP(═O)(OR^{cc})₂, —P(═O)(N(R^{b}b)₂)₂, —OP(═O)(N(R^{b}b)₂)₂, —NR^{bb}P(═O)(R^{aa})₂, —NR^{bb}P(═O)(OR^{cc})₂, —NR^{bb}P(═O)(N(R^{bb})₂)₂, —P(R^{cc})₂, —P(OR^{cc})₂, —P(R^{cc})₃⁺X⁻, —P(OR^{cc})₃⁺X⁻, —P(R^{cc})₄, —P(OR^{cc})₄, —OP(R^{cc})₂, —OP(R^{cc})₃⁺X⁻, —OP(OR^{cc})₂, —OP(OR^{cc})₃⁺X⁻, —OP(R^{cc})₄, —OP(OR^{cc})₄, —B(R^{aa})₂, —B(OR^{cc})₂, —BR^{aa}(OR^{cc}), C₁₋₁₀ alkyl, C₁₋₁₀ perhaloalkyl, C₂₋₁₀ alkenyl, C₂₋₁₀ alkynyl, heteroC₂₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion;

or two geminal hydrogens on a carbon atom are replaced with the group ═O, ═S, ═NN(R^{bb})₂, ═NNR^{bb}C(═O)R^{aa}, ═NNR^{bb}C(═O)OR^{aa}, ═NNR^{bb}S(═O)₂R^{aa}, ═NR^{bb}, or ═NOR^{cc}; each instance of R^{aa} is, independently, selected from C₁₋₁₀ alkyl, C₁₋₁₀ perhaloalkyl, C₂₋₁₀ alkenyl, C₂₋₁₀ alkynyl, heteroC₂₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{aa} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
each instance of R^{bb} is, independently, selected from hydrogen, —OH, —OR^{aa}, —N(R^{cc})₂, —CN, —C(═O)R^{aa}, —C(═O)N(R^{cc})₂, —CO₂R^{aa}, —SO₂R^{aa}, —C(═NR^{cc})OR^{aa}, —C(═NR^{cc})N(R^{cc})₂, —SO₂N(R^{cc})₂, —SO₂R^{cc}, —SO₂OR^{cc}, —SOR^{aa}, —C(═S)N(R^{cc})₂, —C(═O)SR^{cc}, —C(═S)SR^{cc}, —P(═O)(R^{aa})₂, —P(═O)(OR^{cc})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₂₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{bb} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups; wherein X⁻ is a counterion;
each instance of R^{dd} is, independently, selected from hydrogen, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups;
each instance of R^{dd} is, independently, selected from halogen, —CN, —NO₂, —N₃, —SO₂H, —SO₃H, —OH, —OR^{ee}, —ON(R^{ff})₂, —N(R^{ff})₂, —N(R^{ff})₃⁺X⁻, —N(OR^{ee})R^{ff}, —SH, —SR^{ee}, —SSR^{ee}, —C(═O)R^{ee}, —CO₂H, —CO₂R^{ee}, —OC(═O)R^{ee}, —OCO₂R^{ee}, —C(═O)N(R^{ff})₂, —OC(═O)N(R^{ff})₂, —NR^{ff}C(═O)R^{ee}, —NR^{ff}CO₂R^{ee}, —NR^{ff}C(═O)N(R^{ff})₂, —C(═NR^{ff})OR^{ee}, —OC(═NR^{ff})R^{ee}, —OC(═NR^{ff})OR^{ee}, —C(═NR^{ff})N(R^{ff})₂, —OC(═NR^{ff})N(R^{ff})₂, —NR^{ff}C(═NR^{ff})N(R^{ff})₂, —NR^{ff}SO₂R^{ee}, —SO₂N(R^{ff})₂, —SO₂R^{ee}, —SO₂OR^{ee}, —OSO₂R^{ee}, —S(═O)R^{ee}, —Si(R^{ee})₃, —OSi(R^{ee})₃, —C(═S)N(R^{ff})₂, —C(═O)SR^{ee}, —C(═S)SR^{ee}, —SC(═S)SR^{ee}, —P(═O)(OR^{ee})₂, —P(═O)(R^{ee})₂, —OP(═O)(R^{ee})₂, —OP(═O)(OR^{ee})₂, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl, 5-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups, or two geminal R^{dd} substituents can be joined to form ═O or ═S; wherein X⁻ is a counterion;
each instance of R^{ee} is, independently, selected from C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, C₆₋₁₀ aryl, 3-10 membered heterocyclyl, and 3-10 membered heteroaryl, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups;
each instance of R^{ff} is, independently, selected from hydrogen, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, 3-10 membered heterocyclyl, C₆₋₁₀ aryl and 5-10 membered heteroaryl, or two R^{ff} groups are joined to form a 3-10 membered heterocyclyl or 5-10 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{gg} groups; and
each instance of R^{gg} is, independently, halogen, —CN, —NO₂, —N₃, —SO₂H, —SO₃H, —OH, —OC₁₋₆ alkyl, —ON(C₁₋₆ alkyl)₂, —N(C₁₋₆ alkyl)₂, —N(C₁₋₆ alkyl)₃⁺X⁻, —NH(C₁₋₆ alkyl)₂⁺X⁻, —NH₂(C₁₋₆ alkyl)⁺X⁻, —NH₃⁺X⁻, —N(OC₁₋₆ alkyl)(C₁₋₆ alkyl), —N(OH)(C₁₋₆ alkyl), —NH(OH), —SH, —SC₁₋₆ alkyl, —SS(C₁₋₆ alkyl), —C(═O)(C₁₋₆ alkyl), —CO₂H, —CO₂(C₁₋₆ alkyl), —OC(═O)(C₁₋₆ alkyl), —OCO₂(C₁₋₆ alkyl), —C(═O)NH₂, —C(═O)N(C₁₋₆ alkyl)₂, —OC(═O)NH(C₁₋₆ alkyl), —NHC(═O)(C₁₋₆ alkyl), —N(C₁₋₆ alkyl)C(═O)(C₁₋₆ alkyl), —NHCO₂(C₁₋₆ alkyl), —NHC(═O)N(C₁₋₆ alkyl)₂, —NHC(═O)NH(C₁₋₆ alkyl), —NHC(═O)NH₂, —C(═NH)O(C₁₋₆ alkyl), —OC(═NH)(C₁₋₆ alkyl), —OC(═NH)OC₁₋₆ alkyl, —C(═NH)N(C₁₋₆ alkyl)₂, —C(═NH)NH(C₁₋₆ alkyl), —C(═NH)NH₂, —OC(═NH)N(C₁₋₆ alkyl)₂, —OC(═NH)NH(C₁₋₆ alkyl), —OC(═NH)NH₂, —NHC(═NH)N(C₁₋₆ alkyl)₂, —NHC(═NH)NH₂, —NHSO₂(C₁₋₆ alkyl), —SO₂N(C₁₋₆ alkyl)₂, —SO₂NH(C₁₋₆ alkyl), —SO₂NH₂, —SO₂(C₁₋₆ alkyl), —SO₂O(C₁₋₆ alkyl), —OSO₂(C₁₋₆ alkyl), —SO(C₁₋₆ alkyl), —Si(C₁₋₆ alkyl)₃, —OSi(C₁₋₆ alkyl)₃ —C(═S)N(C₁₋₆ alkyl)₂, C(═S)NH(C₁₋₆ alkyl), C(═S)NH₂, —C(═O)S(C₁₋₆ alkyl), —C(═S)SC₁₋₆ alkyl, —SC(═S)SC₁₋₆ alkyl, —P(═O)(OC₁₋₆ alkyl)₂, —P(═O)(C₁₋₆ alkyl)₂, —OP(═O)(C₁₋₆ alkyl)₂, —OP(═O)(OC₁₋₆ alkyl)₂, C₁₋₆ alkyl, C₁₋₆ perhaloalkyl, C₂₋₆ alkenyl, C₂₋₆ alkynyl, heteroC₁₋₆ alkyl, heteroC₂₋₆ alkenyl, heteroC₂₋₆ alkynyl, C₃₋₁₀ carbocyclyl, C₆₋₁₀ aryl, 3-10 membered heterocyclyl, 5-10 membered heteroaryl; or two geminal R^{gg} substituents can be joined to form ═O or ═S; wherein X⁻ is a counterion.

The term “halo” or “halogen” refers to fluorine (fluoro, —F), chlorine (chloro, —Cl), bromine (bromo, —Br), or iodine (iodo, —I).

The term “hydroxyl” or “hydroxy” refers to the group —OH. The term “substituted hydroxyl” or “substituted hydroxyl,” by extension, refers to a hydroxyl group wherein the oxygen atom directly attached to the parent molecule is substituted with a group other than hydrogen, and includes groups selected from —OR^{aa}, —ON(R^{bb})₂, —OC(═O)SR^{aa}, —OC(═O)R^{aa}, —OCO₂R^{aa}, —OC(═O)N(R^{bb})₂, —OC(═NR^{bb})R^{aa}, —OC(═NR^{bb})OR^{aa}, —OC(═NR^{bb})N(R^{bb})₂, —OS(═O)R^{aa}, —OSO₂R^{aa}, —OSi(R^{aa})₃, —OP(R^{cc})₂, —OP(R^{cc})₃⁺X⁻, —OP(OR^{cc})₂, —OP(OR^{cc})₃⁺X⁻, —OP(═O)(R^{aa})₂, —OP(═O)(OR^{cc})₂, and —OP(═O)(N(R^{bb})₂)₂, wherein X⁻, R^{aa}, R^{bb}, and R^{cc} are as defined herein.

The term “amino” refers to the group —NH₂. The term “substituted amino,” by extension, refers to a monosubstituted amino, a disubstituted amino, or a trisubstituted amino. In certain embodiments, the “substituted amino” is a monosubstituted amino or a disubstituted amino group.

The term “monosubstituted amino” refers to an amino group wherein the nitrogen atom directly attached to the parent molecule is substituted with one hydrogen and one group other than hydrogen, and includes groups selected from —NH(R^{bb}), —NHC(═O)R^{aa}, —NHCO₂R^{aa}, —NHC(═O)N(R^{bb})₂, —NHC(═NR^{bb})N(R^{bb})₂, —NHSO₂R^{aa}, —NHP(═O)(OR^{cc})₂, and —NHP(═O)(N(R^{bb})₂)₂, wherein R^{aa}, R^{bb}, and R^{cc} are as defined herein, and wherein R^{bb} of the group —NH(R^{bb}) is not hydrogen.

The term “disubstituted amino” refers to an amino group wherein the nitrogen atom directly attached to the parent molecule is substituted with two groups other than hydrogen, and includes groups selected from —N(R^{bb})₂, —NR^{bb}C(═O)R—, —NR^{bb}CO₂R—, —NR^{bb}C(═O)N(R^{bb})₂, —NR^{bb}C(═NR^{bb})N(R^{bb})₂, —NR^{bb}SO₂R^{aa}, —NR^{bb}P(═O)(OR^{cc})₂, and —NR^{bb}P(═O)(N(R^{bb})₂)₂, wherein R^{aa}, R^{bb}, and R^{cc} are as defined herein, with the proviso that the nitrogen atom directly attached to the parent molecule is not substituted with hydrogen.

The term “trisubstituted amino” refers to an amino group wherein the nitrogen atom directly attached to the parent molecule is substituted with three groups, and includes groups selected from —N(R^{bb})₃ and —N(R^{bb})₃⁺X⁻, wherein R^{bb} and X⁻ are as defined herein.

The term “sulfonyl” refers to a group selected from —SO₂N(R^{bb})₂, —SO₂R^{aa}, and —SO₂OR^{aa}, wherein R^{aa} and R^{bb} are as defined herein.

The term “sulfinyl” refers to the group —S(═O)R^{aa}, wherein R^{aa} is as defined herein.

The term “acyl” refers to a group having the general formula —C(═O)R^{X1}, —C(═O)OR^{X1}, —C(═O)—O—C(═O)R^{X1}, —C(═O)SR^{X1}, —C(═O)N(R^{X1})₂, —C(═S)R^{X1}, —C(═S)N(R^{X1})₂, —C(═S)O(R^{X1}), —C(═S)S(R^{X1}), —C(═NR^{X1})R^{X1}, —C(═NR^{X1})OR^{X1}, —C(═NR^{X1})SR^{X1}, and —C(═NR^{X1})N(R^{X1})₂, wherein R^{X1} is hydrogen; halogen; substituted or unsubstituted hydroxyl; substituted or unsubstituted thiol; substituted or unsubstituted amino; substituted or unsubstituted acyl, cyclic or acyclic, substituted or unsubstituted, branched or unbranched aliphatic; cyclic or acyclic, substituted or unsubstituted, branched or unbranched heteroaliphatic; cyclic or acyclic, substituted or unsubstituted, branched or unbranched alkyl; cyclic or acyclic, substituted or unsubstituted, branched or unbranched alkenyl; substituted or unsubstituted alkynyl; substituted or unsubstituted aryl, substituted or unsubstituted heteroaryl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, mono- or di-aliphaticamino, mono- or di-heteroaliphaticamino, mono- or di-alkylamino, mono- or di-heteroalkylamino, mono- or di-arylamino, or mono- or di-heteroarylamino; or two R^{X1} groups taken together form a 5- to 6-membered heterocyclic ring. Exemplary acyl groups include aldehydes (—CHO), carboxylic acids (—CO₂H), ketones, acyl halides, esters, amides, imines, carbonates, carbamates, and ureas. Acyl substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “carbonyl” refers a group wherein the carbon directly attached to the parent molecule is sp² hybridized, and is substituted with an oxygen, nitrogen or sulfur atom, e.g., a group selected from ketones (e.g., —C(═O)R^{aa}), carboxylic acids (e.g., —CO₂H), aldehydes (—CHO), esters (e.g., —CO₂R^{aa}, —C(═O)SR^{aa}, —C(═S)SR^{aa}), amides (e.g., —C(═O)N(R^{bb})₂, —C(═O)NR^{bb}SO₂R^{aa}, C(═S)N(R^{bb})₂), and imines (e.g., —C(═NR^{bb})R^{aa}, —C(═NR^{bb})OR^{aa}), —C(═NR^{bb})N(R^{bb})₂), wherein R^{aa} and R^{bb} are as defined herein.

The term “oxo” refers to the group ═O, and the term “thiooxo” refers to the group ═S.

Nitrogen atoms can be substituted or unsubstituted as valency permits, and include primary, secondary, tertiary, and quaternary nitrogen atoms. Exemplary nitrogen atom substituents include, but are not limited to, hydrogen, —OH, —OR^{aa}, —N(R^{cc})₂, —CN, —C(═O)R^{aa}, —C(═O)N(R^{cc})₂, —CO₂R^{aa}, —SO₂R—, —C(═NR^{bb})R^{aa}, —C(═NR^{cc})OR^{aa}, —C(═NR^{cc})N(R^{cc})₂, —SO₂N(R^{cc})₂, —SO₂R^{aa}, —SO₂OR^{cc}, —SOR^{aa}, —C(═S)N(R^{cc})₂, —C(═O)SR^{cc}, —C(═S)SR^{cc}, —P(═O)(OR^{cc})₂, —P(═O)(R^{aa})₂, —P(═O)(N(R^{cc})₂)₂, C₁₋₁₀ alkyl, C₁₋₁₀ perhaloalkyl, C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl, or two R^{cc} groups attached to an N atom are joined to form a 3-14 membered heterocyclyl or 5-14 membered heteroaryl ring, wherein each alkyl, alkenyl, alkynyl, heteroalkyl, heteroalkenyl, heteroalkynyl, carbocyclyl, heterocyclyl, aryl, and heteroaryl is independently substituted with 0, 1, 2, 3, 4, or 5 R^{dd} groups, and wherein R^{aa}, R^{bb}, R^{cc} and R^{dd} are as defined above.

In certain embodiments, the substituent present on the nitrogen atom is an nitrogen protecting group (also referred to herein as an “amino protecting group”). Nitrogen protecting groups include, but are not limited to, —OH, —OR^{aa}, —N(R^{cc})₂, —C(═O)R^{aa}, —C(═O)N(R^{cc})₂, —CO₂R^{aa}, —SO₂R^{aa}, —C(═NR^{cc})R^{aa}, —C(═NR^{cc})OR^{aa}, —C(═NR^{cc})N(R^{cc})₂, —SO₂N(R^{cc})₂, —SO₂R^{cc}, —SO₂ORC, —SOR^{aa}, —C(═S)N(R^{cc})₂, —C(═O)SR^{cc}, —C(═S)SR^{cc}, C₁₋₁₀ alkyl (e.g., aralkyl, heteroaralkyl), C₂₋₁₀ alkenyl, C₂₋₁₀ alkynyl, heteroC₁₋₁₀ alkyl, heteroC₂₋₁₀ alkenyl, heteroC₂₋₁₀ alkynyl, C₃₋₁₀ carbocyclyl, 3-14 membered heterocyclyl, C₆₋₁₄ aryl, and 5-14 membered heteroaryl groups, wherein each alkyl, alkenyl, alkynyl, heteroalkyl, heteroalkenyl, heteroalkynyl, carbocyclyl, heterocyclyl, aralkyl, aryl, and heteroaryl is independently substituted with 0, 1, 2, 3, 4, or 5 R^{dd} groups, and wherein R^{aa}, R^{bb}, R^{cc}, and R^{dd} are as defined herein. Nitrogen protecting groups are well known in the art and include those described in detail in Protecting Groups in Organic Synthesis, T. W. Greene and P. G. M. Wuts, 3^{rd} edition, John Wiley & Sons, 1999, incorporated herein by reference.

For example, nitrogen protecting groups such as amide groups (e.g., —C(═O)R^{aa}) include, but are not limited to, formamide, acetamide, chloroacetamide, trichloroacetamide, trifluoroacetamide, phenylacetamide, 3-phenylpropanamide, picolinamide, 3-pyridylcarboxamide, N-benzoylphenylalanyl derivative, benzamide, p-phenylbenzamide, o-nitophenylacetamide, o-nitrophenoxyacetamide, acetoacetamide, (N′-dithiobenzyloxyacylamino)acetamide, 3-(p-hydroxyphenyl)propanamide, 3-(o-nitrophenyl)propanamide, 2-methyl-2-(o-nitrophenoxy)propanamide, 2-methyl-2-(o-phenylazophenoxy)propanamide, 4-chlorobutanamide, 3-methyl-3-nitrobutanamide, o-nitrocinnamide, N-acetylmethionine derivative, o-nitrobenzamide and o-(benzoyloxymethyl)benzamide.

Nitrogen protecting groups such as carbamate groups (e.g., —C(═O)OR^{aa}) include, but are not limited to, methyl carbamate, ethyl carbamate, 9-fluorenylmethyl carbamate (Fmoc), 9-(2-sulfo)fluorenylmethyl carbamate, 9-(2,7-dibromo)fluoroenylmethyl carbamate, 2,7-di-t-butyl-[9-(10,10-dioxo-10,10,10,10-tetrahydrothioxanthyl)]methyl carbamate (DBD-Tmoc), 4-methoxyphenacyl carbamate (Phenoc), 2,2,2-trichloroethyl carbamate (Troc), 2-trimethylsilylethyl carbamate (Teoc), 2-phenylethyl carbamate (hZ), 1-(1-adamantyl)-1-methylethyl carbamate (Adpoc), 1,1-dimethyl-2-haloethyl carbamate, 1,1-dimethyl-2,2-dibromoethyl carbamate (DB-t-BOC), 1,1-dimethyl-2,2,2-trichloroethyl carbamate (TCBOC), 1-methyl-1-(4-biphenylyl)ethyl carbamate (Bpoc), 1-(3,5-di-t-butylphenyl)-1-methylethyl carbamate (t-Bumeoc), 2-(2′- and 4′-pyridyl)ethyl carbamate (Pyoc), 2-(N,N-dicyclohexylcarboxamido)ethyl carbamate, t-butyl carbamate (BOC or Boc), 1-adamantyl carbamate (Adoc), vinyl carbamate (Voc), allyl carbamate (Alloc), 1-isopropylallyl carbamate (Ipaoc), cinnamyl carbamate (Coc), 4-nitrocinnamyl carbamate (Noc), 8-quinolyl carbamate, N-hydroxypiperidinyl carbamate, alkyldithio carbamate, benzyl carbamate (Cbz), p-methoxybenzyl carbamate (Moz), p-nitobenzyl carbamate, p-bromobenzyl carbamate, p-chlorobenzyl carbamate, 2,4-dichlorobenzyl carbamate, 4-methylsulfinylbenzyl carbamate (Msz), 9-anthrylmethyl carbamate, diphenylmethyl carbamate, 2-methylthioethyl carbamate, 2-methylsulfonylethyl carbamate, 2-(p-toluenesulfonyl)ethyl carbamate, [2-(1,3-dithianyl)]methyl carbamate (Dmoc), 4-methylthiophenyl carbamate (Mtpc), 2,4-dimethylthiophenyl carbamate (Bmpc), 2-phosphonioethyl carbamate (Peoc), 2-triphenylphosphonioisopropyl carbamate (Ppoc), 1,1-dimethyl-2-cyanoethyl carbamate, m-chloro-p-acyloxybenzyl carbamate, p-(dihydroxyboryl)benzyl carbamate, 5-benzisoxazolylmethyl carbamate, 2-(trifluoromethyl)-6-chromonylmethyl carbamate (Tcroc), m-nitrophenyl carbamate, 3,5-dimethoxybenzyl carbamate, o-nitrobenzyl carbamate, 3,4-dimethoxy-6-nitrobenzyl carbamate, phenyl(o-nitrophenyl)methyl carbamate, t-amyl carbamate, S-benzyl thiocarbamate, p-cyanobenzyl carbamate, cyclobutyl carbamate, cyclohexyl carbamate, cyclopentyl carbamate, cyclopropylmethyl carbamate, p-decyloxybenzyl carbamate, 2,2-dimethoxyacylvinyl carbamate, o-(N,N-dimethylcarboxamido)benzyl carbamate, 1,1-dimethyl-3-(N,N-dimethylcarboxamido)propyl carbamate, 1,1-dimethylpropynyl carbamate, di(2-pyridyl)methyl carbamate, 2-furanylmethyl carbamate, 2-iodoethyl carbamate, isoborynl carbamate, isobutyl carbamate, isonicotinyl carbamate, p-(p′-methoxyphenylazo)benzyl carbamate, 1-methylcyclobutyl carbamate, 1-methylcyclohexyl carbamate, 1-methyl-1-cyclopropylmethyl carbamate, 1-methyl-1-(3,5-dimethoxyphenyl)ethyl carbamate, 1-methyl-1-(p-phenylazophenyl)ethyl carbamate, 1-methyl-1-phenylethyl carbamate, 1-methyl-1-(4-pyridyl)ethyl carbamate, phenyl carbamate, p-(phenylazo)benzyl carbamate, 2,4,6-tri-t-butylphenyl carbamate, 4-(trimethylammonium)benzyl carbamate, and 2,4,6-trimethylbenzyl carbamate.

Nitrogen protecting groups such as sulfonamide groups (e.g., —S(═O)₂R^{aa}) include, but are not limited to, p-toluenesulfonamide (Ts), benzenesulfonamide, 2,3,6-trimethyl-4-methoxybenzenesulfonamide (Mtr), 2,4,6-trimethoxybenzenesulfonamide (Mtb), 2,6-dimethyl-4-methoxybenzenesulfonamide (Pme), 2,3,5,6-tetramethyl-4-methoxybenzenesulfonamide (Mte), 4-methoxybenzenesulfonamide (Mbs), 2,4,6-trimethylbenzenesulfonamide (Mts), 2,6-dimethoxy-4-methylbenzenesulfonamide (iMds), 2,2,5,7,8-pentamethylchroman-6-sulfonamide (Pmc), methanesulfonamide (Ms), (3-trimethylsilylethanesulfonamide (SES), 9-anthracenesulfonamide, 4-(4′,8′-dimethoxynaphthylmethyl)benzenesulfonamide (DNMBS), benzylsulfonamide, trifluoromethylsulfonamide, and phenacylsulfonamide.

Other nitrogen protecting groups include, but are not limited to, phenothiazinyl-(10)-acyl derivative, N′-p-toluenesulfonylaminoacyl derivative, N′-phenylaminothioacyl derivative, N-benzoylphenylalanyl derivative, N-acetylmethionine derivative, 4,5-diphenyl-3-oxazolin-2-one, N-phthalimide, N-dithiasuccinimide (Dts), N-2,3-diphenylmaleimide, N-2,5-dimethylpyrrole, N-1,1,4,4-tetramethyldisilylazacyclopentane adduct (STABASE), 5-substituted 1,3-dimethyl-1,3,5-triazacyclohexan-2-one, 5-substituted 1,3-dibenzyl-1,3,5-triazacyclohexan-2-one, 1-substituted 3,5-dinitro-4-pyridone, N-methylamine, N-allylamine, N-[2-(trimethylsilyl)ethoxy]methylamine (SEM), N-3-acetoxypropylamine, N-(1-isopropyl-4-nitro-2-oxo-3-pyroolin-3-yl)amine, quaternary ammonium salts, N-benzylamine, N-di(4-methoxyphenyl)methylamine, N-5-dibenzosuberylamine, N-triphenylmethylamine (Tr), N-[(4-methoxyphenyl)diphenylmethyl]amine (MMTr), N-9-phenylfluorenylamine (PhF), N-2,7-dichloro-9-fluorenylmethyleneamine, N-ferrocenylmethylamino (Fcm), N-2-picolylamino N′-oxide, N-1,1-dimethylthiomethyleneamine, N-benzylideneamine, N-p-methoxybenzylideneamine, N-diphenylmethyleneamine, N-[(2-pyridyl)mesityl]methyleneamine, N—(N′,N′-dimethylaminomethylene)amine, N,N′-isopropylidenediamine, N-p-nitrobenzylideneamine, N-salicylideneamine, N-5-chlorosalicylideneamine, N-(5-chloro-2-hydroxyphenyl)phenylmethyleneamine, N-cyclohexylideneamine, N-(5,5-dimethyl-3-oxo-1-cyclohexenyl)amine, N-borane derivative, N-diphenylborinic acid derivative, N-[phenyl(pentaacylchromium- or tungsten)acyl]amine, N-copper chelate, N-zinc chelate, N-nitroamine, N-nitrosoamine, amine N-oxide, diphenylphosphinamide (Dpp), dimethylthiophosphinamide (Mpt), diphenylthiophosphinamide (Ppt), dialkyl phosphoramidates, dibenzyl phosphoramidate, diphenyl phosphoramidate, benzenesulfenamide, o-nitrobenzenesulfenamide (Nps), 2,4-dinitrobenzenesulfenamide, pentachlorobenzenesulfenamide, 2-nitro-4-methoxybenzenesulfenamide, triphenylmethylsulfenamide, and 3-nitropyridinesulfenamide (Npys). In certain embodiments, a nitrogen protecting group is benzyl (Bn), tert-butyloxycarbonyl (BOC), carbobenzyloxy (Cbz), 9-flurenylmethyloxycarbonyl (Fmoc), trifluoroacetyl, triphenylmethyl, acetyl (Ac), benzoyl (Bz), p-methoxybenzyl (PMB), 3,4-dimethoxybenzyl (DMPM), p-methoxyphenyl (PMP), 2,2,2-trichloroethyloxycarbonyl (Troc), triphenylmethyl (Tr), tosyl (Ts), brosyl (Bs), nosyl (Ns), mesyl (Ms), triflyl (Tf), or dansyl (Ds).

In certain embodiments, the substituent present on an oxygen atom is an oxygen protecting group (also referred to herein as an “hydroxyl protecting group”). Oxygen protecting groups include, but are not limited to, —R^{aa}, —N(R^{bb})₂, —C(═O)SR^{aa}, —C(═O)R^{aa}, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{cc})₂, —P(R^{cc})₃⁺X⁻, —P(OR^{cc})₂, —P(OR^{cc})₃⁺X⁻, —P(═O)(R^{aa})₂, —P(═O)(OR^{cc})₂, and —P(═O)(N(R^{bb})₂)₂, wherein X⁻, R^{aa}, R^{bb}, and R^{cc} are as defined herein. Oxygen protecting groups are well known in the art and include those described in detail in Protecting Groups in Organic Synthesis, T. W. Greene and P. G. M. Wuts, 3^{rd} edition, John Wiley & Sons, 1999, incorporated herein by reference.

Exemplary oxygen protecting groups include, but are not limited to, methyl, methoxylmethyl (MOM), methylthiomethyl (MTM), t-butylthiomethyl, (phenyldimethylsilyl)methoxymethyl (SMOM), benzyloxymethyl (BOM), p-methoxybenzyloxymethyl (PMBM), (4-methoxyphenoxy)methyl (p-AOM), guaiacolmethyl (GUM), t-butoxymethyl, 4-pentenyloxymethyl (POM), siloxymethyl, 2-methoxyethoxymethyl (MEM), 2,2,2-trichloroethoxymethyl, bis(2-chloroethoxy)methyl, 2-(trimethylsilyl)ethoxymethyl (SEMOR), tetrahydropyranyl (THP), 3-bromotetrahydropyranyl, tetrahydrothiopyranyl, 1-methoxycyclohexyl, 4-methoxytetrahydropyranyl (MTHP), 4-methoxytetrahydrothiopyranyl, 4-methoxytetrahydrothiopyranyl S,S-dioxide, 1-[(2-chloro-4-methyl)phenyl]-4-methoxypiperidin-4-yl (CTMP), 1,4-dioxan-2-yl, tetrahydrofuranyl, tetrahydrothiofuranyl, 2,3,3a,4,5,6,7,7a-octahydro-7,8,8-trimethyl-4,7-methanobenzofuran-2-yl, 1-ethoxyethyl, 1-(2-chloroethoxy)ethyl, 1-methyl-1-methoxyethyl, 1-methyl-1-benzyloxyethyl, 1-methyl-1-benzyloxy-2-fluoroethyl, 2,2,2-trichloroethyl, 2-trimethylsilylethyl, 2-(phenylselenyl)ethyl, t-butyl, allyl, p-chlorophenyl, p-methoxyphenyl, 2,4-dinitrophenyl, benzyl (Bn), p-methoxybenzyl, 3,4-dimethoxybenzyl, o-nitrobenzyl, p-nitrobenzyl, p-halobenzyl, 2,6-dichlorobenzyl, p-cyanobenzyl, p-phenylbenzyl, 2-picolyl, 4-picolyl, 3-methyl-2-picolyl N-oxido, diphenylmethyl, p,p′-dinitrobenzhydryl, 5-dibenzosuberyl, triphenylmethyl, α-naphthyldiphenylmethyl, p-methoxyphenyldiphenylmethyl, di(p-methoxyphenyl)phenylmethyl, tri(p-methoxyphenyl)methyl, 4-(4′-bromophenacyloxyphenyl)diphenylmethyl, 4,4′,4″-tris(4,5-dichlorophthalimidophenyl)methyl, 4,4′,4″-tris(levulinoyloxyphenyl)methyl, 4,4′,4″-tris(benzoyloxyphenyl)methyl, 3-(imidazol-1-yl)bis(4′,4″-dimethoxyphenyl)methyl, 1,1-bis(4-methoxyphenyl)-1′-pyrenylmethyl, 9-anthryl, 9-(9-phenyl)xanthenyl, 9-(9-phenyl-10-oxo)anthryl, 1,3-benzodithiolan-2-yl, benzisothiazolyl S,S-dioxido, trimethylsilyl (TMS), triethylsilyl (TES), triisopropylsilyl (TIPS), dimethylisopropylsilyl (IPDMS), diethylisopropylsilyl (DEIPS), dimethylthexylsilyl, t-butyldimethylsilyl (TBDMS), t-butyldiphenylsilyl (TBDPS), tribenzylsilyl, tri-p-xylylsilyl, triphenylsilyl, diphenylmethylsilyl (DPMS), t-butylmethoxyphenylsilyl (TBMPS), formate, benzoylformate, acetate, chloroacetate, dichloroacetate, trichloroacetate, trifluoroacetate, methoxyacetate, triphenylmethoxyacetate, phenoxyacetate, p-chlorophenoxyacetate, 3-phenylpropionate, 4-oxopentanoate (levulinate), 4,4-(ethylenedithio)pentanoate (levulinoyldithioacetal), pivaloate, adamantoate, crotonate, 4-methoxycrotonate, benzoate, p-phenylbenzoate, 2,4,6-trimethylbenzoate (mesitoate), methyl carbonate, 9-fluorenylmethyl carbonate (Fmoc), ethyl carbonate, 2,2,2-trichloroethyl carbonate (Troc), 2-(trimethylsilyl)ethyl carbonate (TMSEC), 2-(phenylsulfonyl) ethyl carbonate (Psec), 2-(triphenylphosphonio) ethyl carbonate (Peoc), isobutyl carbonate, vinyl carbonate, allyl carbonate, t-butyl carbonate (BOC or Boc), p-nitrophenyl carbonate, benzyl carbonate, p-methoxybenzyl carbonate, 3,4-dimethoxybenzyl carbonate, o-nitrobenzyl carbonate, p-nitrobenzyl carbonate, S-benzyl thiocarbonate, 4-ethoxy-1-napththyl carbonate, methyl dithiocarbonate, 2-iodobenzoate, 4-azidobutyrate, 4-nitro-4-methylpentanoate, o-(dibromomethyl)benzoate, 2-formylbenzenesulfonate, 2-(methylthiomethoxy)ethyl, 4-(methylthiomethoxy)butyrate, 2-(methylthiomethoxymethyl)benzoate, 2,6-dichloro-4-methylphenoxyacetate, 2,6-dichloro-4-(1,1,3,3-tetramethylbutyl)phenoxyacetate, 2,4-bis(1,1-dimethylpropyl)phenoxyacetate, chlorodiphenylacetate, isobutyrate, monosuccinoate, (E)-2-methyl-2-butenoate, o-(methoxyacyl)benzoate, α-naphthoate, nitrate, alkyl N,N,N′,N′-tetramethylphosphorodiamidate, alkyl N-phenylcarbamate, borate, dimethylphosphinothioyl, alkyl 2,4-dinitrophenylsulfenate, sulfate, methanesulfonate (mesylate), benzylsulfonate, and tosylate (Ts). In certain embodiments, an oxygen protecting group is silyl. In certain embodiments, an oxygen protecting group is t-butyldiphenylsilyl (TBDPS), t-butyldimethylsilyl (TBDMS), triisoproylsilyl (TIPS), triphenylsilyl (TPS), triethylsilyl (TES), trimethylsilyl (TMS), triisopropylsiloxymethyl (TOM), acetyl (Ac), benzoyl (Bz), allyl carbonate, 2,2,2-trichloroethyl carbonate (Troc), 2-trimethylsilylethyl carbonate, methoxymethyl (MOM), 1-ethoxyethyl (EE), 2-methyoxy-2-propyl (MOP), 2,2,2-trichloroethoxyethyl, 2-methoxyethoxymethyl (MEM), 2-trimethylsilylethoxymethyl (SEM), methylthiomethyl (MTM), tetrahydropyranyl (THP), tetrahydrofuranyl (THF), p-methoxyphenyl (PMP), triphenylmethyl (Tr), methoxytrityl (MMT), dimethoxytrityl (DMT), allyl, p-methoxybenzyl (PMB), t-butyl, benzyl (Bn), allyl, or pivaloyl (Piv).

In certain embodiments, the substituent present on a sulfur atom is a sulfur protecting group (also referred to as a “thiol protecting group”). Sulfur protecting groups include, but are not limited to, —R^{aa}, —N(R^{bb})₂, —C(═O)SR^{aa}, —C(═O)R—, —CO₂R^{aa}, —C(═O)N(R^{bb})₂, —C(═NR^{bb})R^{aa}, —C(═NR^{bb})OR^{aa}, —C(═NR^{bb})N(R^{bb})₂, —S(═O)R^{aa}, —SO₂R^{aa}, —Si(R^{aa})₃, —P(R^{cc})₂, —P(R^{aa})₃⁺X⁻, —P(OR^{cc})₂, —P(OR^{aa})₃⁺X⁻, —P(═O)(R^{aa})₂, —P(═O)(OR^{cc})₂, and —P(═O)(N(R^{bb})₂)₂, wherein R^{aa}, R^{bb}, and R^{cc} are as defined herein. Sulfur protecting groups are well known in the art and include those described in detail in Protecting Groups in Organic Synthesis, T. W. Greene and P. G. M. Wuts, 3^{rd} edition, John Wiley & Sons, 1999, incorporated herein by reference. In certain embodiments, a sulfur protecting group is acetamidomethyl, t-Bu, 3-nitro-2-pyridine sulfenyl, 2-pyridine-sulfenyl, or triphenylmethyl.

A “counterion” or “anionic counterion” is a negatively charged group associated with a positively charged group in order to maintain electronic neutrality. An anionic counterion may be monovalent (i.e., including one formal negative charge). An anionic counterion may also be multivalent (i.e., including more than one formal negative charge), such as divalent or trivalent. Exemplary counterions include halide ions (e.g., F⁻, Cl⁻, Br⁻, I⁻), NO₃⁻, ClO₄⁻, OH⁻, H₂PO₄⁻, HCO₃⁻, HSO₄⁻, sulfonate ions (e.g., methansulfonate, trifluoromethanesulfonate, p-toluenesulfonate, benzenesulfonate, 10-camphor sulfonate, naphthalene-2-sulfonate, naphthalene-1-sulfonic acid-5-sulfonate, ethan-1-sulfonic acid-2-sulfonate, and the like), carboxylate ions (e.g., acetate, propanoate, benzoate, glycerate, lactate, tartrate, glycolate, gluconate, and the like), BF₄⁻, PF₄⁻, PF₆⁻, AsF₆⁻, SbF₆⁻, B[3,5-(CF₃)₂C₆H₃]₄]⁻, B(C₆F₅)₄⁻, BPh₄⁻, Al(OC(CF₃)₃)₄—, and carborane anions (e.g., CB₁₁H₁₂⁻ or (HCB₁₁Me₅Br₆)⁻). Exemplary counterions which may be multivalent include CO₃²⁻, HPO₄²⁻, PO₄³⁻, B₄O₇²⁻, SO₄²⁻, S₂O₃²⁻, carboxylate anions (e.g., tartrate, citrate, fumarate, maleate, malate, malonate, gluconate, succinate, glutarate, adipate, pimelate, suberate, azelate, sebacate, salicylate, phthalates, aspartate, glutamate, and the like), and carboranes.

The term “leaving group” is given its ordinary meaning in the art of synthetic organic chemistry and refers to an atom or a group capable of being displaced by a nucleophile. See, for example, Smith, March's Advanced Organic Chemistry 6th ed. (501-502). Examples of suitable leaving groups include, but are not limited to, halogen (such as F, Cl, Br, or I (iodine)), alkoxycarbonyloxy, aryloxycarbonyloxy, alkanesulfonyloxy, arenesulfonyloxy, alkyl-carbonyloxy (e.g., acetoxy), arylcarbonyloxy, aryloxy, methoxy, N,O-dimethylhydroxylamino, pixyl, and haloformates. In some cases, the leaving group is a sulfonic acid ester, such as toluenesulfonate (tosylate, -OTs), methanesulfonate (mesylate, -OMs), p-bromobenzenesulfonyloxy (brosylate, -OBs), —OS(═O)₂(CF₂)₃CF₃ (nonaflate, —ONf), or trifluoromethanesulfonate (triflate, -OTf). In some cases, the leaving group is a brosylate, such as p-bromobenzenesulfonyloxy. In some cases, the leaving group is a nosylate, such as 2-nitrobenzenesulfonyloxy. The leaving group may also be a phosphineoxide (e.g., formed during a Mitsunobu reaction) or an internal leaving group such as an epoxide or cyclic sulfate. Other non-limiting examples of leaving groups are water, ammonia, alcohols, ether moieties, thioether moieties, zinc halides, magnesium moieties, diazonium salts, and copper moieties. Further exemplary leaving groups include, but are not limited to, halo (e.g., chloro, bromo, iodo) and activated substituted hydroxyl groups (e.g., —OC(═O)SR^{aa}, —OC(═O)R^{aa}, —OCO₂R^{aa}, —OC(═O)N(R^{bb})₂, —OC(═NR^{bb})R—, —OC(═NR^{bb})OR—, —OC(═NR^{bb})N(R^{bb})₂, —OS(═O)R^{a}, —OSO₂R^{aa}, —OP(R^{cc})₂, —OP(R^{aa})₃, —OP(═O)₂R^{aa}, —OP(═O)(R^{aa})₂, —OP(═O)(OR^{cc})₂, —OP(═O)₂N(R^{bb})₂, and —OP(═O)(NR^{bb})₂, wherein R^{aa}, R^{bb}, and R^{cc} are as defined herein).

As used herein, use of the phrase “at least one instance” refers to 1, 2, 3, 4, or more instances, but also encompasses a range, e.g., for example, from 1 to 4, from 1 to 3, from 1 to 2, from 2 to 4, from 2 to 3, or from 3 to 4 instances, inclusive.

A “non-hydrogen group” refers to any group that is defined for a particular variable that is not hydrogen.

These and other exemplary substituents are described in more detail in the Detailed Description, Examples, and Claims. The invention is not intended to be limited in any manner by the above exemplary listing of substituents.

### Other Definitions

The following definitions are more general terms used throughout the present application.

As used herein, the term “salt” refers to any and all salts, and encompasses pharmaceutically acceptable salts.

The term “pharmaceutically acceptable salt” refers to those salts which are, within the scope of sound medical judgment, suitable for use in contact with the tissues of humans and lower animals without undue toxicity, irritation, allergic response, and the like, and are commensurate with a reasonable benefit/risk ratio. Pharmaceutically acceptable salts are well known in the art. For example, Berge et al. describe pharmaceutically acceptable salts in detail in J. Pharmaceutical Sciences, 1977, 66, 1-19, incorporated herein by reference. Pharmaceutically acceptable salts of the compounds of this invention include those derived from suitable inorganic and organic acids and bases. Examples of pharmaceutically acceptable, nontoxic acid addition salts are salts of an amino group formed with inorganic acids, such as hydrochloric acid, hydrobromic acid, phosphoric acid, sulfuric acid, and perchloric acid or with organic acids, such as acetic acid, oxalic acid, maleic acid, tartaric acid, citric acid, succinic acid, or malonic acid or by using other methods known in the art such as ion exchange. Other pharmaceutically acceptable salts include adipate, alginate, ascorbate, aspartate, benzenesulfonate, benzoate, bisulfate, borate, butyrate, camphorate, camphorsulfonate, citrate, cyclopentanepropionate, digluconate, dodecylsulfate, ethanesulfonate, formate, fumarate, glucoheptonate, glycerophosphate, gluconate, hemisulfate, heptanoate, hexanoate, hydroiodide, 2-hydroxy-ethanesulfonate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 3-phenylpropionate, phosphate, picrate, pivalate, propionate, stearate, succinate, sulfate, tartrate, thiocyanate, p-toluenesulfonate, undecanoate, valerate salts, and the like. Salts derived from appropriate bases include alkali metal, alkaline earth metal, ammonium, and N⁺(C₁₋₄ alkyl)₄⁻ salts. Representative alkali or alkaline earth metal salts include sodium, lithium, potassium, calcium, magnesium, and the like. Further pharmaceutically acceptable salts include, when appropriate, nontoxic ammonium, quaternary ammonium, and amine cations formed using counterions such as halide, hydroxide, carboxylate, sulfate, phosphate, nitrate, lower alkyl sulfonate, and aryl sulfonate.

The term “tautomers” or “tautomeric” refers to two or more interconvertible compounds resulting from at least one formal migration of a hydrogen atom and at least one change in valency (e.g., a single bond to a double bond, a triple bond to a single bond, or vice versa). The exact ratio of the tautomers depends on several factors, including temperature, solvent, and pH. Tautomerizations (i.e., the reaction providing a tautomeric pair) may catalyzed by acid or base. Exemplary tautomerizations include keto-to-enol, amide-to-imide, lactam-to-lactim, enamine-to-imine, and enamine-to-(a different enamine) tautomerizations.

As described, a compound described herein is provided in any and all of its tautomeric forms, for example, and shown below:

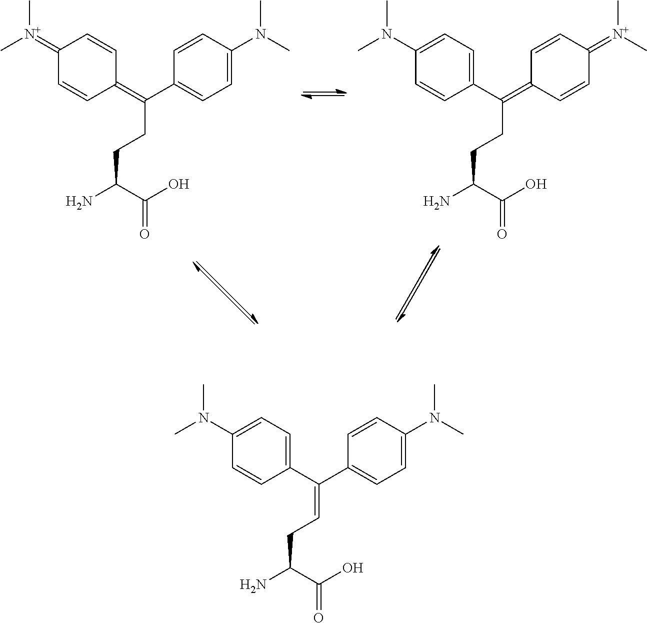

It is also to be understood that compounds that have the same molecular formula but differ in the nature or sequence of bonding of their atoms or the arrangement of their atoms in space are termed “isomers”. Isomers that differ in the arrangement of their atoms in space are termed “stereoisomers”.

Stereoisomers that are not mirror images of one another are termed “diastereomers” and those that are non-superimposable mirror images of each other are termed “enantiomers”. When a compound has an asymmetric center, for example, it is bonded to four different groups, a pair of enantiomers is possible. An enantiomer can be characterized by the absolute configuration of its asymmetric center and is described by the R- and S-sequencing rules of Cahn and Prelog, or by the manner in which the molecule rotates the plane of polarized light and designated as dextrorotatory or levorotatory (i.e., as (+) or (−)-isomers respectively). A chiral compound can exist as either individual enantiomer or as a mixture thereof. A mixture containing equal proportions of the enantiomers is called a “racemic mixture”.

The terms “composition” and “formulation” are used interchangeably.

As generally defined herein, “biomolecule” refers to any compound or biological material which may be found in a living organism. Examples of classes of biomolecules include, but are not limited to, proteins, polypeptides, nucleic acids, glycans (e.g, polysaccharides), peptidoglycans, macromolecules, small molecules, primary metabolites, secondary metabolites, natural products, etc.

A “protein,” “peptide,” or “polypeptide” comprises a polymer of amino acid residues linked together by peptide bonds. The term refers to proteins, polypeptides, and peptides of any size, structure, or function. Typically, a protein will be at least three amino acids long. A protein may refer to an individual protein or a collection of proteins. Inventive proteins preferably contain only natural amino acids, although non-natural amino acids (i.e., compounds that do not occur in nature but that can be incorporated into a polypeptide chain) and/or amino acid analogs as are known in the art may alternatively be employed. Also, one or more of the amino acids in a protein may be modified, for example, by the addition of a chemical agent such as a carbohydrate group, a hydroxyl group, a phosphate group, a farnesyl group, an isofarnesyl group, a fatty acid group, a linker for conjugation or functionalization, or other modification. A protein may also be a single molecule or may be a multi-molecular complex. A protein may be a fragment of a naturally occurring protein or peptide. A protein may be naturally occurring, recombinant, synthetic, or any combination of these. A “native” or “wild type” protein or peptide refers to the protein or peptide as it is found in nature (i.e., without further modification). In certain embodiments, a protein useful in the present invention is a therapeutic protein. Examples of therapeutic proteins are provided below and elsewhere herein.

The terms “polynucleotide”, “nucleic acid”, and “oligonucleotide” refer to a series of nucleotide bases (also called “nucleotides”) in DNA and RNA, and mean any chain of two or more nucleotides. The nucleic acids can be chimeric mixtures or derivatives or modified versions thereof, single-stranded or double-stranded. The oligonucleotide can be modified at the base moiety, sugar moiety, or phosphate backbone, for example, to improve stability of the molecule, its hybridization parameters, etc. A nucleotide sequence typically carries genetic information, including the information used by cellular machinery to make proteins and enzymes.

As used herein, the terms “incorporated” or “incorporation” when used with respect to two or more molecules, means that the molecules are physically associated or connected with one another, either directly or via one or more additional moieties that serves as a linking agent, to form a structure that is sufficiently stable so that the moieties remain physically associated under the conditions in which the structure is used, e.g., physiological conditions. The moieties can be connected via covalent or non-covalent interactions. In some instances, moieties are connected by covalent bonds. In some instances, moieties are connected by non-covalent interactions. The terms “covalently incorporated” or “covalently attached” implies that the two molecules are connected via one or more covalent bonds.

The terms “glycan” and “polysaccharide” refer to compounds consisting of a large number of monosaccharides linked glycosidically. The term glycan may also be used to refer to the carbohydrate portion of a glycoconjugate, such as a glycoprotein, glycolipid, or a proteoglycan. Glycans sometimes consist solely of O-glycosidic linkages of monosaccharides. Glycans can be homo- or heteropolymers of monosaccharide residues, and can be linear or branched.

The term “peptidoglycan” refers a polymer comprising sugars and amino acids. In certain embodiments, a peptidoglycan is a polymer that forms a mesh-like layer outside the plasma membrane of a cell (e.g., bacterial cell), forming the cell wall. In certain embodiments, the sugar component consists of alternating residues of 0- linked N-acetylglucosamine and N-acetylmuramic acid.

As used herein, when two or more chemical groups are “in conjugation with” one another, it is implied that the p orbitals of the chemical groups are connected in such a way that the π bond elections of the two groups are delocalized throughout the two groups, forming a π-conjugated system. In other words, two groups are “in conjugation” with each other when their π bonds are conjugated. This type of π-conjugation general lowers the overall energy of the molecule and increases stability. It can also confer fluorescent properties onto the molecule. For example, a depiction of a conjugated system (with electron delocalization) is shown below:

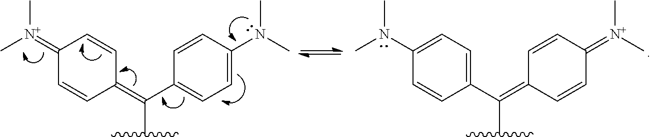

### BRIEF DESCRIPTION OF THE DRAWINGS

The accompanying drawings, which constitute a part of this specification, illustrate several embodiments of the invention and together with the description, serve to explain the principles of the invention.

FIG. 1. Enhanced green fluorescent protein (EGFP) requires maturation and in some instances is approximately 100× larger than some of the fluorogenic amino acid (FgAA) compounds provided herein.

FIG. 2. FgAA compounds described herein can be similar in size to many non-standard amino acids (nsAAs) that can be encoded into proteins in live cells, e.g., BpA. Fold “turn-on” values for exemplary FgAAs are shown.

FIGS. 3A-3C. Design of exemplary FgAAs (FIG. 3A). As shown, the exemplary compounds “turn on” in glycerol (FIG. 3B) or when incorporated to bacterial cell walls (FIG. 3C).

FIG. 4. Generic structures representing certain embodiments of FgAAs provided herein.

FIG. 5. Generic structures representing certain embodiments of FgAAs provided herein.

FIGS. 6A-6D. Excitation and absorbance data for exemplary FgAAs (Molecules a-e). Relative fluorescent units (RFU) is normalized using ‘RFU glycerol’ for each molecule independently.

FIG. 7. Normalized absorbance spectra for and structures of Molecules a and b. ** Molecule b likely has an absorbance maximum beyond the detection limit of the instrument

FIG. 8. Absorbance spectra for and structures of Molecules c and d.

FIG. 9. Normalized absorbance spectra for and structures of Molecules c and d.

FIG. 10. Summary of fluorescence fold increase data. Fold increase in fluorescence was calculated by dividing relative fluorescence units (RFU) in glycerol (95% final) by RFU in Phosphate Buffered Saline (PBS) at the same concentrations of dye. Averages of 4 independent measurements were shown. * Indicates the average RFU value in PBS was negative after subtracting the blank. Therefore the value of 1 was assumed for RFU in PBS.

### DETAILED DESCRIPTION OF CERTAIN EMBODIMENTS

Provided herein are compounds (i.e., fluorogenic amino acids (FgAAs), e.g., compounds of Formulae (I), (II), (III), and (IV)) that can be used in fluorescent labeling of biomolecules and/or cells. Also described herein are methods of labeling and/or detecting biomolecules and/or cells by incorporating the FgAA compounds described herein into the biomolecules and/or cells (e.g., by enzymatic incorporation). Also provided herein are biomolecules, cells, compositions, and kits comprising the FgAA compounds described herein.

Small, rapidly-maturing FgAA labeling reagents provided herein address many of the challenges associated with current labeling technologies. A critical problem with current technologies is the high background signal originating from unbound probes. In contrast, the FgAAs provided herein activate, or “turn on,” upon incorporation into biomolecules or macromolecules, thereby minimizing or eliminating background noise. The FgAAs have an emission intensity that is sensitive to the ability of the environment the fluorophore is in to restrict bond rotation (“spatial hindrance”). In certain embodiments, the FgAAs provided herein allow for the detection/monitoring biomolecules and cells in real time and with minimal perturbation.

### Fluorogenic Amino Acids

Provided herein are compounds of Formula (I):

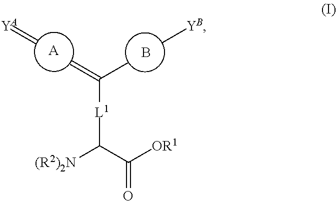

and salts, tautomers, and isotopically labeled derivatives thereof, wherein:
═Y^{A} is ═N⁺(R^{N1})₂, ═NR^{N1}, ═O⁺R^{O1}, ═O, or ═S⁺R^{S1}, or ═S;
Ring A is an optionally substituted carbocyclic, optionally substituted heterocyclic, optionally substituted aryl, or optionally substituted heteroaryl ring comprising at least one double bond in conjugation with ═Y^{A} and the group:

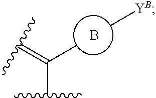

Ring B is optionally substituted aryl or optionally substituted heteroaryl ring;
Y^{B} is —N(R^{N1})₂, —OR^{O1}, or —SR^{S1};
L¹ is a bond, optionally substituted alkylene, optionally substituted heteroalkylene, optionally substituted alkenylene, optionally substituted alkynylene, optionally substituted heteroalkylene, optionally substituted heteroalkynylene, optionally substituted carbocyclylene, optionally substituted arylene, optionally substituted heterocyclylene optionally substituted heteroarylene, optionally substituted acylene, or a combination thereof;
R¹ is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, an oxygen protecting group, an amino acid, or a polypeptide;
each instance of R² is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, a nitrogen protecting group, an amino acid, or a polypeptide; or two R² bonded to the same nitrogen atom are taken together with the intervening atoms to form optionally substituted heterocyclyl or optionally substituted heteroaryl;
each instance of R^{N1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N1} bonded to the same nitrogen atom are taken together with the intervening atoms to form optionally substituted heterocyclyl or optionally substituted heteroaryl;
each instance of R^{O1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group; and
each instance of R^{S1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group.

In certain embodiments, the compound of Formula (I) is of one of the following formulae:

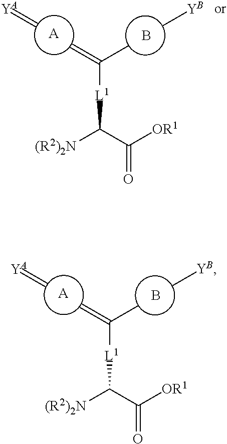

or a salt, tautomer, or isotopically labeled derivative thereof.

In certain embodiments, the compound of Formula (I) is of the formula:

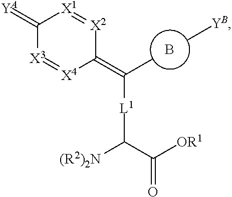

or a salt, tautomer, or isotopically labeled derivative thereof, wherein:
each of X¹, X², X³, and X⁴ are independently N or CR⁴;
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group; and
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group.

In certain embodiments, the compound of Formula (I) is of one of the following formulae:

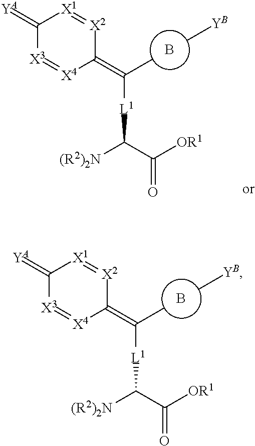

or a salt, tautomer, or isotopically labeled derivative thereof.

In certain embodiments, the compound of Formula (I) is of the formula:

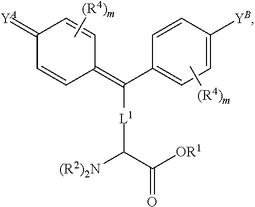

or a salt, tautomer, or isotopically labeled derivative thereof.

In certain embodiments, the compound of Formula (I) is of one of the following formulae:

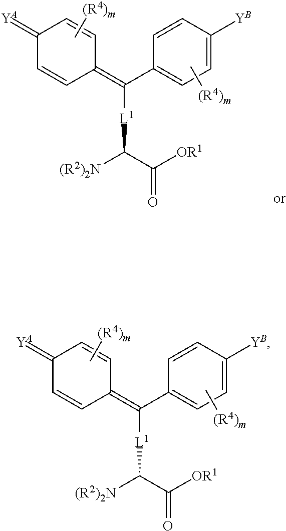

or a salt, tautomer, or isotopically labeled derivative thereof.

In certain embodiments, the compound of Formula (I) is of the formula:

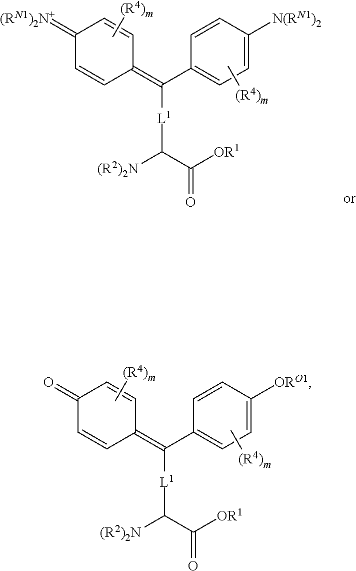

or a salt, tautomer, or isotopically labeled derivative thereof.

In certain embodiments, the compound of Formula (I) is of one of the following formulae:

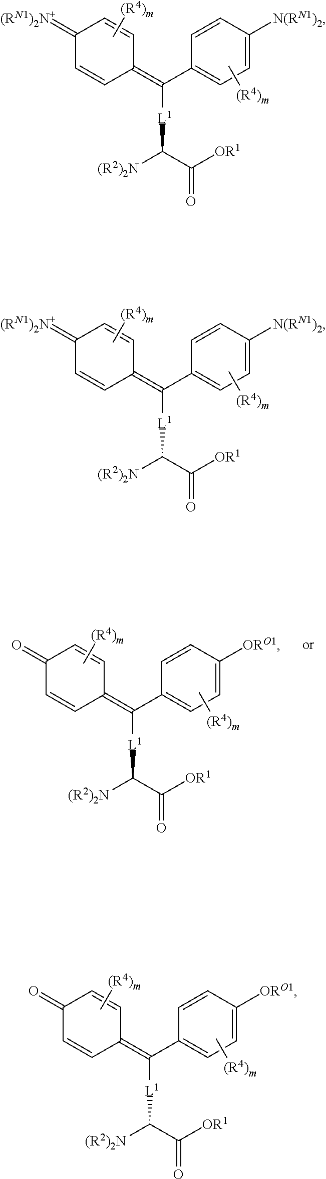

or a salt, tautomer, or isotopically labeled derivative thereof.

In certain embodiments, the compound of Formula (I) is of one of the following formulae:

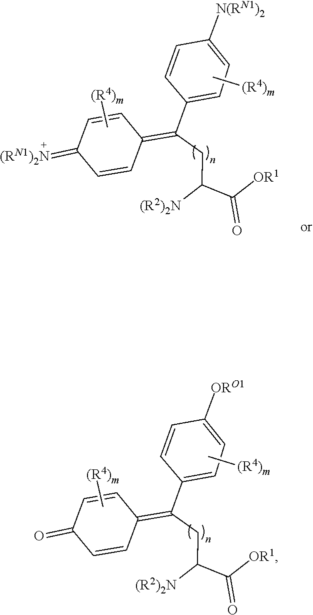

or a salt, tautomer, or isotopically labeled derivative thereof, wherein:
n is an integer from 1-6, inclusive.

In certain embodiments, the compound of Formula (I) is of one of the following formulae:

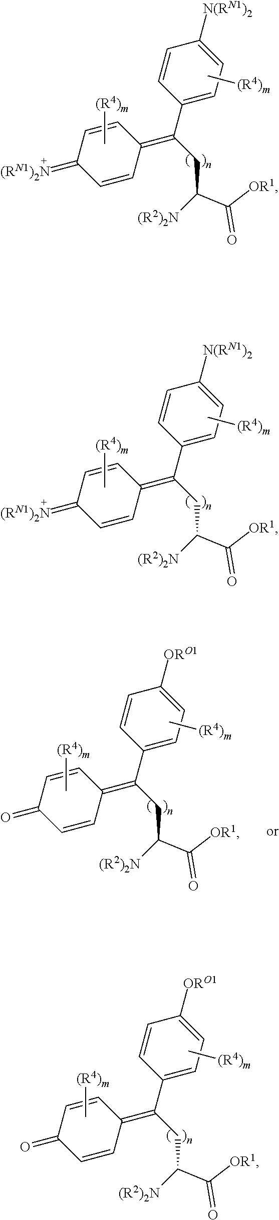

or a salt, tautomer, or isotopically labeled derivative thereof.

In certain embodiments, the compound of Formula (I) is of one of the following formulae:

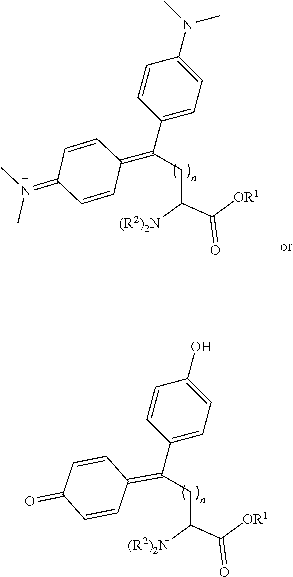

or a salt, tautomer, or isotopically labeled derivative thereof, wherein:
n is an integer from 1-6, inclusive.

In certain embodiments, the compound of Formula (I) is of one of the following formulae:

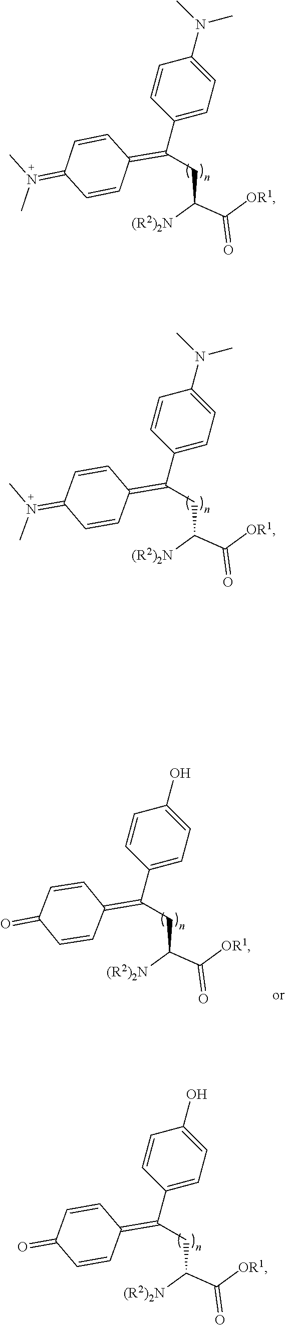

or a salt, tautomer, or isotopically labeled derivative thereof.

In certain embodiments, the compound of Formula (I) is of one of the following formulae:

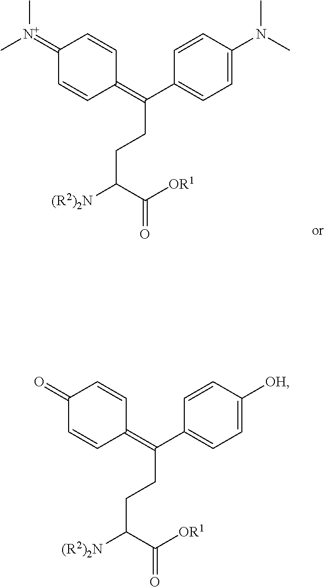

or a salt, tautomer, or isotopically labeled derivative thereof.

As described herein, the compounds may be in the form of their tautomers, for example, as shown below:

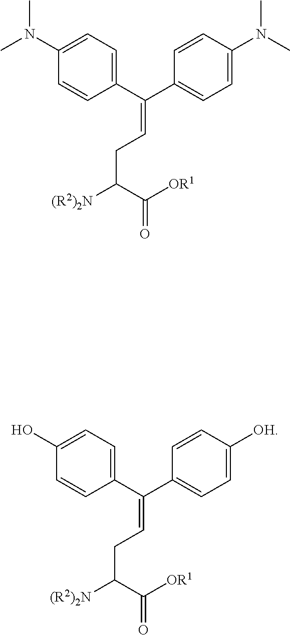

In certain embodiments, the compound of Formula (I) is of one of the following formulae:

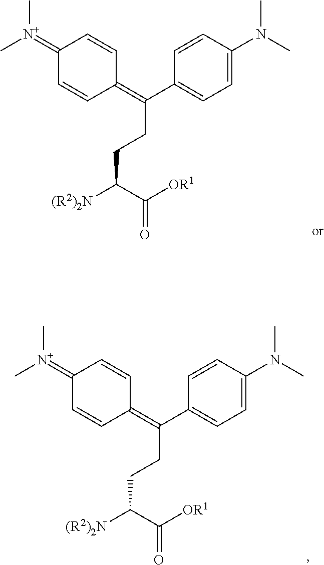

or a salt, tautomer, or isotopically labeled derivative thereof.

In certain embodiments, the compound of Formula (I) is of one of the following formulae:

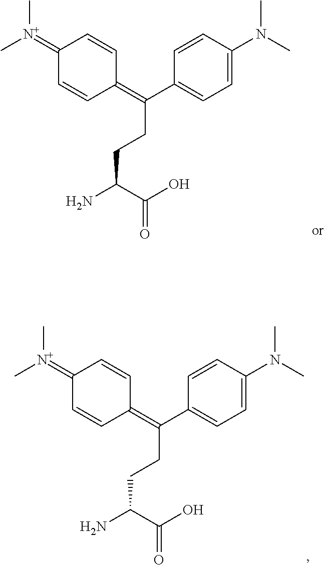

or a salt, tautomer, or isotopically labeled derivative thereof.

As described herein, the compounds may be in the form of their tautomers, for example, as shown below:

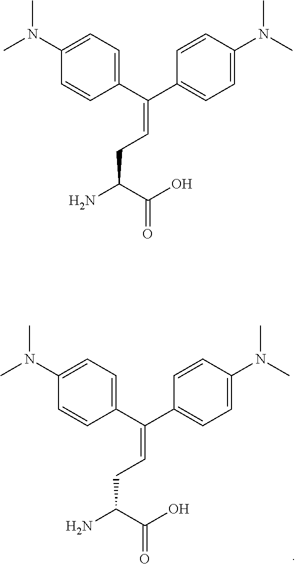

In certain embodiments, the compound of Formula (I) is of one of the following formulae:

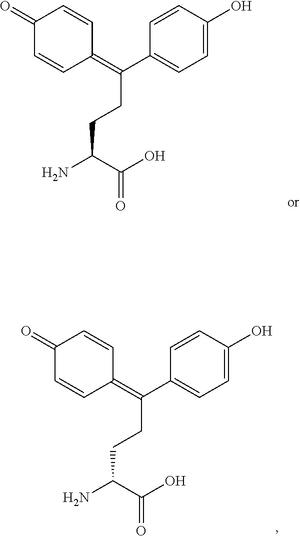 [SMILES: N[C@@H](CCC(=C1C=CC(=O)C=C1)c1ccc(O)cc1)C(=O)O ; N[C@H](CCC(=C1C=CC(=O)C=C1)c1ccc(O)cc1)C(=O)O]

or a salt, tautomer, or isotopically labeled derivative thereof.

As described herein, the compounds may be in the form of their tautomers, for example, as shown below:

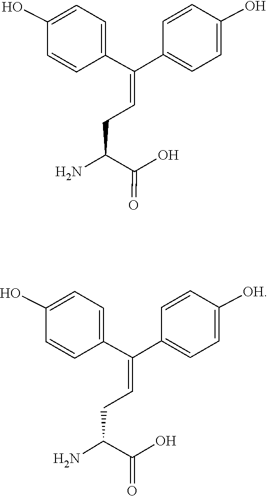 [SMILES: N[C@@H](CC=C(c1ccc(O)cc1)c1ccc(O)cc1)C(=O)O ; N[C@H](CC=C(c1ccc(O)cc1)c1ccc(O)cc1)C(=O)O]

In certain embodiments, the compound of Formula (I) is of one of the following formulae:

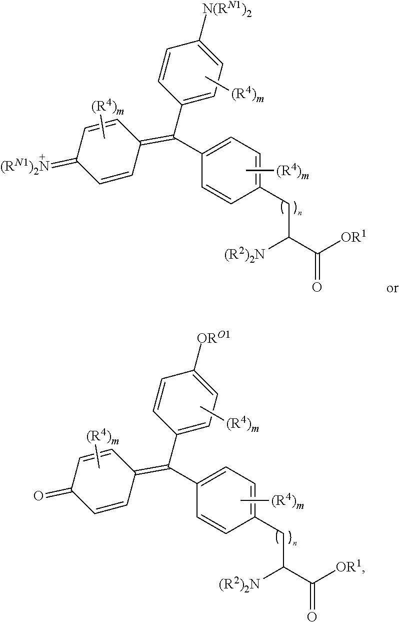

or a salt, tautomer, or isotopically labeled derivative thereof, wherein:
n is an integer from 1-6, inclusive.

In certain embodiments, the compound of Formula (I) is of one of the following formulae:

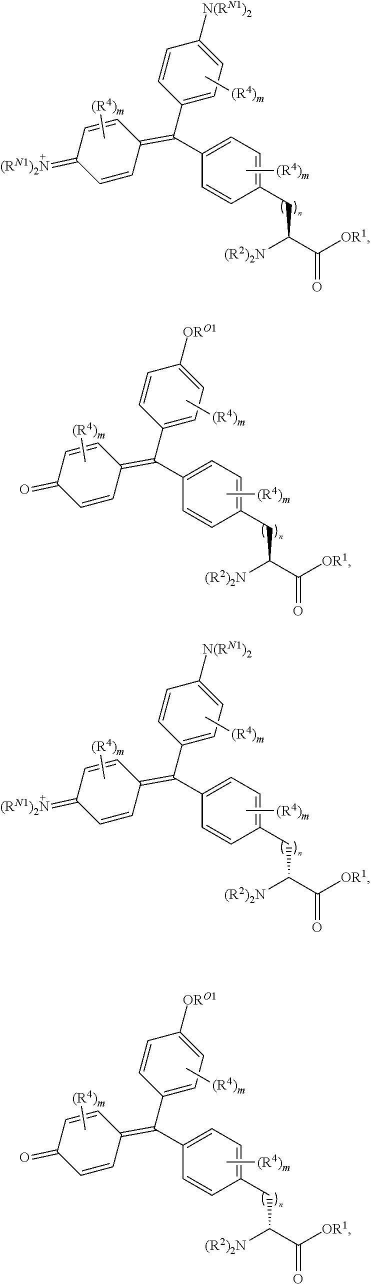

or a salt, tautomer, or isotopically labeled derivative thereof.

In certain embodiments, the compound of Formula (I) is of one of the following formulae:

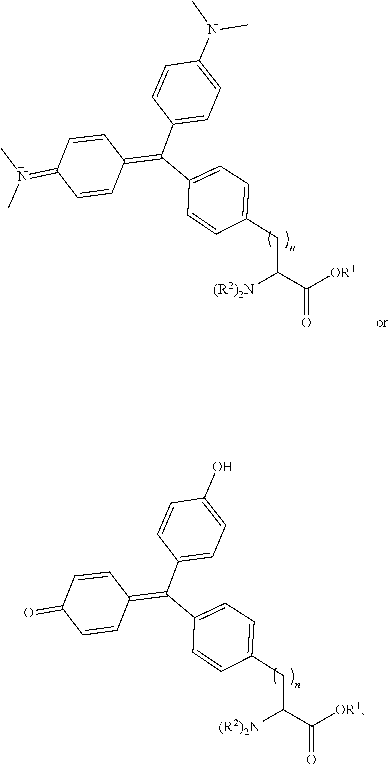

or a salt, tautomer, or isotopically labeled derivative thereof, wherein:
n is an integer from 1-6, inclusive.

In certain embodiments, the compound of Formula (I) is of one of the following formulae:

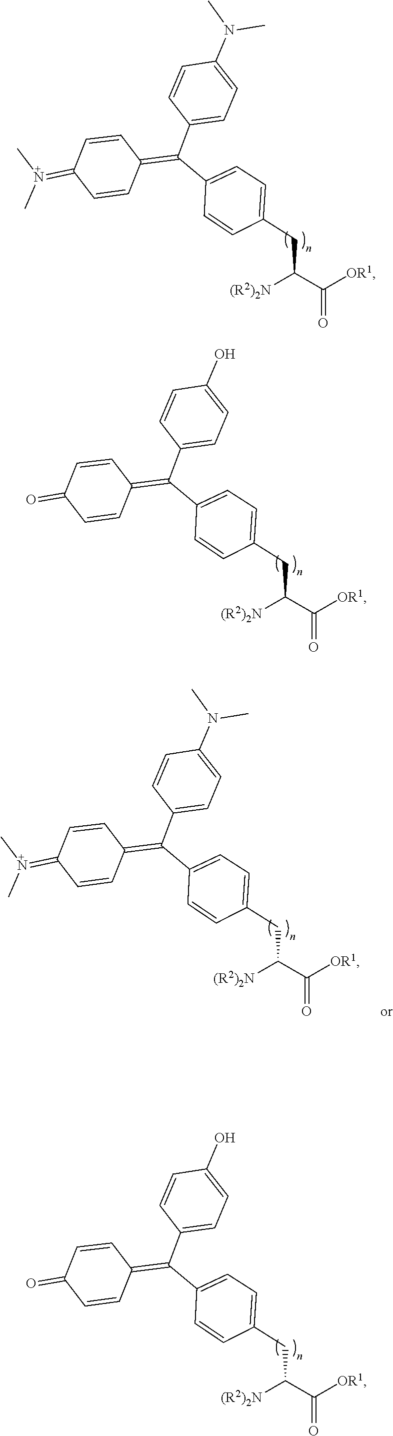

or a salt, tautomer, or isotopically labeled derivative thereof.

In certain embodiments, the compound of Formula (I) is of one of the following formulae:

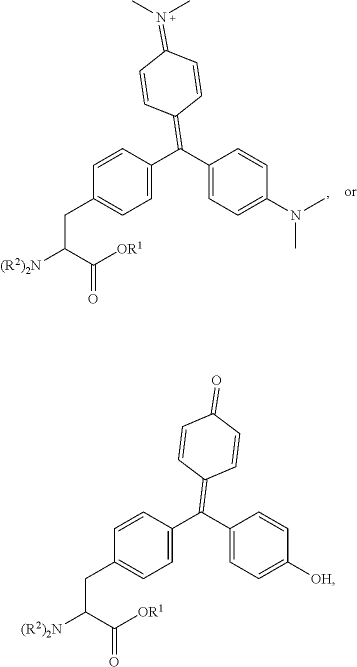

or a salt, tautomer, or isotopically labeled derivative thereof.

In certain embodiments, the compound of Formula (I) is of one of the following formulae:

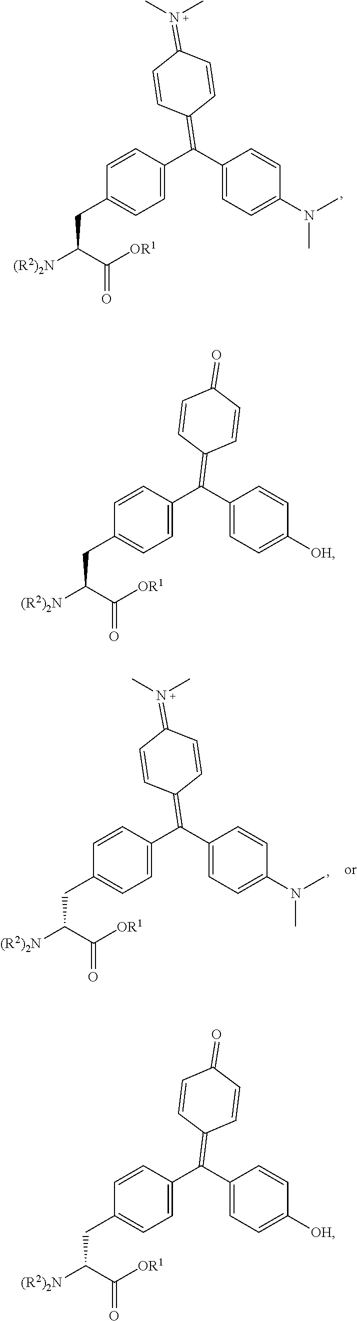

or a salt, tautomer, or isotopically labeled derivative thereof.

In certain embodiments, the compound of Formula (I) is of one of the following formulae:

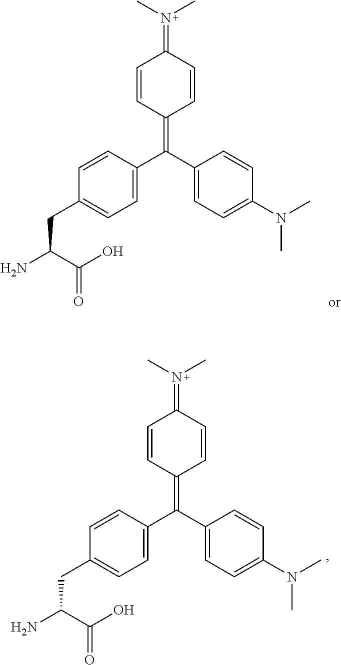

or a salt, tautomer, or isotopically labeled derivative thereof.

In certain embodiments, the compound of Formula (I) is of one of the following formulae:

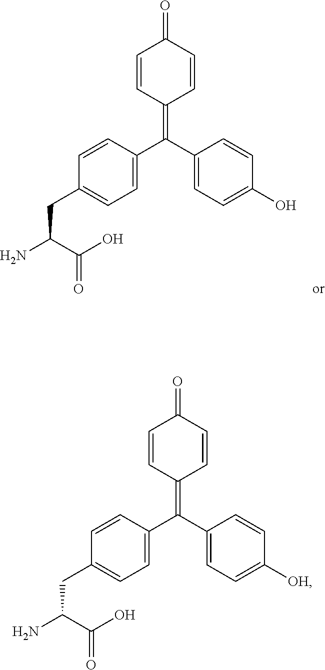 [SMILES: N[C@@H](Cc1ccc(C(=C2C=CC(=O)C=C2)c2ccc(O)cc2)cc1)C(=O)O ; N[C@H](Cc1ccc(C(=C2C=CC(=O)C=C2)c2ccc(O)cc2)cc1)C(=O)O]

or a salt, tautomer, or isotopically labeled derivative thereof.

In certain embodiments, the compound of Formula (I) is of the formula:

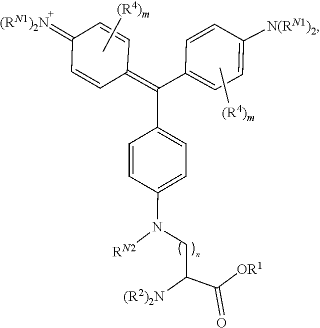

or a salt, tautomer, or isotopically labeled derivative thereof, wherein:
n is an integer from 1-6, inclusive.

In certain embodiments, the compound of Formula (I) is of one of the following formulae:

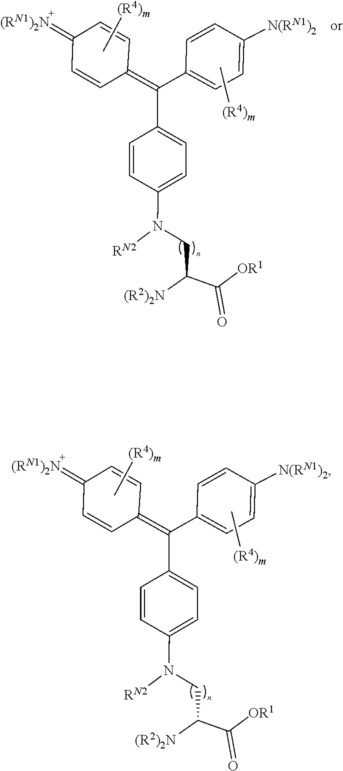

or a salt, tautomer, or isotopically labeled derivative thereof.

In certain embodiments, the compound of Formula (I) is of the formula:

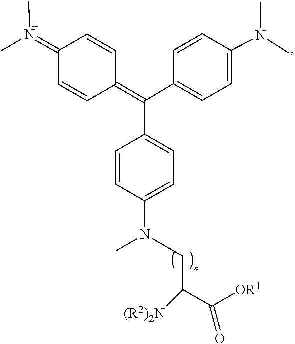

or a salt, tautomer, or isotopically labeled derivative thereof, wherein:
n is an integer from 1-6, inclusive.

In certain embodiments, the compound of Formula (I) is of one of the following formulae:

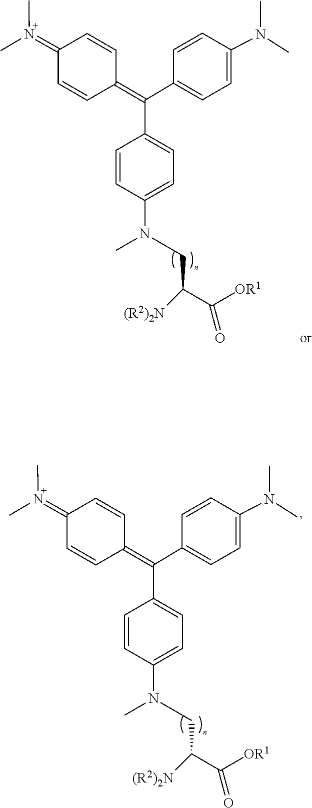

or a salt, tautomer, or isotopically labeled derivative thereof.

In certain embodiments, the compound of Formula (I) is of the formula:

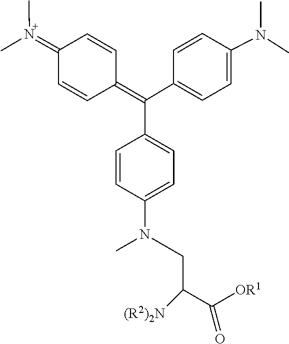

or a salt, tautomer, or isotopically labeled derivative thereof.

In certain embodiments, the compound of Formula (I) is of one of the following formulae:

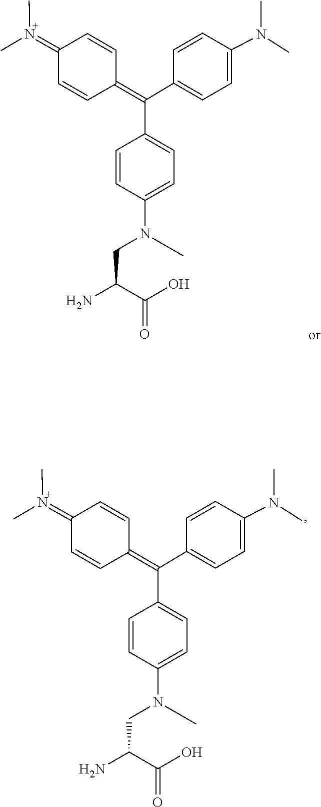

or a salt, tautomer, or isotopically labeled derivative thereof.

In certain embodiments, the compound of Formula (I) is of one of the following formulae:

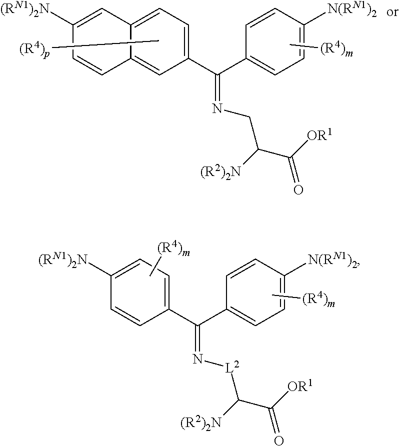

or a salt, tautomer, or isotopically labeled derivative thereof, wherein p is 0, 1, 2, 3, 4, 5, or 6.

In certain embodiments, the compound of Formula (I) is of the following formula:

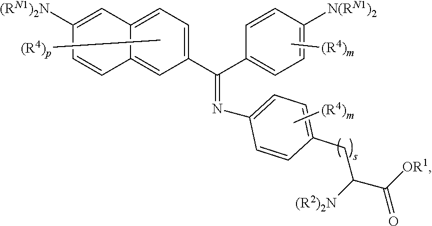

or a salt, tautomer, or isotopically labeled derivative thereof; wherein s is 0, 1, 2, 3, 4, 5, or 6.

In certain embodiments, the compound of Formula (I) is of one of the following formulae:

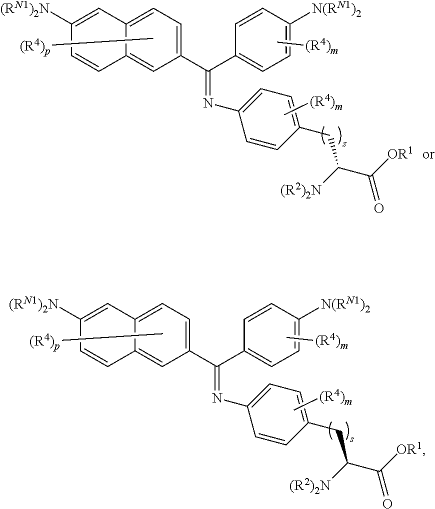

or a salt, tautomer, or isotopically labeled derivative thereof.

In certain embodiments, the compound of Formula (I) is of the formula:

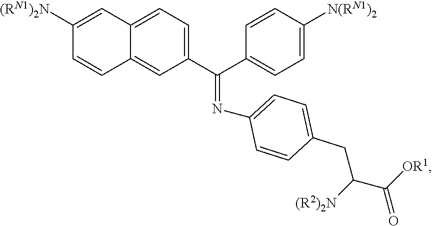

or a salt, tautomer, or isotopically labeled derivative thereof.

In certain embodiments, the compound of Formula (I) is of one of the following formulae:

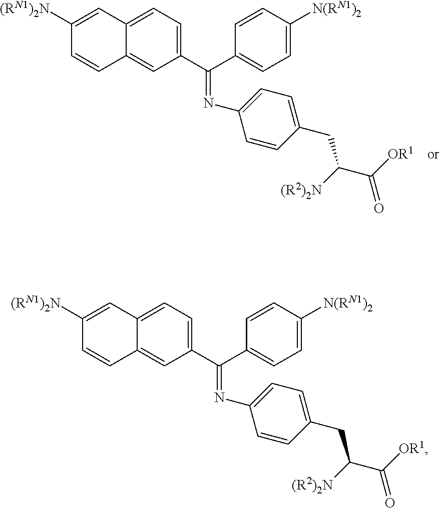

or a salt, tautomer, or isotopically labeled derivative thereof.

In certain embodiments, the compound of Formula (I) is of the formula:

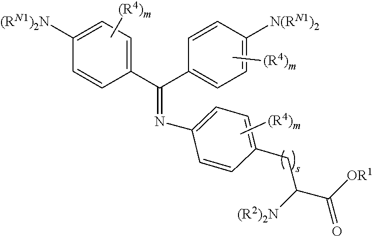

or a salt, tautomer, or isotopically labeled derivative thereof; wherein s is 0, 1, 2, 3, 4, 5, or 6.

In certain embodiments, the compound of Formula (I) is of one of the following formulae:

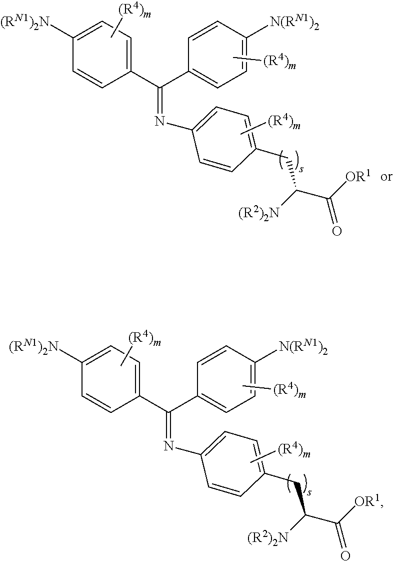

or a salt, tautomer, or isotopically labeled derivative thereof.

In certain embodiments, the compound of Formula (I) is of the formula:

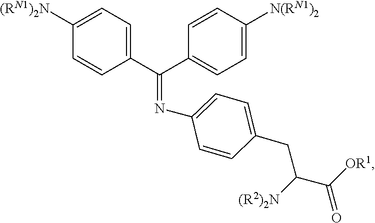

or a salt, tautomer, or isotopically labeled derivative thereof.

In certain embodiments, the compound of Formula (I) is of one of the following formulae:

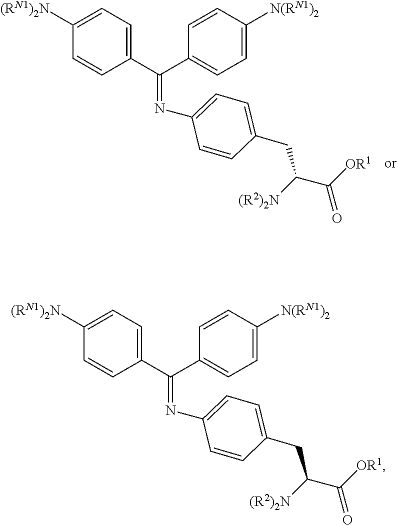

or a salt, tautomer, or isotopically labeled derivative thereof.

In certain embodiments, the compound of Formula (I) is of the formula:

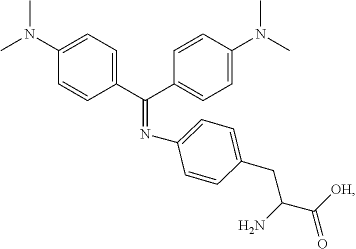 [SMILES: CN(C)c1ccc(C(=Nc2ccc(CC(N)C(=O)O)cc2)c2ccc(N(C)C)cc2)cc1]

or a salt, tautomer, or isotopically labeled derivative thereof.

In certain embodiments, the compound of Formula (I) is of one of the following formulae:

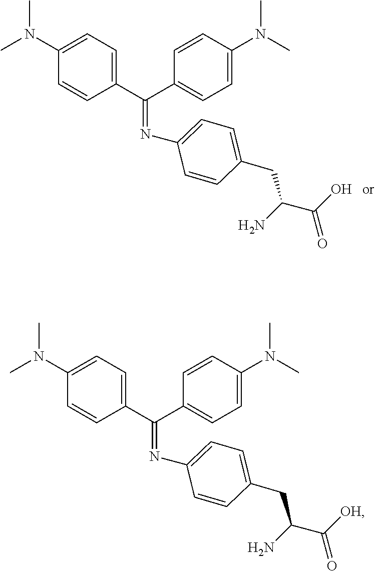 [SMILES: CN(C)c1ccc(C(=Nc2ccc(C[C@@H](N)C(=O)O)cc2)c2ccc(N(C)C)cc2)cc1 ; CN(C)c1ccc(C(=Nc2ccc(C[C@H](N)C(=O)O)cc2)c2ccc(N(C)C)cc2)cc1]

or a salt, tautomer, or isotopically labeled derivative thereof.

In certain embodiments, the compound of Formula (I) is of the formula:

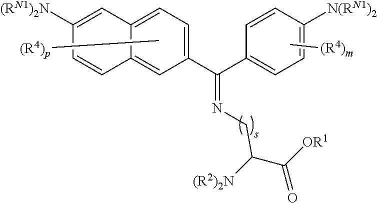

or a salt, tautomer, or isotopically labeled derivative thereof; wherein s is 0, 1, 2, 3, 4, 5, or 6;
and p is 0, 1, 2, 3, 4, 5, or 6.

In certain embodiments, the compound of Formula (I) is of one of the following formulae:

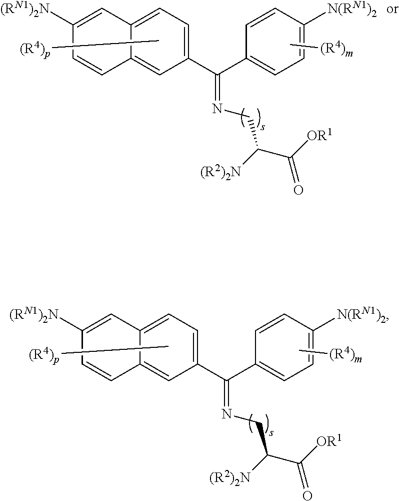

or a salt, tautomer, or isotopically labeled derivative thereof.

In certain embodiments, the compound of Formula (I) is of the formula:

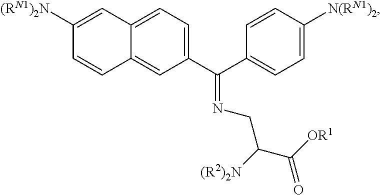

or a salt, tautomer, or isotopically labeled derivative thereof.

In certain embodiments, the compound of Formula (I) is of one of the following formulae:

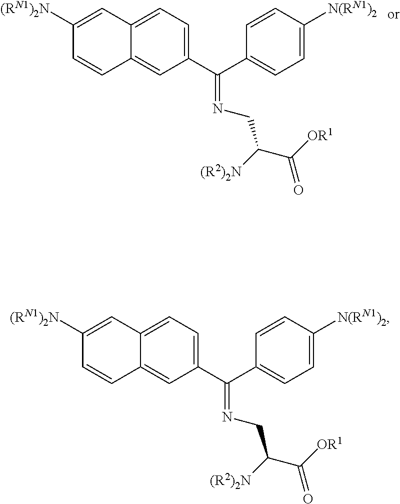

or a salt, tautomer, or isotopically labeled derivative thereof.

In certain embodiments, the compound of Formula (I) is of the formula:

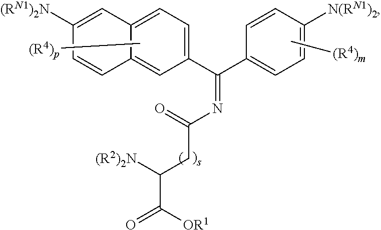

or a salt, tautomer, or isotopically labeled derivative thereof; wherein s is 0, 1, 2, 3, 4, 5, or 6; and p is 0, 1, 2, 3, 4, 5, or 6.

In certain embodiments, the compound of Formula (I) is of one of the following formulae:

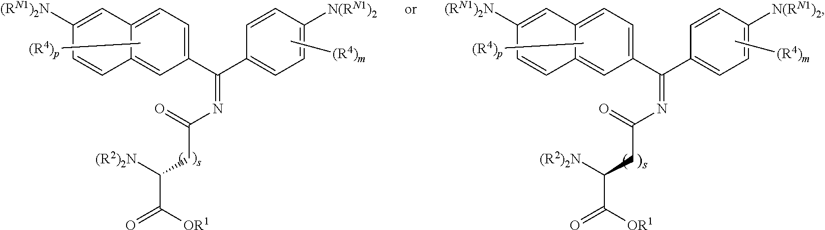

or a salt, tautomer, or isotopically labeled derivative thereof.

In certain embodiments, the compound of Formula (I) is of the formula:

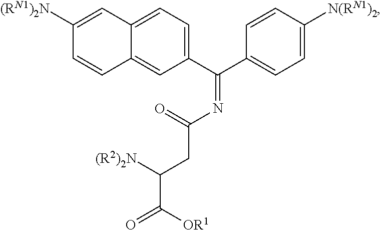

or a salt, tautomer, or isotopically labeled derivative thereof.

In certain embodiments, the compound of Formula (I) is of one of the following formulae:

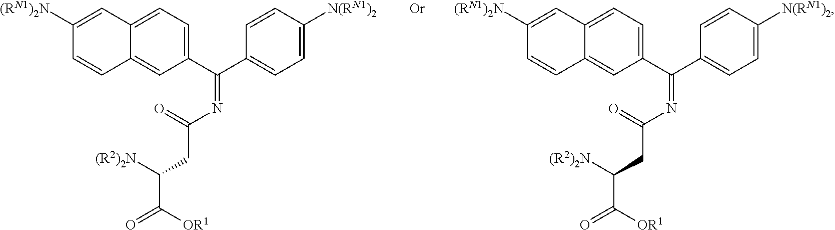

or a salt, tautomer, or isotopically labeled derivative thereof.

In certain embodiments, the compound of Formula (I) is of the formula:

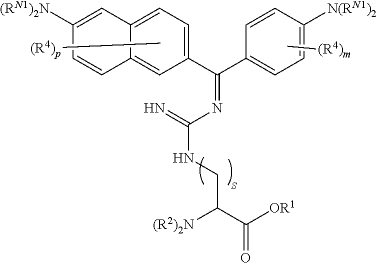

or a salt, tautomer, or isotopically labeled derivative thereof; wherein s is 0, 1, 2, 3, 4, 5, or 6; and p is 0, 1, 2, 3, 4, 5, or 6.

In certain embodiments, the compound of Formula (I) is of one of the following formulae:

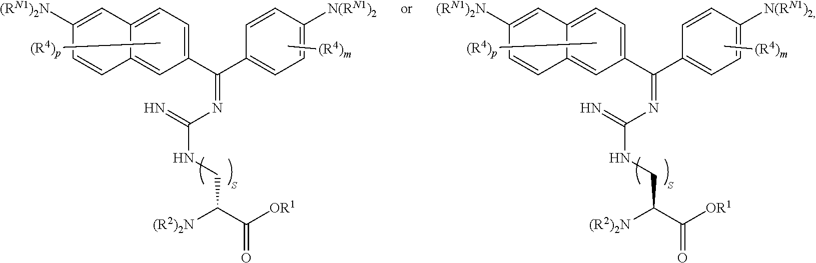

or a salt, tautomer, or isotopically labeled derivative thereof.

In certain embodiments, the compound of Formula (I) is of the formula:

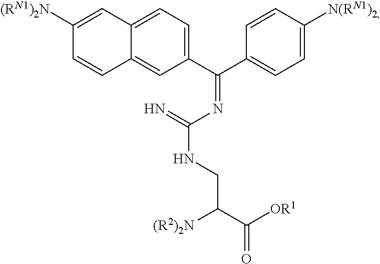

or a salt, tautomer, or isotopically labeled derivative thereof.

In certain embodiments, the compound of Formula (I) is of one of the following formulae:

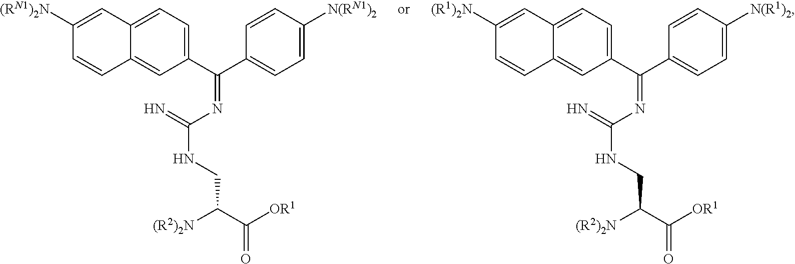

or a salt, tautomer, or isotopically labeled derivative thereof.

Also provided herein are compounds of Formula (II):

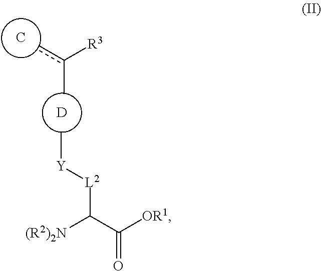

and salts, tautomers, and isotopically labeled derivatives thereof, wherein:
Ring D is optionally substituted aryl or optionally substituted heteroaryl;
R³ is hydrogen, ═NR^{NX}, —N—R^{NX}, ═S, —S—, ═O, —O—, ═C(R^{C})₂, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl;
[symbol] is a single or double bond, provided that when [symbol] is a single bond, R³ is ═O or ═C(R^{C})₂, and provided that when [symbol] is a double bond, R³ is not ═NR^{NX}, ═S, ═O or ═C(R^{C})₂;
Ring C is an optionally substituted heterocyclic or heteroaryl ring comprising at least one N, S, or O atom; wherein the heterocyclic or heteroaryl ring is in conjugation with the group:

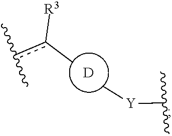

or
Ring C is an optionally substituted carbocyclic, optionally substituted heterocyclic, optionally substituted aryl, or optionally substituted heteroaryl ring substituted with [symbol] Y^{C} and comprising at least one double bond in conjugation with [symbol] Y^{C} and the group:

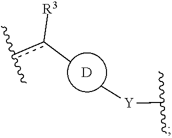

[symbol] Y^{C} is —N(R^{N1})₂, ═N⁺(R^{N1})₂, ═NR^{N1}₂—OR^{O1}, ═O⁺R^{O1}, ═O, —SR^{S1}, ═S⁺R^{S1}, or ═S;
Y is a bond, —O—, —NR^{N2}—, or —S—;
L² is a bond, optionally substituted alkylene, optionally substituted heteroalkylene, optionally substituted alkenylene, optionally substituted alkynylene, optionally substituted carbocyclylene, optionally substituted arylene, optionally substituted heterocyclylene, optionally substituted heteroarylene, optionally substituted acylene, or a combination thereof;
R¹ is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, an oxygen protecting group, an amino acid, or a polypeptide;
each instance of R² is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, a nitrogen protecting group, an amino acid, or a polypeptide; or two R² bonded to the same nitrogen atom are taken together with the intervening atoms to form optionally substituted heterocyclyl or optionally substituted heteroaryl;
each instance of R^{N1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N1} bonded to the same nitrogen atom are taken together with the intervening atoms to form optionally substituted heterocyclyl or optionally substituted heteroaryl;
R^{N2} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group;
R^{NX} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group;
each instance of R^{O1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group;
each instance of R^{C} is independently hydrogen, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl, optionally wherein two R^{C} on the same carbon atom are joined together with the intervening atoms to form optionally substituted carbocyclyl or optionally substituted heterocyclyl.

In certain embodiments, the compound of Formula (II) is of one of the following formulae:

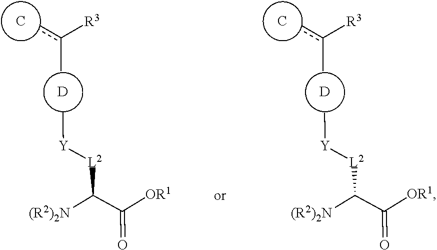

or a salt, tautomer, or isotopically labeled derivative thereof.

In certain embodiments, the compound of Formula (II) is of the formula:

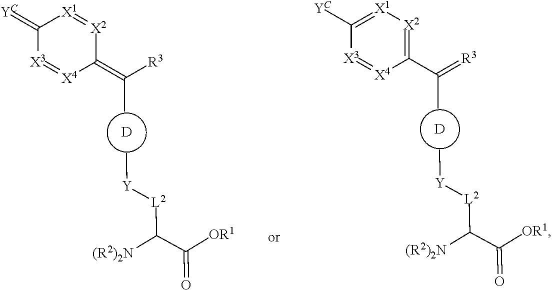

or a salt, tautomer, or isotopically labeled derivative thereof, wherein:
each of X¹, X², X³, and X⁴ are independently N or CR⁴;
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group; and
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group.

In certain embodiments, the compound of Formula (II) is of one of the following formulae:

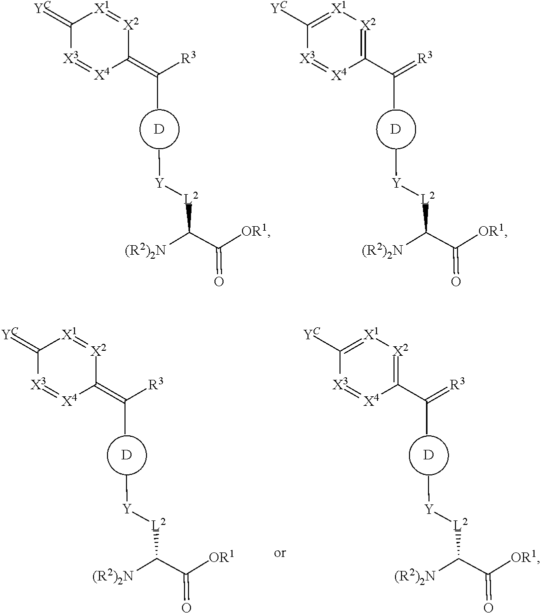

or a salt, tautomer, or isotopically labeled derivative thereof.

In certain embodiments, the compound of Formula (II) is of the formula:

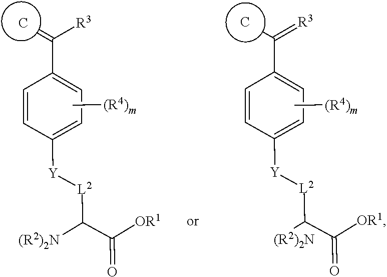

or a salt, tautomer, or isotopically labeled derivative thereof, wherein:
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
m is 0, 1, 2, 3, or 4.

In certain embodiments, the compound of Formula (II) is of one of the following formulae:

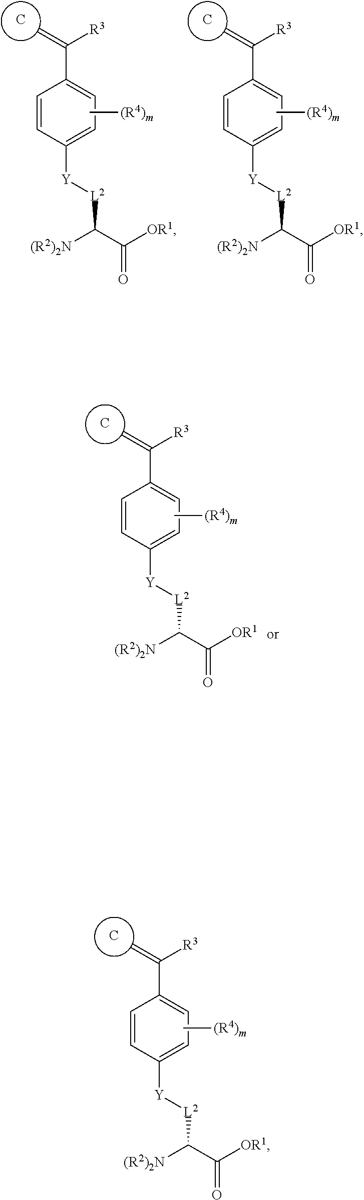

or a salt, tautomer, or isotopically labeled derivative thereof.

In certain embodiments, the compound of Formula (II) is of the formula:

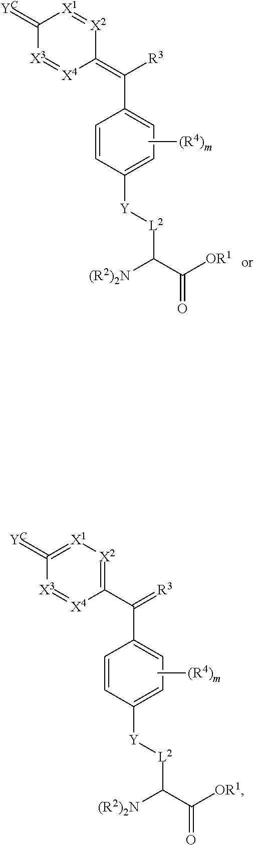

or a salt, tautomer, or isotopically labeled derivative thereof.

In certain embodiments, the compound of Formula (II) is of one of the following formulae:

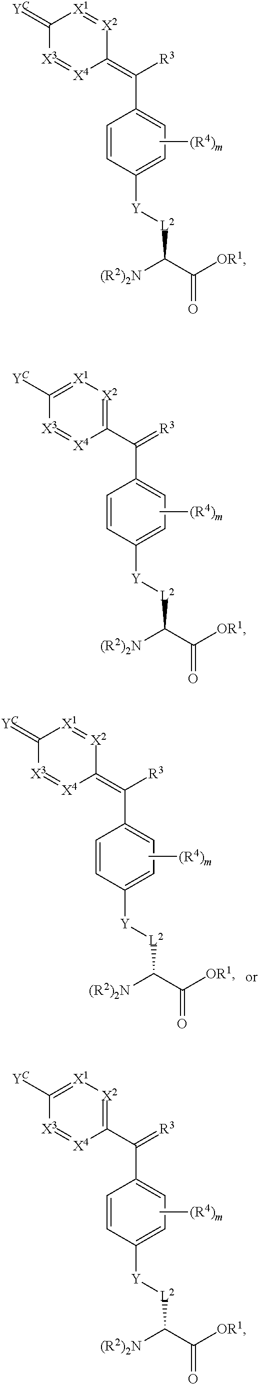

or a salt, tautomer, or isotopically labeled derivative thereof.

In certain embodiments, the compound of Formula (II) is of the formula:

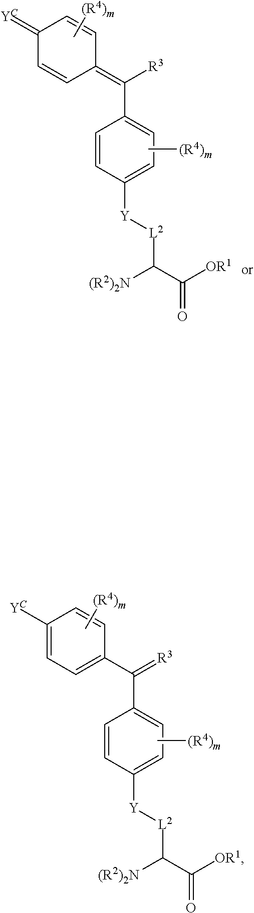

or a salt, tautomer, or isotopically labeled derivative thereof.

In certain embodiments, the compound of Formula (II) is of one of the following formulae:

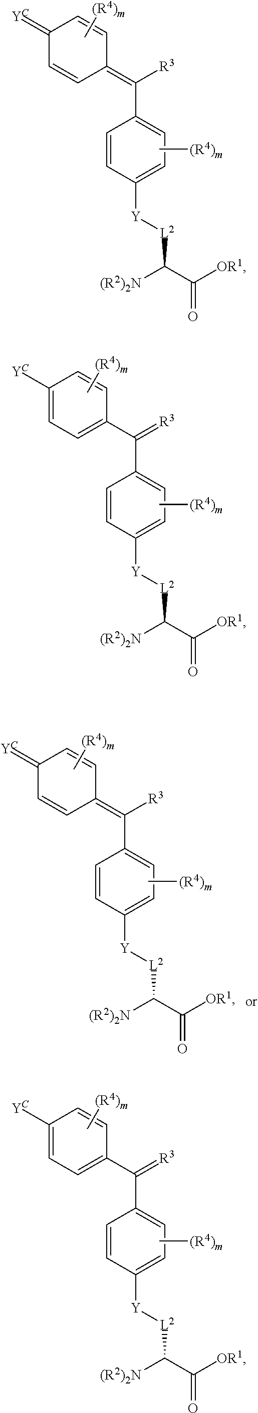

or a salt, tautomer, or isotopically labeled derivative thereof.

In certain embodiments, the compound of Formula (II) is of the formula:

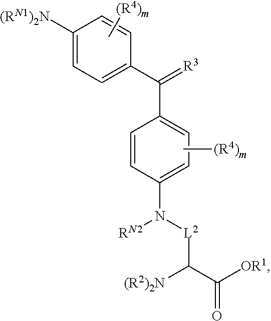

or a salt, tautomer, or isotopically labeled derivative thereof.

In certain embodiments, the compound of Formula (II) is of one of the following formulae:

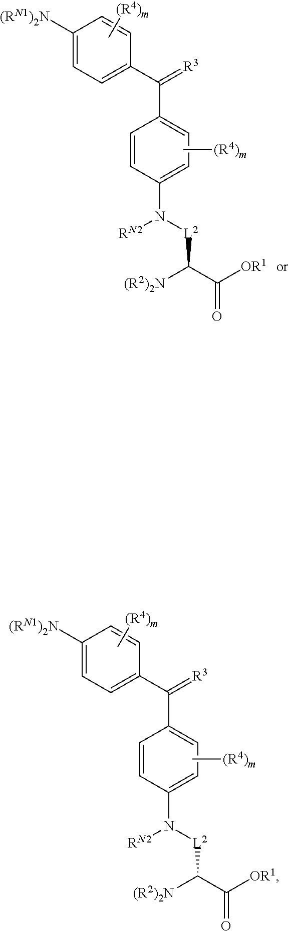

or a salt, tautomer, or isotopically labeled derivative thereof.

In certain embodiments, the compound of Formula (II) is of one of the following formulae:

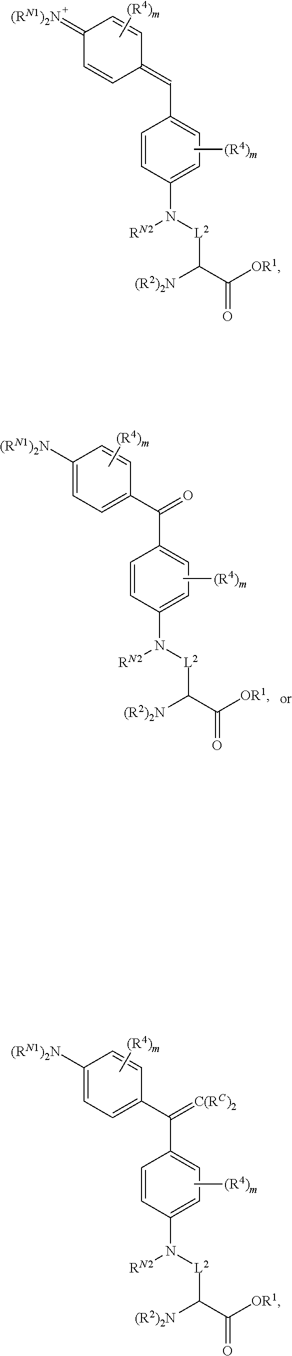

or a salt, tautomer, or isotopically labeled derivative thereof.

In certain embodiments, the compound of Formula (II) is of one of the following formulae:

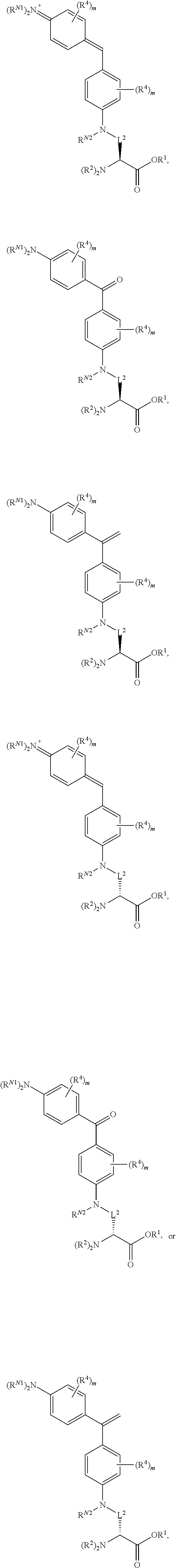

or a salt, tautomer, or isotopically labeled derivative thereof.

In certain embodiments, the compound of Formula (II) is of one of the following formulae:

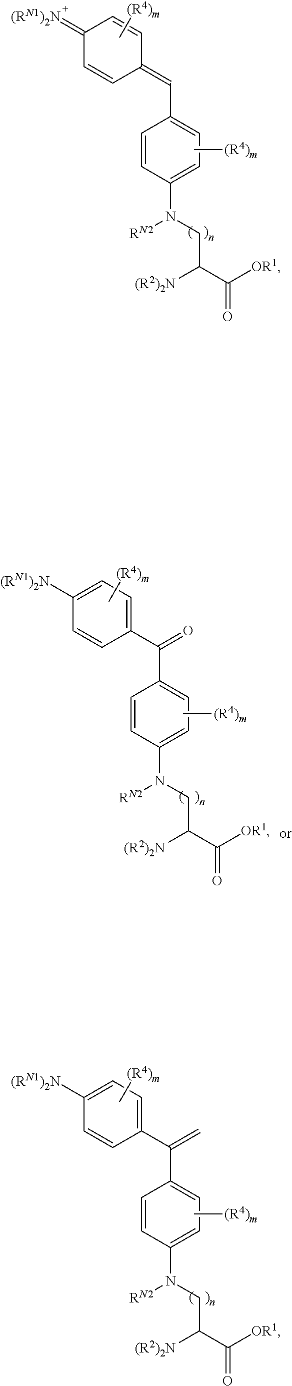

or a salt, tautomer, or isotopically labeled derivative thereof,
wherein n is an integer from 1-6, inclusive.

In certain embodiments, the compound of Formula (II) is of one of the following formulae:

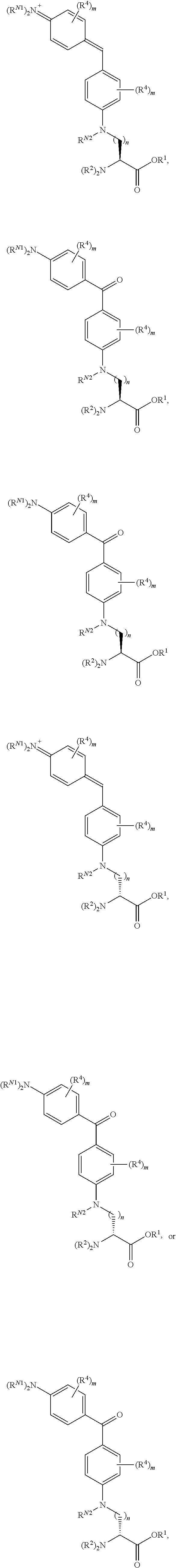

or a salt, tautomer, or isotopically labeled derivative thereof.

In certain embodiments, the compound of Formula (II) is of one of the following formulae:

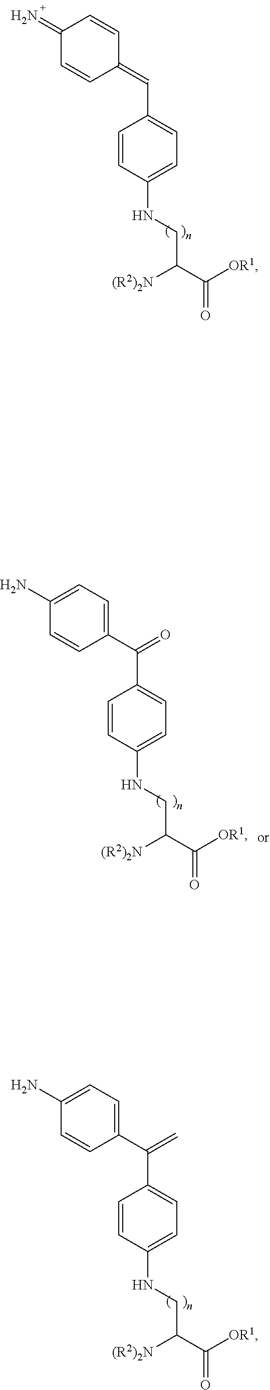

or a salt, tautomer, or isotopically labeled derivative thereof.

In certain embodiments, the compound of Formula (II) is of one of the following formulae:

or a salt, tautomer, or isotopically labeled derivative thereof.

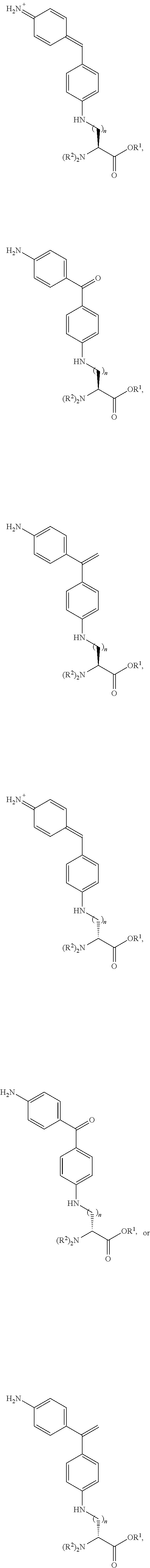

In certain embodiments, the compound of Formula (II) is of one of the following formulae:

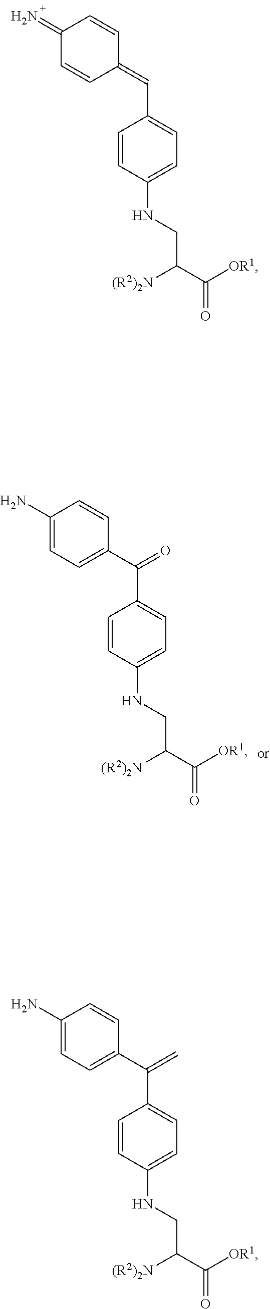

or a salt, tautomer, or isotopically labeled derivative thereof.

As described herein, the compounds may be in the form of their tautomers, for example, as shown below:

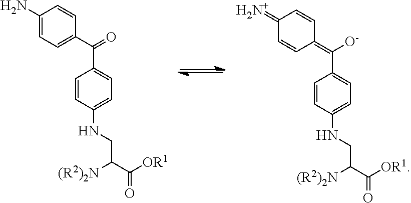

In certain embodiments, the compound of Formula (II) is of one of the following formulae:

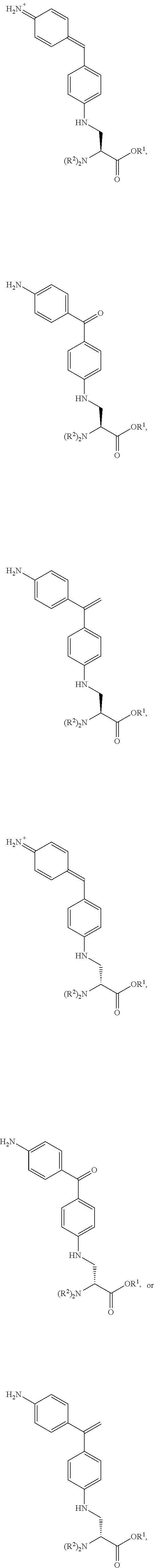

or a salt, tautomer, or isotopically labeled derivative thereof.

In certain embodiments, the compound of Formula (II) is of the formula:

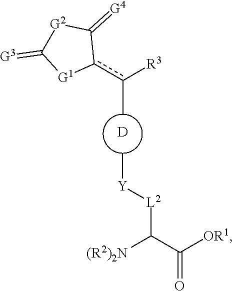

or a salt, tautomer, or isotopically labeled derivative thereof,
wherein each of G¹, G², G³, and G⁴ is independently selected from the group consisting of O, S, and NR^{N3}; and
each instance of R^{N3} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group.

In certain embodiments, the compound of Formula (II) is of one of the following formulae:

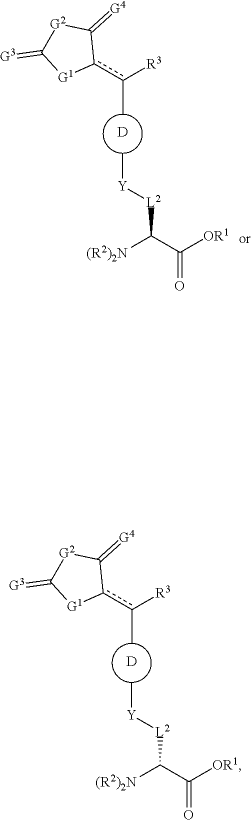

or a salt, tautomer, or isotopically labeled derivative thereof.

In certain embodiments, the compound of Formula (II) is of the formula:

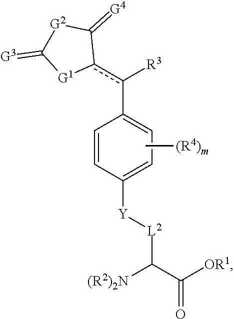

or a salt, tautomer, or isotopically labeled derivative thereof.

In certain embodiments, the compound of Formula (II) is of one of the following formulae:

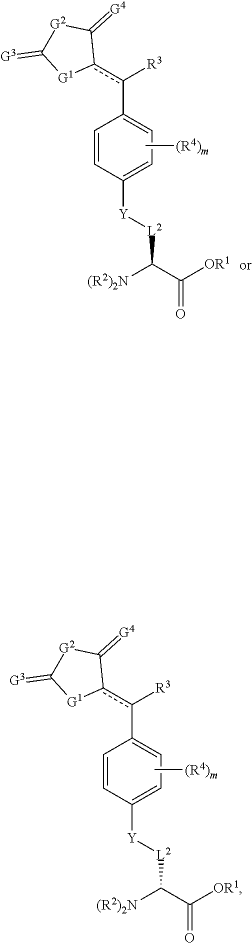

or a salt, tautomer, or isotopically labeled derivative thereof.

In certain embodiments, the compound of Formula (II) is of the formula:

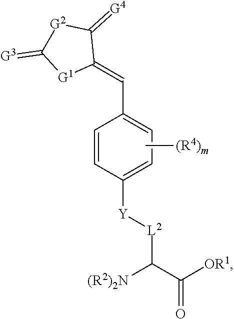

or a salt, tautomer, or isotopically labeled derivative thereof.

In certain embodiments, the compound of Formula (II) is of one of the following formulae:

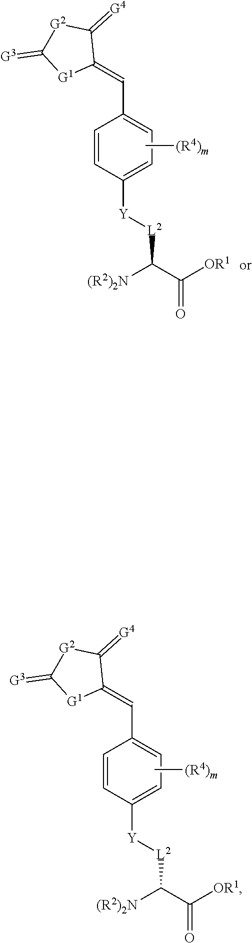

or a salt, tautomer, or isotopically labeled derivative thereof.

In certain embodiments, the compound of Formula (II) is of the formula:

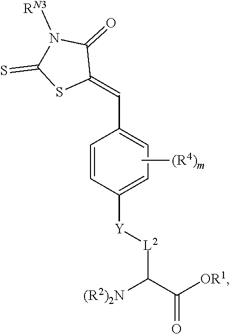

or a salt, tautomer, or isotopically labeled derivative thereof.

In certain embodiments, the compound of Formula (II) is of one of the following formulae:

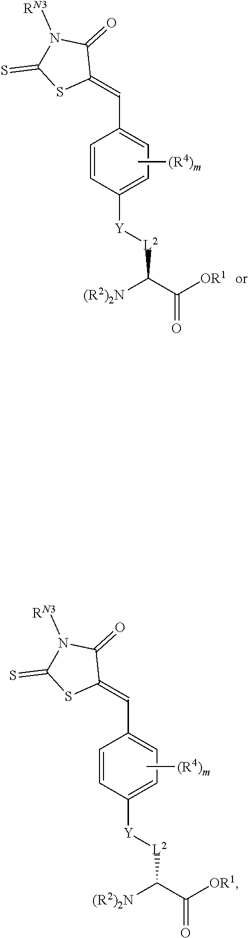

or a salt, tautomer, or isotopically labeled derivative thereof.

In certain embodiments, the compound of Formula (II) is of the formula:

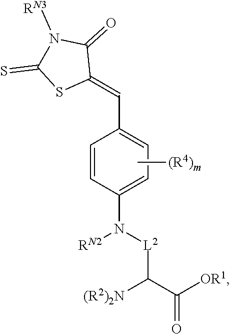

or a salt, tautomer, or isotopically labeled derivative thereof.

In certain embodiments, the compound of Formula (II) is of one of the following formulae:

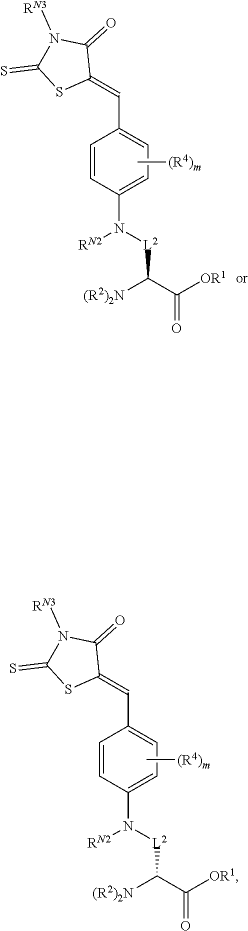

or a salt, tautomer, or isotopically labeled derivative thereof.

In certain embodiments, the compound of Formula (II) is of the formula:

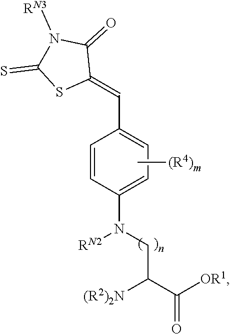

or a salt, tautomer, or isotopically labeled derivative thereof,
wherein n is an integer from 1-6, inclusive.

In certain embodiments, the compound of Formula (II) is of one of the following formulae:

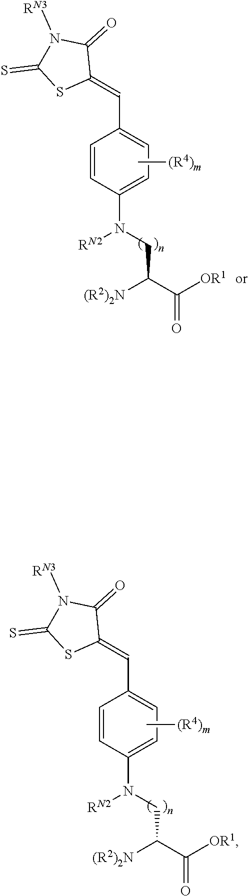

or a salt, tautomer, or isotopically labeled derivative thereof.

In certain embodiments, the compound of Formula (II) is of the formula:

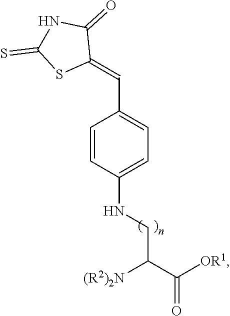

or a salt, tautomer, or isotopically labeled derivative thereof.

In certain embodiments, the compound of Formula (II) is of one of the following formulae:

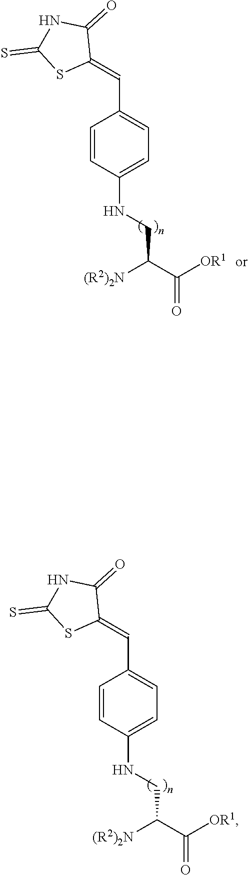

or a salt, tautomer, or isotopically labeled derivative thereof.

In certain embodiments, the compound of Formula (II) is of the formula:

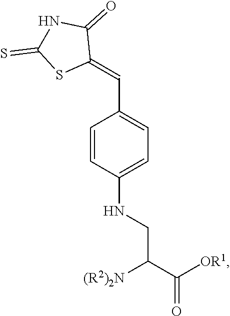

or a salt, tautomer, or isotopically labeled derivative thereof.

In certain embodiments, the compound of Formula (II) is of one of the following formulae:

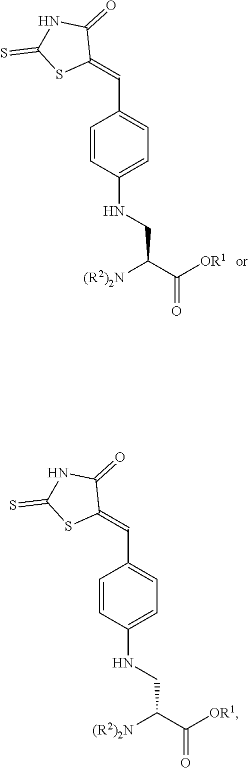

or a salt, tautomer, or isotopically labeled derivative thereof.

In certain embodiments, the compound of Formula (II) is selected from the group consisting of:

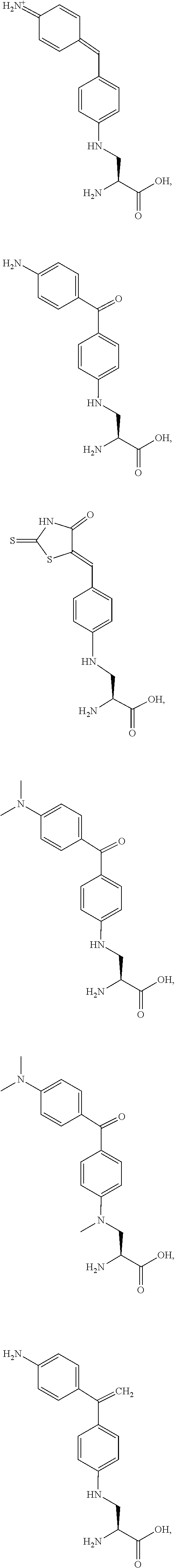 [SMILES: N[C@@H](CNc1ccc(C=C2C=CC(=[NH2+])C=C2)cc1)C(=O)O ; Nc1ccc(C(=O)c2ccc(NC[C@H](N)C(=O)O)cc2)cc1 ; N[C@@H](CNc1ccc(/C=C2\SC(=S)NC2=O)cc1)C(=O)O ; CN(C)c1ccc(C(=O)c2ccc(NC[C@H](N)C(=O)O)cc2)cc1 ; CN(C)c1ccc(C(=O)c2ccc(N(C)C[C@H](N)C(=O)O)cc2)cc1 ; C=C(c1ccc(N)cc1)c1ccc(NC[C@H](N)C(=O)O)cc1]

and salts, tautomers, and isotopically labeled derivatives thereof.

In certain embodiments, the compound of Formula (II) is selected from the group consisting of:

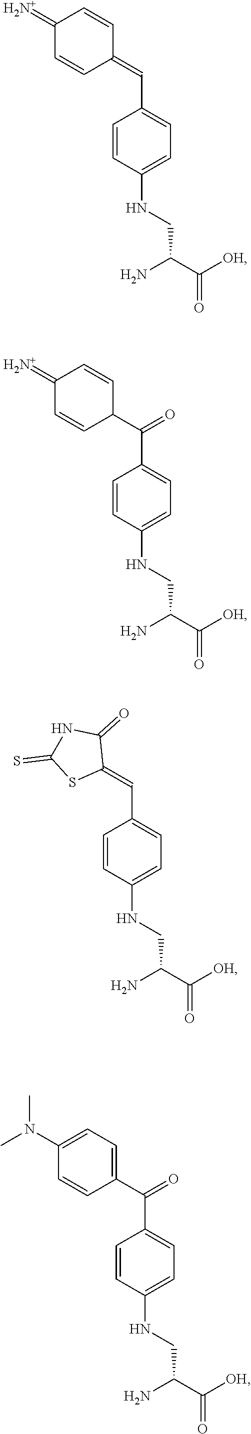 [SMILES: N[C@H](CNc1ccc(C=C2C=CC(=[NH2+])C=C2)cc1)C(=O)O ; N[C@H](CNc1ccc(C(=O)C2C=CC(=[NH2+])C=C2)cc1)C(=O)O ; N[C@H](CNc1ccc(/C=C2\SC(=S)NC2=O)cc1)C(=O)O ; CN(C)c1ccc(C(=O)c2ccc(NC[C@@H](N)C(=O)O)cc2)cc1]

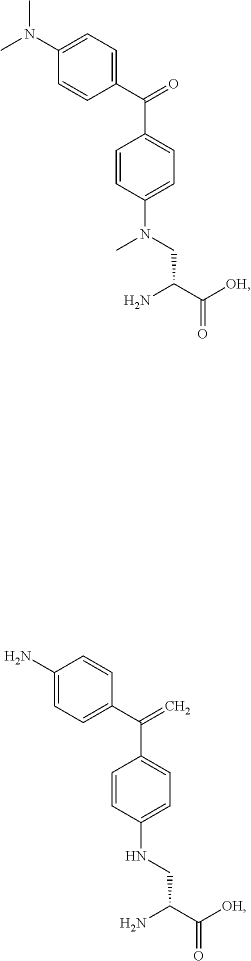 [SMILES: CN(C)c1ccc(C(=O)c2ccc(N(C)C[C@@H](N)C(=O)O)cc2)cc1 ; C=C(c1ccc(N)cc1)c1ccc(NC[C@@H](N)C(=O)O)cc1]

and salts, tautomers, and isotopically labeled derivatives thereof.

As described herein, the compounds may be in the form of their tautomers, for example, as shown below:

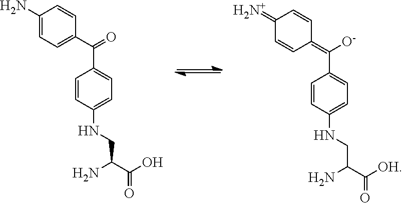 [SMILES: Nc1ccc(C(=O)c2ccc(NC[C@H](N)C(=O)O)cc2)cc1 ; NC(CNc1ccc(C([O-])=C2C=CC(=[NH2+])C=C2)cc1)C(=O)O]

In certain embodiments, the compound of Formula (II) is of the following formula:

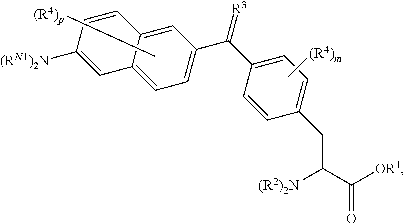

or a salt, tautomer, or isotopically labeled derivative thereof, wherein p is 0, 1, 2, 3, 4, 5, or 6.

In certain embodiments, the compound of Formula (II) is of one of the following formulae:

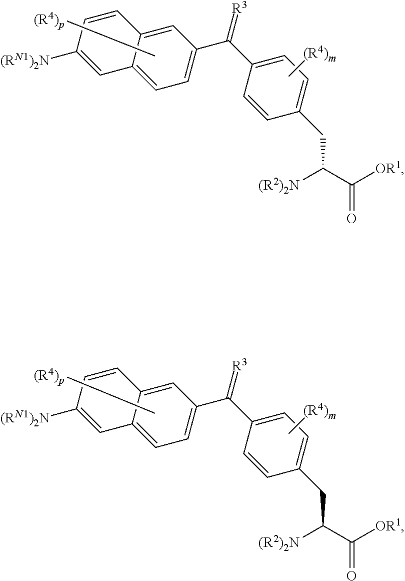

or a salt, tautomer, or isotopically labeled derivative thereof, wherein p is 0, 1, 2, 3, 4, 5, or 6.

In certain embodiments, the compound of Formula (II) is of one of the following formulae:

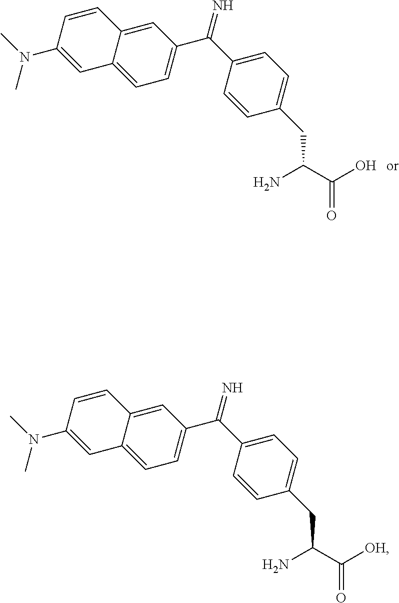 [SMILES: CN(C)c1ccc2cc(C(=N)c3ccc(C[C@@H](N)C(=O)O)cc3)ccc2c1 ; CN(C)c1ccc2cc(C(=N)c3ccc(C[C@H](N)C(=O)O)cc3)ccc2c1]

or a salt, tautomer, or isotopically labeled derivative thereof, wherein p is 0, 1, 2, 3, 4, 5, or 6.

Provided herein are compounds of Formula (III):

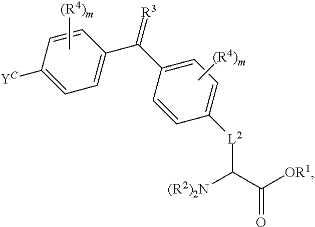

and salts, tautomers, and isotopically labeled derivatives thereof, wherein:
R³ is ═NR^{NX}, ═S, ═O, or ═C(R^{C})₂;
—Y^{C} is —N(R^{N1})₂, —OR^{O1}, or —SR^{S1};
L² is a bond, optionally substituted alkylene, optionally substituted heteroalkylene, optionally substituted alkenylene, optionally substituted alkynylene, optionally substituted carbocyclylene, optionally substituted arylene, optionally substituted heterocyclylene, optionally substituted heteroarylene, optionally substituted acylene, or a combination thereof;
R¹ is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, an oxygen protecting group, an amino acid, or a polypeptide;
each instance of R² is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, a nitrogen protecting group, an amino acid, or a polypeptide; or two R² bonded to the same nitrogen atom are taken together with the intervening atoms to form optionally substituted heterocyclyl or optionally substituted heteroaryl;
R^{N1} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N1} bonded to the same nitrogen atom are taken together with the intervening atoms to form optionally substituted heterocyclyl or optionally substituted heteroaryl;
R^{N2} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group;
R^{NX} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group;
each instance of R^{O1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group;
each instance of R^{C} is independently hydrogen, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl, optionally wherein two R^{C} on the same carbon atom are joined together with the intervening atoms to form optionally substituted carbocyclyl or optionally substituted heterocyclyl;
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
m is 0, 1, 2, 3, or 4.

In certain embodiments, the compound of Formula (III) is of the following formula:

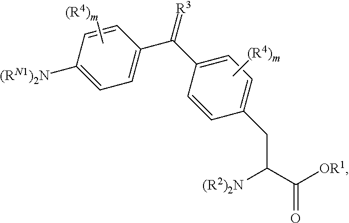

or a salt, tautomer, or isotopically labeled derivative thereof.

In certain embodiments, the compound of Formula (III) is of one of the following formulae:

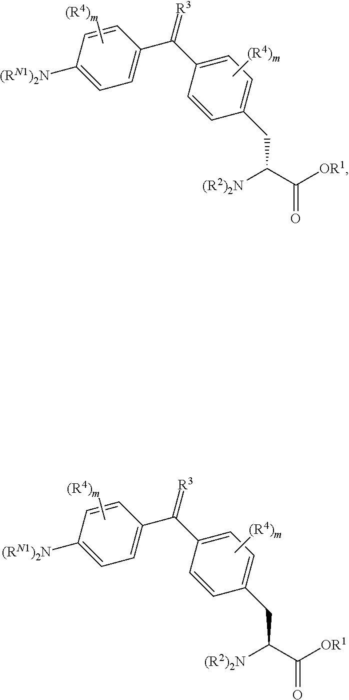

or a salt, tautomer, or isotopically labeled derivative thereof.

In certain embodiments, the compound of Formula (III) is one of the following:

or a salt, tautomer, or isotopically labeled derivative thereof.

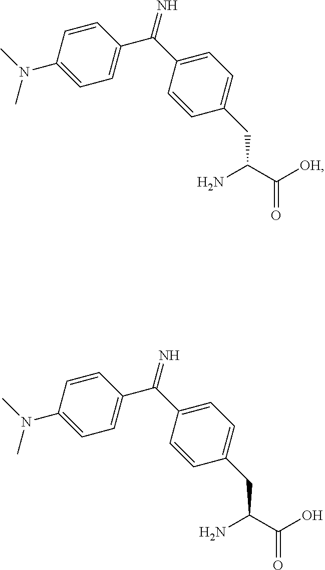 [SMILES: CN(C)c1ccc(C(=N)c2ccc(C[C@@H](N)C(=O)O)cc2)cc1 ; CN(C)c1ccc(C(=N)c2ccc(C[C@H](N)C(=O)O)cc2)cc1]

In certain embodiments, the compound of Formula (III) is of one of the following formulae:

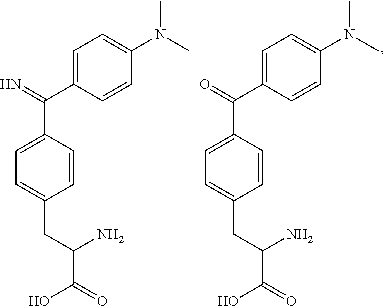

or a salt, tautomer, or isotopically labeled derivative thereof.

Also provided herein are compounds of Formula (IV):

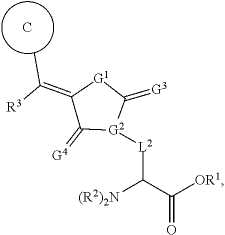

and salts, tautomers, and isotopically labeled derivatives thereof, wherein:
Ring C is an optionally substituted aryl ring, or optionally substituted heteroaryl ring comprising at least one N, S, or O atom; wherein Ring C is optionally substituted with —Y^{C};
Y^{C} is —N(R^{N1})₂, —OR^{O1}, —SR^{S1}, each of G¹, G³, and G⁴ is independently selected from the group consisting of O, S, and NR^{N3}; G² is N;
R³ is hydrogen, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl;
L² is a bond, optionally substituted alkylene, optionally substituted heteroalkylene, optionally substituted alkenylene, optionally substituted alkynylene, optionally substituted carbocyclylene, optionally substituted arylene, optionally substituted heterocyclylene, optionally substituted heteroarylene, optionally substituted acylene, or a combination thereof;
R¹ is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, an oxygen protecting group, an amino acid, or a polypeptide;
each instance of R² is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, a nitrogen protecting group, an amino acid, or a polypeptide; or two R² bonded to the same nitrogen atom are taken together with the intervening atoms to form optionally substituted heterocyclyl or optionally substituted heteroaryl;
each instance of R^{N1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N1} bonded to the same nitrogen atom are taken together with the intervening atoms to form optionally substituted heterocyclyl or optionally substituted heteroaryl;
R^{O1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
R^{S1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group;
each instance of R^{N3} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group.

In certain embodiments, the compound of Formula (IV) is of the formula:

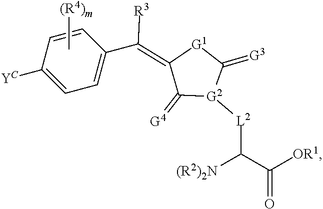

or a salt, tautomer, or isotopically derivative thereof, wherein:
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
m is 0, 1, 2, 3, or 4.

In certain embodiments, the compound of Formula (IV) is of one of the following formulae:

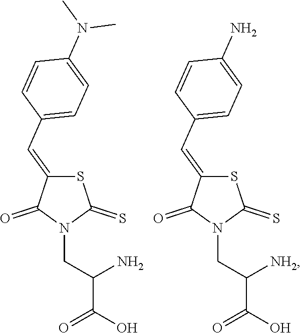

or a salt, tautomer, or isotopically derivative thereof

### Ring A and Y^{A}

As defined herein, Ring A an optionally substituted carbocyclic, optionally substituted heterocyclic, optionally substituted aryl, or optionally substituted heteroaryl ring comprising at least one double bond in conjugation with ═Y^{A} and the group:

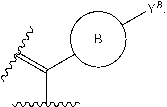

In certain embodiments, Ring A is an optionally substituted carbocyclic ring. In certain embodiments, Ring A is an optionally substituted heterocyclic ring. In certain embodiments, Ring A is an optionally substituted C₆ carbocyclic ring. In certain embodiments, Ring A is an optionally substituted 6-membered heterocyclic ring. In certain embodiment, Ring A is an optionally substituted cyclohexadienyl ring. In certain embodiment, Ring A is an unsubstituted cyclohexadienyl ring.

In certain embodiments, Ring A is of the formula:

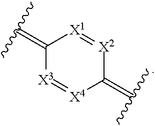

In certain embodiments, Ring A is of the formula:

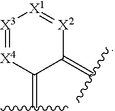

As defined herein, each of X¹, X², X³, and X⁴ are independently N or CR⁴. In certain embodiments, X¹ is N. In certain embodiments, X¹ is CR⁴. In certain embodiments, X¹ is CH. In certain embodiments, X² is N. In certain embodiments, X² is CR⁴. In certain embodiments, X² is CH. In certain embodiments, X³ is N. In certain embodiments, X³ is CR⁴. In certain embodiments, X³ is CH. In certain embodiments, X⁴ is N. In certain embodiments, X⁴ is CR⁴. In certain embodiments, X⁴ is CH. In certain embodiments, X¹, X², X³, and X⁴ are each CR⁴. In certain embodiments, X¹, X², X³, and X⁴ are each CH.

In certain embodiments, Ring A is of the formula:

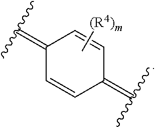

In certain embodiments, Ring A is of the formula:

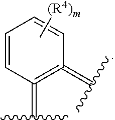

In certain embodiments, Ring A is of the formula:

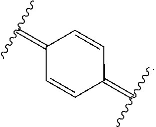 [SMILES: *=c1ccc(=*)cc1]

In certain embodiments, Ring A is of the formula:

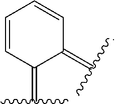 [SMILES: *=c1ccccc1=*]

As defined herein, ═Y^{A} is ═N⁺(R^{N1})₂, ═O⁺R^{O1}, ═S⁺R^{S1}, ═NR^{N1}, ═O, or ═S. In certain embodiments, ═Y^{A} is ═N⁺(R^{N1})₂. In certain embodiments, ═Y^{A} is ═N⁺(Me)₂. In certain embodiments, ═Y^{A} is ═NH₂+. In certain embodiments, ═Y^{A} is ═O⁺R^{O1}. In certain embodiments, ═Y^{A} is ═O⁺Me. In certain embodiments, ═Y^{A} is ═OH⁺. In certain embodiments, ═Y^{A} is ═O. In certain embodiments, ═Y^{A} is ═S⁺R^{S1}. In certain embodiments, ═Y^{A} is ═S⁺Me. In certain embodiments, ═Y^{A} is ═SH⁺. In certain embodiments, ═Y^{A} is ═S.

In certain embodiments, the group

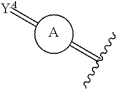

is of the formula:

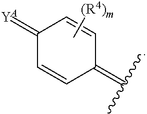

In certain embodiments, the group is of the formula:

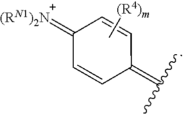

In certain embodiments, the group is of the formula:

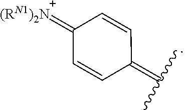

In certain embodiments, the group is of the formula:

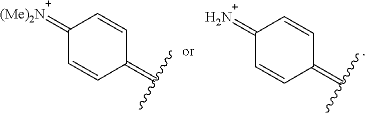

In certain embodiments, the group is of the formula:

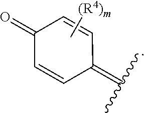

In certain embodiments, the group is of the formula:

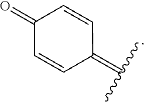 [SMILES: *=C1C=CC(=O)C=C1]

### Ring B and R^{B}

As defined herein, Ring B is optionally substituted aryl or optionally substituted heteroaryl. In certain embodiments, Ring B is optionally substituted aryl. In certain embodiments, Ring B is optionally substituted heteroaryl. In certain embodiments, Ring B is optionally substituted phenyl. In certain embodiments, Ring B is optionally substituted 6-membered heteroaryl. In certain embodiments, Ring is unsubstituted phenyl.

In certain embodiments, Ring B is of the formula:

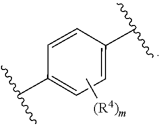

In certain embodiments, Ring B is of the formula:

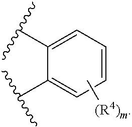

In certain embodiments, Ring B is of the formula:

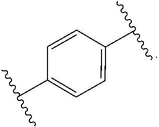 [SMILES: *c1ccc(*)cc1]

In certain embodiments, Ring B is of the formula:

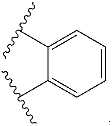 [SMILES: *c1ccccc1*]

As defined herein, Y^{B} is —N(R^{N1})₂, —OR^{O1}, or —SR^{S1}, In certain embodiments, Y^{B} is —N(R^{N1})₂, In certain embodiments, Y^{B} is —N(Me)₂. In certain embodiments, Y^{B} is —NH₂. In certain embodiments, Y^{B} is —OR^{O1}. In certain embodiments, Y^{B} is —OMe. In certain embodiments, Y^{B} is —OH. In certain embodiments, Y^{B} is —SR^{S1}. In certain embodiments, Y^{B} is —SMe. In certain embodiments, Y^{B} is —SH.

In certain embodiments, the group of the formula:

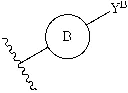

is of the formula:

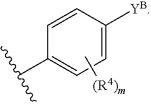

In certain embodiments, the group is of the formula:

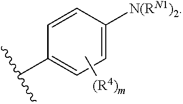

In certain embodiments, the group is of the formula:

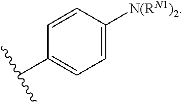

In certain embodiments, the group is of the formula:

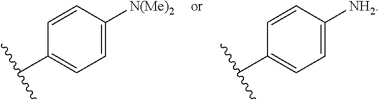

In certain embodiments, the group is of the formula:

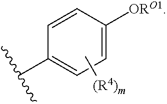

In certain embodiments, the group is of the formula:

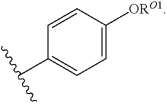

In certain embodiments, the group is of the formula:

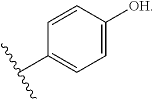 [SMILES: *c1ccc(O)cc1]

In certain embodiments, Ring B is optionally substituted naphthalene. In certain embodiments, Ring B is unsubstituted naphthalene. In certain embodiments, the group

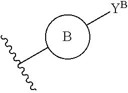

is of the formula:

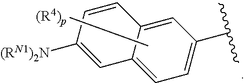

In certain embodiments, the group

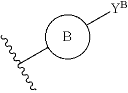

is of the formula:

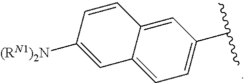

In certain embodiments, the group

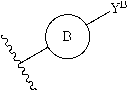

is of the formula:

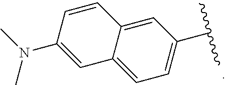 [SMILES: *c1ccc2cc(N(C)C)ccc2c1]

In certain embodiments, the group

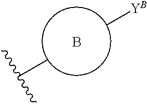

is of the formula:

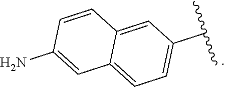 [SMILES: *c1ccc2cc(N)ccc2c1]

As defined herein, p is 0, 1, 2, 3, 4, 5, or 6. In certain embodiments, p is 0. In certain embodiments, p is 1. In certain embodiments, p is 2. In certain embodiments, p is 3. In certain embodiments, p is 4. In certain embodiments, p is 5. In certain embodiments, p is 6.

### Ring C and Y^{C}

In certain embodiments, Ring C is an optionally substituted heterocyclic or heteroaryl ring comprising at least one N, S, or O atom; wherein the heterocyclic or heteroaryl ring is in conjugation with the group:

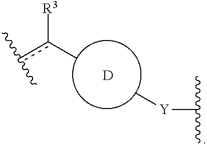

In certain embodiments, Ring C is an optionally substituted carbocyclic ring. In certain embodiments, Ring C is an optionally substituted heterocyclic ring. In certain embodiments, Ring C is an optionally substituted C₆ carbocyclic ring. In certain embodiments, Ring C is an optionally substituted 6-membered heterocyclic ring. In certain embodiment, Ring C is an optionally substituted cyclohexadienyl ring. In certain embodiment, Ring C is an unsubstituted cyclohexadienyl ring.

In certain embodiments, Ring C is of the formula:

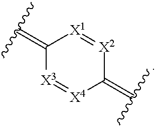

In certain embodiments, Ring C is of the formula:

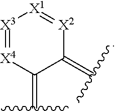

In certain embodiments, Ring C is of the formula:

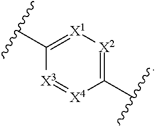

In certain embodiments, Ring C is of the formula:

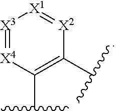

As defined herein, each of X¹, X², X³, and X⁴ are independently N or CR⁴. In certain embodiments, X¹ is N. In certain embodiments, X¹ is CR⁴. In certain embodiments, X¹ is CH. In certain embodiments, X² is N. In certain embodiments, X² is CR⁴. In certain embodiments, X² is CH. In certain embodiments, X³ is N. In certain embodiments, X³ is CR⁴. In certain embodiments, X³ is CH. In certain embodiments, X⁴ is N. In certain embodiments, X⁴ is CR⁴. In certain embodiments, X⁴ is CH. In certain embodiments, X¹, X², X³, and X⁴ are each CR⁴. In certain embodiments, X¹, X², X³, and X⁴ are each CH.

In certain embodiments, Ring C is of the formula:

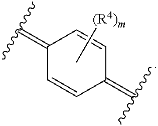

In certain embodiments, Ring C is of the formula:

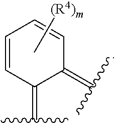

In certain embodiments, Ring C is of the formula:

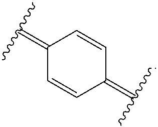 [SMILES: *=c1ccc(=*)cc1]

In certain embodiments, Ring C is of the formula:

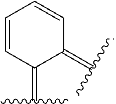 [SMILES: *=c1ccccc1=*]

In certain embodiments, Ring C is of the formula:

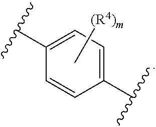

In certain embodiments, Ring C is of the formula:

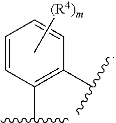

In certain embodiments, Ring C is of the formula:

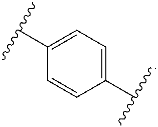 [SMILES: *c1ccc(*)cc1]

In certain embodiments, Ring C is of the formula:

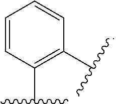 [SMILES: *c1ccccc1*]

As defined herein, [symbol] Y^{C} is ═N⁺(R^{N1})₂, ═O⁺R^{O1}, ═S⁺R^{S1}, —N(R^{N1})₂, —OR^{O1}, —SR^{S1} ═NR^{N1}, ═O, or ═S. In certain embodiments, ═Y^{C} is ═N⁺(R^{N1})₂. In certain embodiments, [symbol] Y^{C} is ═N⁺(Me)₂. In certain embodiments, [symbol] Y^{C} is ═NH₂+. In certain embodiments, [symbol] Y^{C} is [symbol] ═O⁺R^{O1}. In certain embodiments, [symbol] Y^{C} is ═O⁺Me. In certain embodiments, [symbol] Y^{C} is ═OH⁺. In certain embodiments, [symbol] Y^{C} is ═O. In certain embodiments, [symbol] Y^{C} is ═S⁺R^{S1}. In certain embodiments, [symbol] Y^{C} is ═S. In certain embodiments, [symbol] Y^{C} is ═S⁺Me. In certain embodiments, [symbol] Y^{C} is —SH.

In certain embodiments, the group

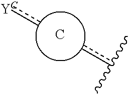

is of the formula:

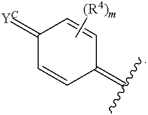

In certain embodiments, the group is of the formula:

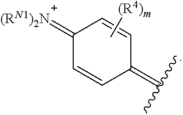

In certain embodiments, the group is of the formula:

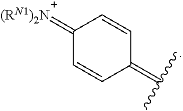

In certain embodiments, the group is of the formula:

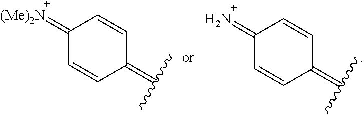

In certain embodiments, the group

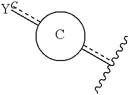

is of the formula:

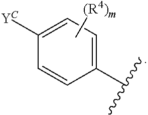

In certain embodiments, the group is of the formula:

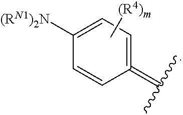

In certain embodiments, the group is of the formula:

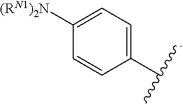

In certain embodiments, the group is of the formula:

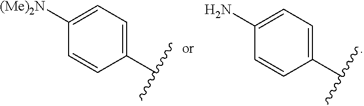

In certain embodiments, Ring C is optionally substituted naphthalene. In certain embodiments, Ring C is unsubstituted naphthalene. In certain embodiments, the group

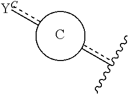

is of the formula:

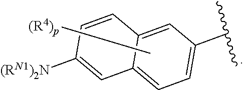

In certain embodiments, the group

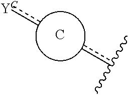

is of the formula:

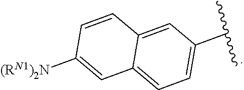

In certain embodiments, the group

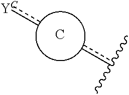

is of the formula:

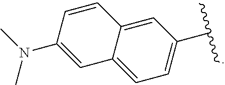 [SMILES: *c1ccc2cc(N(C)C)ccc2c1]

In certain embodiments, the group

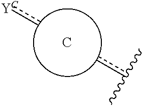

is of the formula:

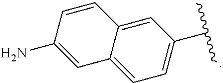 [SMILES: *c1ccc2cc(N)ccc2c1]

As defined herein, p is 0, 1, 2, 3, 4, 5, or 6. In certain embodiments, p is 0. In certain embodiments, p is 1. In certain embodiments, p is 2. In certain embodiments, p is 3. In certain embodiments, p is 4. In certain embodiments, p is 5. In certain embodiments, p is 6.

In certain embodiments, Ring C is an optionally substituted carbocyclic, optionally substituted heterocyclic, optionally substituted aryl, or optionally substituted heteroaryl ring substituted with ═Y^{C} and comprising at least one double bond in conjugation with ═Y^{C} and the group:

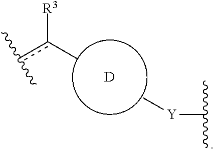

In certain embodiments, Ring C is an optionally substituted 5-membered heterocyclic ring. In certain embodiments, Ring C is an optionally substituted 6-membered heterocyclic ring.

In certain embodiments, Ring is of the formula:

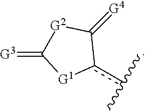

As defined herein, each of G¹, G², G³, and G⁴ is independently selected from the group consisting of O, S, and NR^{N3}. In certain embodiments, G¹ is O. In certain embodiments, G¹ is S. In certain embodiments, G¹ is NR^{N3}. In certain embodiments, G¹ is NH. In certain embodiments, G² is 0. In certain embodiments, G² is S. In certain embodiments, G² is NR^{N3}. In certain embodiments, G² is NH. In certain embodiments, G³ is O. In certain embodiments, G³ is S. In certain embodiments, G³ is NR^{N3}. In certain embodiments, G³ is NH. In certain embodiments, G⁴ is O. In certain embodiments, G⁴ is S. In certain embodiments, G⁴ is NR^{N3}. In certain embodiments, G⁴ is NH. In certain embodiments, G¹ is S; G² is NR^{N3}; G³ is S; and G⁴ is O. In certain embodiments, G¹ is S; G² is NH; G³ is S; and G⁴ is O.

As defined herein, each instance of R^{N3} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group. In certain embodiments, at least one instance of R^{N3} is hydrogen. In certain embodiments, at least one instance of R^{N3} is optionally substituted alkyl. In certain embodiments, at least one instance of R^{N3} is optionally substituted alkenyl. In certain embodiments, at least one instance of R^{N3} is optionally substituted alkynyl. In certain embodiments, at least one instance of R^{N3} is optionally substituted aryl. In certain embodiments, at least one instance of R^{N3} is optionally substituted heteroaryl. In certain embodiments, at least one instance of R^{N3} is optionally substituted carbocyclyl. In certain embodiments, at least one instance of R^{N3} is optionally substituted heterocyclyl. In certain embodiments, at least one instance of R^{N3} is optionally substituted acyl. In certain embodiments, at least one instance of R^{N3} is a nitrogen protecting group. In certain embodiments, each instance of R^{N3} is hydrogen.

In certain embodiments, Ring C is an optionally substituted aryl ring, or optionally substituted heteroaryl ring comprising at least one N, S, or O atom; wherein Ring C is optionally substituted with —Y^{C}. In certain embodiments, Ring C is substituted with —Y^{C}. In certain embodiments, Ring C is an optionally substituted aryl ring substituted with —Y^{C}.

### Ring D and Y

As defined herein, Ring D is optionally substituted aryl or optionally substituted heteroaryl. In certain embodiments, Ring D is optionally substituted aryl. In certain embodiments, Ring D is optionally substituted heteroaryl. In certain embodiments, Ring D is optionally substituted phenyl. In certain embodiments, Ring D is optionally substituted 6-membered heteroaryl. In certain embodiments, Ring is unsubstituted phenyl.

In certain embodiments, Ring D is of the formula:

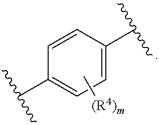

In certain embodiments, Ring D is of the formula:

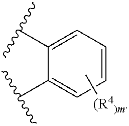

In certain embodiments, Ring D is of the formula:

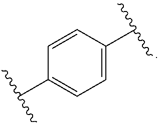 [SMILES: *c1ccc(*)cc1]

In certain embodiments, Ring D is of the formula:

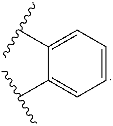 [SMILES: *c1ccccc1*]

As defined herein, Y is a bond, —O—, —NR^{N2}—, or —S—. In certain embodiments, Y is —O—. In certain embodiments, Y is —NR^{N2}—. In certain embodiments, Y is —NH—. In certain embodiments, Y is —S—. In certain embodiments, Y is a bond.

As defined herein, R^{N2} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group. In certain embodiments, R^{N2} is hydrogen. In certain embodiments, R^{N2} is optionally substituted alkyl. In certain embodiments, R^{N2} is optionally substituted alkenyl. In certain embodiments, R^{N2} is optionally substituted alkynyl. In certain embodiments, R^{N2} is optionally substituted aryl. In certain embodiments, R^{N2} is optionally substituted heteroaryl. In certain embodiments, R^{N2} is optionally substituted carbocyclyl. In certain embodiments, R^{N2} is optionally substituted heterocyclyl. In certain embodiments, R^{N2} is optionally substituted acyl. In certain embodiments, R^{N2} is a nitrogen protecting group. In certain embodiments, R^{N2} is hydrogen.

### R⁴ and m

As defined herein, each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S}. In certain embodiments, at least one instance of R⁴ is hydrogen. In certain embodiments, at least one instance of R⁴ is halogen (i.e., —Cl, —Br, —I, and —F). In certain embodiments, at least one instance of R⁴ is —CN. In certain embodiments, at least one instance of R⁴ is —NO₂. In certain embodiments, at least one instance of R⁴ is —N₃. In certain embodiments, at least one instance of R⁴ is optionally substituted alkyl. In certain embodiments, at least one instance of R⁴ is optionally substituted alkenyl. In certain embodiments, at least one instance of R⁴ is optionally substituted alkynyl. In certain embodiments, at least one instance of R⁴ is optionally substituted aryl. In certain embodiments, at least one instance of R⁴ is optionally substituted heteroaryl. In certain embodiments, at least one instance of R⁴ is optionally substituted carbocyclyl. In certain embodiments, at least one instance of R⁴ is optionally substituted heterocyclyl. In certain embodiments, at least one instance of R⁴ is optionally substituted acyl. In certain embodiments, at least one instance of R⁴ is —N(R^{N})₂. In certain embodiments, at least one instance of R⁴ is —OR^{O}. In certain embodiments, at least one instance of R⁴ is —SR^{S}. In certain embodiments, at least one instance of R⁴ is optionally substituted sulfinyl. In certain embodiments, at least one instance of R⁴ is optionally substituted sulfonyl. In certain embodiments, at least one instance of R⁴ is optionally substituted sulfinate. In certain embodiments, at least one instance of R⁴ is optionally substituted sulfonate.

In certain embodiments, each instance of R⁴ is hydrogen.

As defined herein, each instance of m is independently 0, 1, 2, 3, or 4. In certain embodiments, at least one instance of m is 0. In certain embodiments, at least one instance of m is 1. In certain embodiments, at least one instance of m is 2. In certain embodiments, at least one instance of m is 3. In certain embodiments, at least one instance of m is 4. In certain embodiments, each instance of m is 0.

R^{N1}, R^{O1}, R^{S1}

As defined herein, each instance of R^{N1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N1} bonded to the same nitrogen atom are taken together with the intervening atoms to form optionally substituted heterocyclyl or optionally substituted heteroaryl. In certain embodiments, at least one instance of R^{N1} is hydrogen. In certain embodiments, at least one instance of R^{N1} is optionally substituted alkyl. In certain embodiments, at least one instance of R^{N1} is optionally substituted alkenyl. In certain embodiments, at least one instance of R^{N1} is optionally substituted alkynyl. In certain embodiments, at least one instance of R^{N1} is optionally substituted aryl. In certain embodiments, at least one instance of R^{N1} is optionally substituted heteroaryl. In certain embodiments, at least one instance of R^{N1} is optionally substituted carbocyclyl. In certain embodiments, at least one instance of R^{N1} is optionally substituted heterocyclyl. In certain embodiments, at least one instance of R^{N1} is optionally substituted acyl. In certain embodiments, at least one instance of R^{N1} is a nitrogen protecting group. In certain embodiments, two R^{N1} bonded to the same nitrogen atom are taken together with the intervening atoms to form optionally substituted heterocyclyl. In certain embodiments, two R^{N1} bonded to the same nitrogen atom are taken together with the intervening atoms to form optionally substituted heteroaryl. In certain embodiments, at least one instance of R^{N1} is optionally substituted C₁₋₆ alkyl. In certain embodiments, at least one instance of R^{N1} is unsubstituted C₁₋₆ alkyl. In certain embodiments, at least one instance of R^{N1} is optionally substituted C₁₋₃ alkyl. In certain embodiments, at least one instance of R^{N1} is unsubstituted C₁₋₆ alkyl. In certain embodiments, at least one instance of R^{N1} is selected from the group consisting of methyl, ethyl, n-propyl, iso-propyl, n-butyl, iso-butyl, sec-butyl, and tert-butyl. In certain embodiments, at least one instance of R^{N1} is methyl. In certain embodiments, each instance of R^{N1} is methyl. In certain embodiments, each instance of R^{N1} is hydrogen.

In certain embodiments, a group of the formula —N(R^{N1})₂ is of the formula:

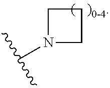

In certain embodiments, a group of the formula —N(R^{N1})₂ is of the formula:

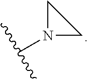 [SMILES: *N1CC1]

In certain embodiments, a group of the formula —N(R^{N1})₂ is of the formula:

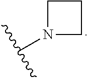 [SMILES: *N1CCC1]

In certain embodiments, a group of the formula —N(R^{N1})₂ is of the formula:

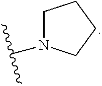 [SMILES: *N1CCCC1]

In certain embodiments, a group of the formula —N(R^{N1})₂ is of the formula:

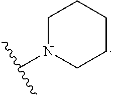 [SMILES: *N1CCCCC1]

In certain embodiments, a group of the formula —N(R^{N1})₂ is of the formula:

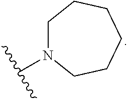 [SMILES: *N1CCCCCC1]

As defined herein, each instance of R^{O1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group. In certain embodiments, at least one instance of R^{O1} is hydrogen. In certain embodiments, at least one instance of R^{O1} is optionally substituted alkyl. In certain embodiments, at least one instance of R^{O1} is optionally substituted alkenyl. In certain embodiments, at least one instance of R^{O1} is optionally substituted alkynyl. In certain embodiments, at least one instance of R^{O1} is optionally substituted aryl. In certain embodiments, at least one instance of R^{O1} is optionally substituted heteroaryl. In certain embodiments, at least one instance of R^{O1} is optionally substituted carbocyclyl. In certain embodiments, at least one instance of R^{O1} is optionally substituted heterocyclyl. In certain embodiments, at least one instance of R^{O1} is optionally substituted acyl. In certain embodiments, at least one instance of R^{O1} is an oxygen protecting group. In certain embodiments, at least one instance of R^{O1} is optionally substituted C₁₋₆ alkyl. In certain embodiments, at least one instance of R^{O1} is unsubstituted C₁₋₆ alkyl. In certain embodiments, at least one instance of R^{O1} is optionally substituted C₁₋₃ alkyl. In certain embodiments, at least one instance of R^{O1} is unsubstituted C₁₋₆ alkyl. In certain embodiments, at least one instance of R^{O1} is selected from the group consisting of methyl, ethyl, n-propyl, iso-propyl, n-butyl, iso-butyl, sec-butyl, and tert-butyl. In certain embodiments, at least one instance of R^{O1} is methyl. In certain embodiments, each instance of R^{O1} is methyl. In certain embodiments, each instance of R^{O1} is hydrogen.

As defined herein, each instance of R^{S1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group. In certain embodiments, at least one instance of R^{S1} is hydrogen. In certain embodiments, at least one instance of R^{S1} is optionally substituted alkyl. In certain embodiments, at least one instance of R^{S1} is optionally substituted alkenyl. In certain embodiments, at least one instance of R^{S1} is optionally substituted alkynyl. In certain embodiments, at least one instance of R^{S1} is optionally substituted aryl. In certain embodiments, at least one instance of R^{S1} is optionally substituted heteroaryl. In certain embodiments, at least one instance of R^{S1} is optionally substituted carbocyclyl. In certain embodiments, at least one instance of R^{S1} is optionally substituted heterocyclyl. In certain embodiments, at least one instance of R^{S1} is optionally substituted acyl. In certain embodiments, at least one instance of R^{S1} is an oxygen protecting group. In certain embodiments, at least one instance of R^{S1} is optionally substituted C₁₋₆ alkyl. In certain embodiments, at least one instance of R^{S1} is unsubstituted C₁₋₆ alkyl. In certain embodiments, at least one instance of R^{S1} is optionally substituted C₁₋₃ alkyl. In certain embodiments, at least one instance of R^{S1} is unsubstituted C₁₋₆ alkyl. In certain embodiments, at least one instance of R^{S1} is selected from the group consisting of methyl, ethyl, n-propyl, iso-propyl, n-butyl, iso-butyl, sec-butyl, and tert-butyl. In certain embodiments, at least one instance of R^{S1} is methyl. In certain embodiments, each instance of R^{S1} is methyl. In certain embodiments, each instance of R^{S1} is hydrogen.

As generally defined herein, each instance of R^{C} is independently hydrogen, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl, optionally wherein two R^{C} on the same carbon atom are joined together with the intervening atoms to form optionally substituted carbocyclyl or optionally substituted heterocyclyl. In certain embodiments, each R^{C} is hydrogen. In certain embodiments, each R^{C} is optionally substituted alkyl.

R³ and

[symbol]

As defined herein, R³ is hydrogen, ═NR^{NX}, —N—R^{NX}, ═S, —S—, ═O, —O—, ═C(R^{C})₂, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl. In certain embodiments, R³ is hydrogen. In certain embodiments, R³ is ═O. In certain embodiments, R³ is halogen. In certain embodiments, R³ is —CN. In certain embodiments, R³ is optionally substituted alkyl. In certain embodiments, R³ is optionally substituted alkenyl. In certain embodiments, R³ is optionally substituted alkynyl. In certain embodiments, R³ is optionally substituted aryl. In certain embodiments, R³ is optionally substituted heteroaryl. In certain embodiments, R³ is optionally substituted carbocyclyl. In certain embodiments, R³ is optionally substituted heterocyclyl. In certain embodiments, R³ is or optionally substituted acyl. In certain embodiments, R³ is ═C(R^{C})₂. In certain embodiments, R³ is ═CH₂. In certain embodiments, R³ is ═NR^{NX}. In certain embodiments, R³ is —N—R^{NX}. In certain embodiments, R³ is ═S. In certain embodiments, R³ is ═NR^{NX}—S⁻.

As defined herein, [symbol] is a single or double bond; provided that when [symbol] is a single bond, R³ is ═NR^{NX}, ═S, ═O or ═C(R^{C})₂; and when [symbol] is a double bond, R³ is not ═NR^{NX}, [symbol] ═O or ═C(R^{C})₂. In certain embodiments, [symbol] is a double bond; and R³ is hydrogen. In certain embodiments, [symbol] is a single bond; and R³ is ═O. In certain embodiments, [symbol] is a single bond; and R³ is ═C(R^{C})₂. In certain embodiments, [symbol] is a single bond; and R³ is ═CH₂. In certain embodiments, [symbol] is a single bond; and R³ is ═C(CN)₂. In certain embodiments, [symbol] is a single bond; and R³ is ═C(CN)(CO₂H). In certain embodiments, [symbol] is a single bond; and R³ is ═NR^{NX}. In certain embodiments, [symbol] is a single bond; and R³ is ═NH. In certain embodiments, [symbol] is a single bond; and R³ is ═S.

As defined herein, R^{NX} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group. In certain embodiments, R^{NX} is hydrogen. In certain embodiments, R^{NX} is optionally substituted alkyl. In certain embodiments, R^{NX} is optionally substituted alkenyl. In certain embodiments, R^{NX} is optionally substituted alkynyl. In certain embodiments, R^{NX} is optionally substituted aryl. In certain embodiments, R^{NX} is optionally substituted heteroaryl. In certain embodiments, R^{NX} is optionally substituted carbocyclyl. In certain embodiments, R^{NX} is optionally substituted heterocyclyl. In certain embodiments, R^{NX} is optionally substituted acyl. In certain embodiments, R^{NX} is a nitrogen protecting group.

L¹ and L²

As defined herein, L¹ is a bond, optionally substituted alkylene, optionally substituted heteroalkylene, optionally substituted alkenylene, optionally substituted alkynylene, optionally substituted heteroalkylene, optionally substituted heteroalkynylene, optionally substituted carbocyclylene, optionally substituted arylene, optionally substituted heterocyclylene optionally substituted heteroarylene, optionally substituted acylene, or a combination thereof. In certain embodiments, L¹ is a bond. In certain embodiments, L¹ comprises optionally substituted alkylene. In certain embodiments, L¹ comprises optionally substituted heteroalkylene. In certain embodiments, L¹ comprises optionally substituted alkenylene. In certain embodiments, L¹ comprises optionally substituted alkynylene. In certain embodiments, L¹ comprises optionally substituted carbocyclylene. In certain embodiments, L¹ comprises optionally substituted arylene. In certain embodiments, L¹ comprises optionally substituted heterocyclylene. In certain embodiments, L¹ comprises optionally substituted heteroarylene. In certain embodiments, L¹ comprises optionally substituted acylene. In certain embodiments, L¹ is optionally substituted heteroalkenylene. In certain embodiments, L¹ is optionally substituted heteroalkynylene.

In certain embodiments, LV is optionally substituted alkylene. In certain embodiments, L¹ is optionally substituted C₁₋₆ alkylene. In certain embodiments, L¹ is unsubstituted C₁₋₆ alkylene. In certain embodiments, L¹ is optionally substituted C₁₋₃ alkylene. In certain embodiments, L¹ is unsubstituted C₁₋₆ alkylene. In certain embodiments, L¹ is of the formula:

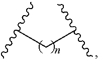

wherein n is an integer from 1-6, inclusive. As defined herein, n is an integer from 1-6, inclusive. In certain embodiments, n is 1. In certain embodiments, n is 2. In certain embodiments, n is 3. In certain embodiments, n is 4. In certain embodiments, n is 5. In certain embodiments, n is 6.

In certain embodiments, L¹ is of one of the following formulae:

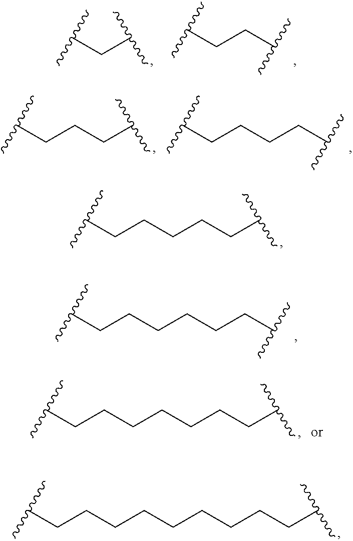

In certain embodiments, L¹ is of the formula:

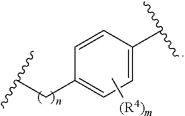

In certain embodiments, L¹ is of the formula:

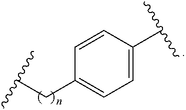 [SMILES: *Cc1ccc(*)cc1]

In certain embodiments, L¹ is of the formula:

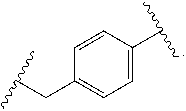 [SMILES: *Cc1ccc(*)cc1]

In certain embodiments, L¹ is of the formula:

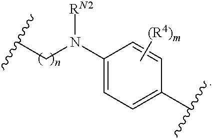

In certain embodiments, L¹ is of the formula:

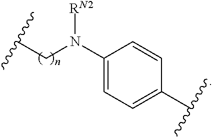

In certain embodiments, L¹ is of the formula:

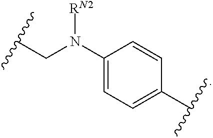

In certain embodiments, L¹ is of the formula:

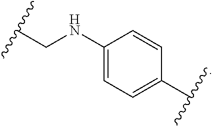 [SMILES: *CNc1ccc(*)cc1]

In certain embodiments, L¹ is of the formula:

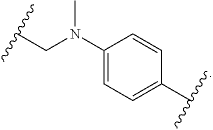 [SMILES: *CN(C)c1ccc(*)cc1]

As defined herein, L² is a bond, optionally substituted alkylene, optionally substituted heteroalkylene, optionally substituted alkenylene, optionally substituted alkynylene, optionally substituted carbocyclylene, optionally substituted arylene, optionally substituted heterocyclylene optionally substituted heteroarylene, optionally substituted acylene, or a combination thereof. In certain embodiments, L² is a bond. In certain embodiments, L² comprises optionally substituted alkylene. In certain embodiments, L² comprises optionally substituted heteroalkylene. In certain embodiments, L² comprises optionally substituted alkenylene. In certain embodiments, L² comprises optionally substituted alkynylene. In certain embodiments, L² comprises optionally substituted carbocyclylene. In certain embodiments, L² comprises optionally substituted arylene. In certain embodiments, L² comprises optionally substituted heterocyclylene. In certain embodiments, L² comprises optionally substituted heteroarylene. In certain embodiments, L² comprises optionally substituted acylene.

In certain embodiments, L² is optionally substituted alkylene. In certain embodiments, L² is optionally substituted C₁₋₆ alkylene. In certain embodiments, L² is unsubstituted C₁₋₆ alkylene. In certain embodiments, L² is optionally substituted C₁₋₃ alkylene. In certain embodiments, L² is unsubstituted C₁₋₆ alkylene. In certain embodiments, L² is of the formula:

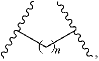

wherein n is an integer from 1-6, inclusive. As defined herein, n is an integer from 1-6, inclusive. In certain embodiments, n is 1. In certain embodiments, n is 2. In certain embodiments, n is 3. In certain embodiments, n is 4. In certain embodiments, n is 5. In certain embodiments, n is 6. In certain embodiments, L² is of one of the following formula:

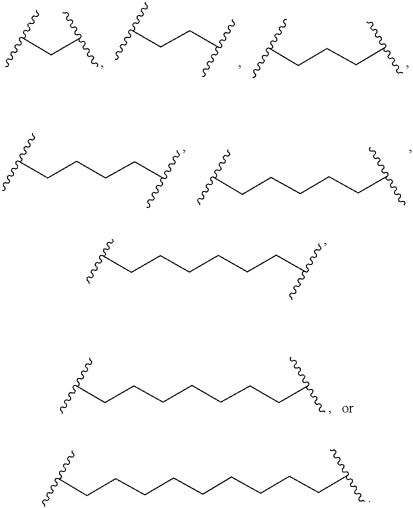

In certain embodiments, L² is optionally substituted alkylene. In certain embodiments, L² is optionally substituted C₁₋₆ alkylene. In certain embodiments, L² is unsubstituted C₁₋₆ alkylene. In certain embodiments, L² is optionally substituted C₁₋₃ alkylene. In certain embodiments, L² is unsubstituted C₁₋₆ alkylene.

In certain embodiments, L² is of the following formula:

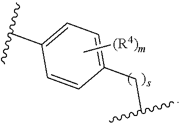

In certain embodiments, L² is of the following formula:

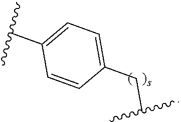 [SMILES: *Cc1ccc(*)cc1]

In certain embodiments, L² is of the following formula:

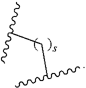 [SMILES: *C*]

In certain embodiments, L² is of the following formula:

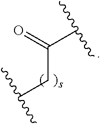 [SMILES: *CC(*)=O]

In certain embodiments, L² is of the following formula:

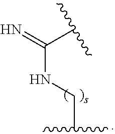

As defined herein, s is 0, 1, 2, 3, 4, 5, or 6. In certain embodiments, s is 0. In certain embodiments, s is 1. In certain embodiments, s is 2. In certain embodiments, s is 3. In certain embodiments, s is 4. In certain embodiments, s is 5. In certain embodiments, s is 6.

R¹ and R²

As defined herein, R¹ is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, an oxygen protecting group, an amino acid, or a polypeptide. In certain embodiments, R¹ is hydrogen. In certain embodiments, R¹ is optionally substituted alkyl. In certain embodiments, R¹ is optionally substituted alkenyl. In certain embodiments, R¹ is optionally substituted alkynyl. In certain embodiments, R¹ is optionally substituted aryl. In certain embodiments, R¹ is optionally substituted heteroaryl. In certain embodiments, R¹ is optionally substituted carbocyclyl. In certain embodiments, R¹ is optionally substituted heterocyclyl. In certain embodiments, R¹ is optionally substituted acyl. In certain embodiments, R¹ is an oxygen protecting group. In certain embodiments, R¹ is an amino acid. In certain embodiments, R¹ is a polypeptide.

As defined herein, each instance of R² is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, a nitrogen protecting group, an amino acid, or a polypeptide; or two R² bonded to the same nitrogen atom are taken together with the intervening atoms to form optionally substituted heterocyclyl or optionally substituted heteroaryl. In certain embodiments, at least one instance of R² is hydrogen. In certain embodiments, at least one instance of R² is optionally substituted alkyl. In certain embodiments, at least one instance of R² is optionally substituted alkenyl. In certain embodiments, at least one instance of R² is optionally substituted alkynyl. In certain embodiments, at least one instance of R² is optionally substituted aryl. In certain embodiments, at least one instance of R² is optionally substituted heteroaryl. In certain embodiments, at least one instance of R² is optionally substituted carbocyclyl. In certain embodiments, at least one instance of R² is optionally substituted heterocyclyl. In certain embodiments, at least one instance of R² is optionally substituted acyl. In certain embodiments, at least one instance of R² is a nitrogen protecting group. In certain embodiments, at least one instance of R² is an amino acid. In certain embodiments, at least one instance of R² is a polypeptide. In certain embodiments, two R² bonded to the same nitrogen atom are taken together with the intervening atoms to form optionally substituted heterocyclyl. In certain embodiments, two R² bonded to the same nitrogen atom are taken together with the intervening atoms to form optionally substituted heteroaryl. In certain embodiments, each instance of R² is hydrogen.

R^{N}, R^{O}, and R^{S}

As defined herein, each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl.

As defined herein, each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group.

As defined herein, each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group.

### Methods of Use, Compositions, and Kits

The compounds described herein (e.g., compounds of Formulae (I), (II), (III), and (IV)) can be used as fluorescent labeling reagents in the fluorescent labeling and imaging of biomolecules and/or cells.

Provided herein are methods of labeling a biomolecule and/or cell, the method comprising exposing the biomolecule and/or cell to a compound of Formula (I), (II), (III), or (IV), or a salt, tautomer, or isotopically labeled derivative thereof. In certain embodiments, the compound is covalently incorporated into the biomolecule and/or cell (e.g., through enzymatic incorporation, chemical synthesis, ribosomal incorporation). In certain embodiments, the method comprises exposing the biomolecule and/or cell to a compound of Formula (I), (II), (III), or (IV), or a salt, tautomer, or isotopically labeled derivative thereof, in the presence of an enzyme capable of incorporating the compound into the biomolecule and/or cell. In certain embodiments, the compound is covalently incorporated into a biomolecule. In certain embodiments, the biomolecule is in a cell (e.g., in a cell wall, cytoplasm, or nucleus).

In certain embodiments, the biomolecule is a protein, polypeptide, glycan, peptidoglycan, or nucleic acid. In certain embodiments, biomolecule is a protein. In certain embodiments, the biomolecule is a polypeptide. In certain embodiments, the biomolecule is a glycan. In certain embodiments, the biomolecule is peptidoglycan. In certain embodiments, the biomolecule is a nucleic acid (e.g., oligonucleotide, DNA, RNA, mRNA). In certain embodiments, the biomolecule is an antibody or a fragment thereof. In certain embodiments, the biomolecule is a nanobody.

In certain embodiments, the biomolecule is in a cell (e.g., in a cell wall). In certain embodiments, the cell is a eukaryotic cell. In certain embodiments, the cell is prokaryotic cell. In certain embodiments, the cell is mammalian cell. In certain embodiments, the cell is a human cell. In certain embodiments, cell is a bacterial cell. In certain embodiments, the cell is a plant cell. In certain embodiments, the biomolecule is peptidoglycan in the wall of a cell. In certain embodiments, the biomolecule is peptidoglycan in the wall of a bacterial cell.

As described herein, the compound may be incorporated into a biomolecule via enzymatic incorporation. In certain embodiments, the compound is incorporated into a biomolecule (e.g., protein, polypeptide, peptidoglycan) through transpeptidation. Therefore, in certain embodiments, the method of labeling a biomolecule comprises exposing the biomolecule to a compound of Formula (I), (II), (III), or (IV), or a salt, tautomer, or isotopically labeled derivative thereof, in the presence of a transpeptidase. In certain embodiments, a compound described herein is incorporated into peptidoglycan via transpeptidation (e.g., D,D-transpeptidation or L,D-transpeptidation). Therefore, in certain embodiments, the method comprises exposing peptidoglycan to a compound of Formula (I), (II), (III), or (IV), or a salt, tautomer, or isotopically labeled derivative thereof, in the presence of a transpeptidase (e.g., D,D-transpeptidase or L,D-transpeptidase).

In certain embodiments, a compound described herein (e.g., a compound of Formula (I), (II), (III), or (IV)) is covalently attached to a biomolecule (e.g., protein, polypeptide) or another amino acid via chemical synthesis (e.g., in the presence of a peptide coupling reagent).

In certain embodiments, the compounds described herein may be conjugated to nucleotides (e.g., nucleotide bases) to form modified nucleotides or oligonucleotides. Examples of amino acid-containing nucleotides include, but are not limited to, Lysidine and other non-standard nucleotides (see, e.g., Tetrahedron Volume 72, Issue 29, 21 Jul. 2016, Pages 4177-4185). For example, conjugating a fluorescent amino acid onto an RNA (e.g., guide RNA) can lead to a fluorogenic readout for association of the RNA and the target.

In general, the compounds described herein can provide a functional readout, e.g., for protein-protein interactions or protein localization, when the compounds are judicially placed on an enzyme. Additionally, in drug discovery assays, the target protein may include a fluorogenic amino acid. In this instance, screening binding affinity of small molecules to the target protein may have a fluorescent readout.

After labeling a biomolecule and/or cell with a FgAA compound described herein, the fluorescence of the resulting labeled biomolecule or cell can be observed and/or measured. Therefore, provided herein is a method of detecting a biomolecule and/or cell comprising:
(a) labeling the biomolecule and/or cell via any one of the methods described above; and
(b) measuring or observing the fluorescence of the biomolecule and/or cell.

Also provided herein are methods of detecting a labeled biomolecule or cell described herein, the methods comprising measuring or observing the fluorescence of the biomolecule and/or cell.

Also provided herein are compositions comprising an FgAA compound described herein (e.g., a compound of Formula (I), (II), (III), or (IV)). In certain embodiments, a composition will comprise a compound provided herein and a solution or excipient.

Also provided herein are kits comprising a FgAA compound described herein (e.g., a compound of Formula (I), (II), (III), or (IV)), or a composition thereof. In certain embodiments, a kit will comprise a compound provided herein, or a composition thereof, and optionally one or more chemical reagents or enzymes. In certain embodiments, the kit comprises one or more chemical synthesis reagents (e.g., peptide coupling reagents). In certain embodiments, the kit comprises one or more enzymes (e.g., transpeptidases, e.g., D,D-transpeptidase or L,D-transpeptidase).

### Biomolecules and Cells

Also provided herein are biomolecules comprising a compound of Formula (I), (II), (III), or (IV), or a salt, tautomer, or isotopically labeled derivative thereof (i.e., “labeled biomolecules”). In certain embodiments, the compound is covalently incorporated into (i.e., covalently attached to) the biomolecule. In certain embodiments, the compound is covalently attached to the biomolecule through one or more peptide bonds. In certain embodiments, the compound is covalently attached to the biomolecule through one or more ester linkages. In certain embodiments, the compound is covalently attached to the biomolecule through one or more disulfide bonds. The labeled biomolecule can comprise one or more of the compounds described herein. In certain embodiments, the labeled biomolecule comprises more than one of the compounds described herein.

In certain embodiments, the biomolecule is a protein, polypeptide, glycan, peptidoglycan, or nucleic acid. In certain embodiments, biomolecule is a protein. In certain embodiments, the biomolecule is a polypeptide. In certain embodiments, the biomolecule is a glycan. In certain embodiments, the biomolecule is peptidoglycan. In certain embodiments, the biomolecule is a nucleic acid. In certain embodiments, the labeled biomolecule is in a cell. In certain embodiments, the labeled biomolecule is in the wall of a cell. In certain embodiments, the labeled biomolecule is in the cytoplasm or nucleus of a cell.

Also provided herein are cells comprising a compound of Formula (I), (II), (III), or (IV), or a salt, tautomer, or isotopically labeled derivative thereof. In certain embodiments, the compound is covalently incorporated into (i.e., covalently attached to) the cell. In certain embodiments, the compound is in the intracellular fluid of the cell. In certain embodiments, the cell comprises a labeled biomolecule described herein. In certain embodiments, the cell comprises a labeled biomolecule described herein in the wall of the cell. In certain embodiments, the cell comprises a labeled biomolecule is in the cytoplasm or nucleus of a cell.

In certain embodiments, the cell is a eukaryotic cell. In certain embodiments, the cell is prokaryotic cell. In certain embodiments, the cell is mammalian cell. In certain embodiments, the cell is a human cell. In certain embodiments, cell is a bacterial cell. In certain embodiments, the cell is a plant cell. In certain embodiments, the cell comprises a labeled peptidoglycan. In certain embodiments, the cell comprises a labeled peptidoglycan in the wall of the cell. In certain embodiments, the cell is a bacterial cell comprising a labeled peptidoglycan in the wall of the cell.

### EXAMPLES

These and other aspects of the present invention will be further appreciated upon consideration of the following Examples, which are intended to illustrate certain particular embodiments of the invention but are not intended to limit its scope, as defined by the claims.

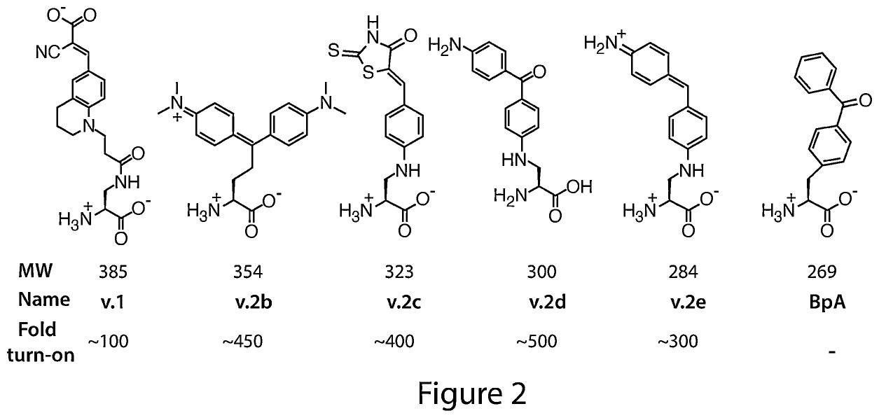

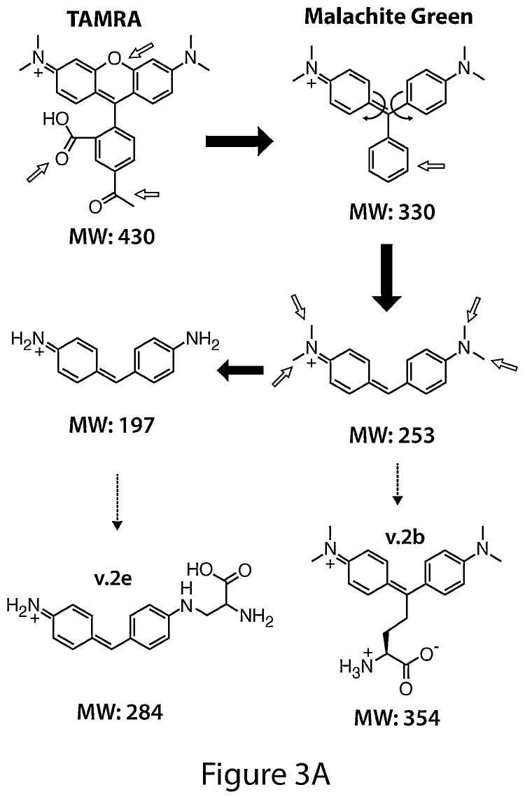

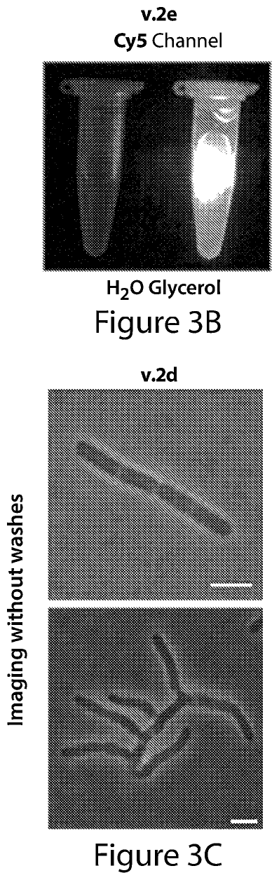

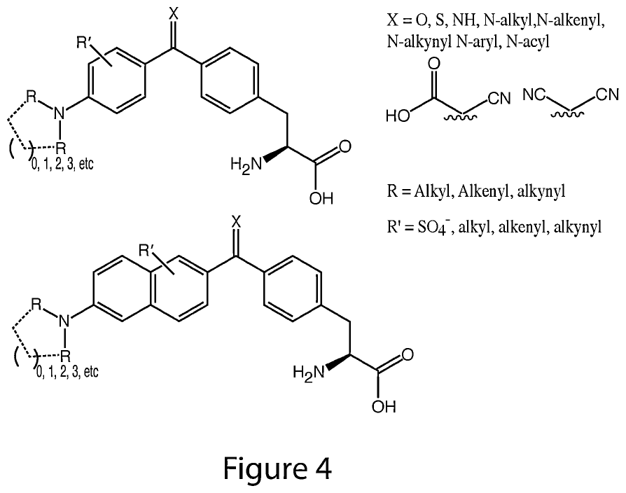

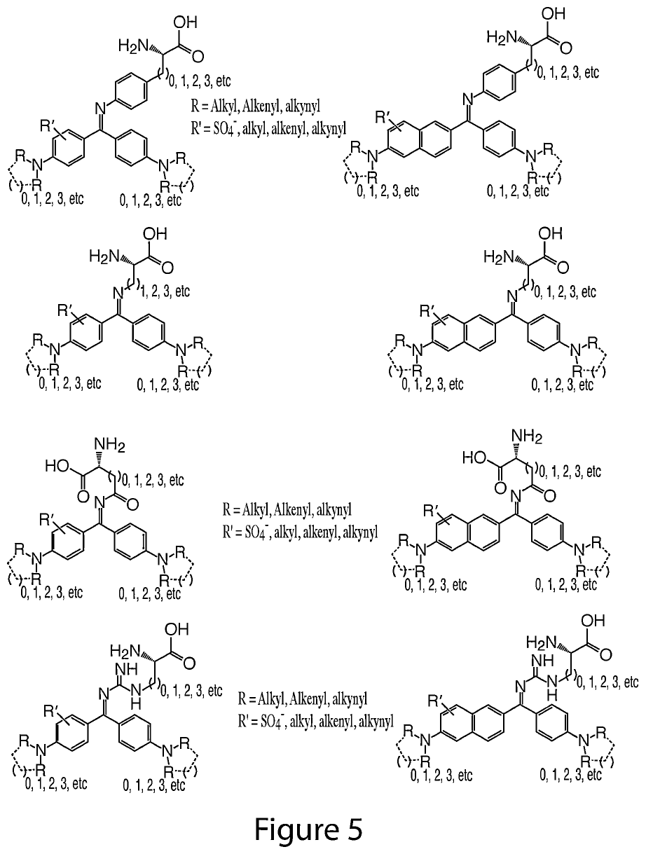

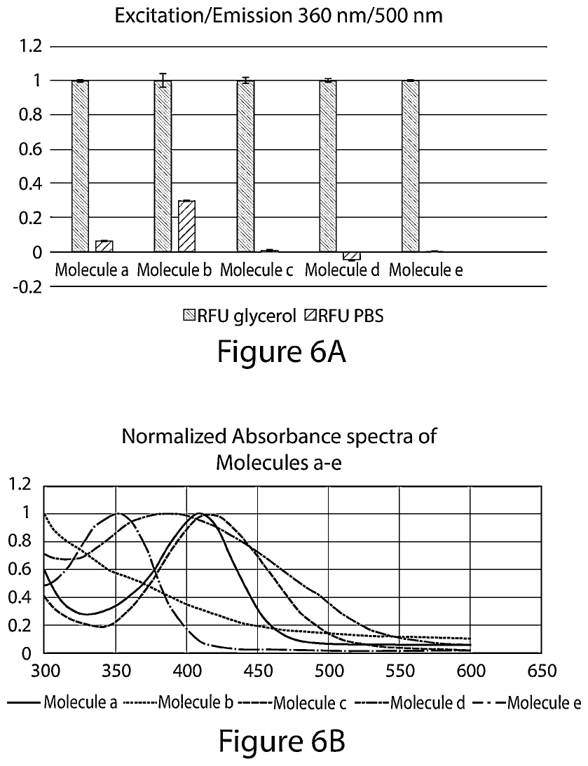

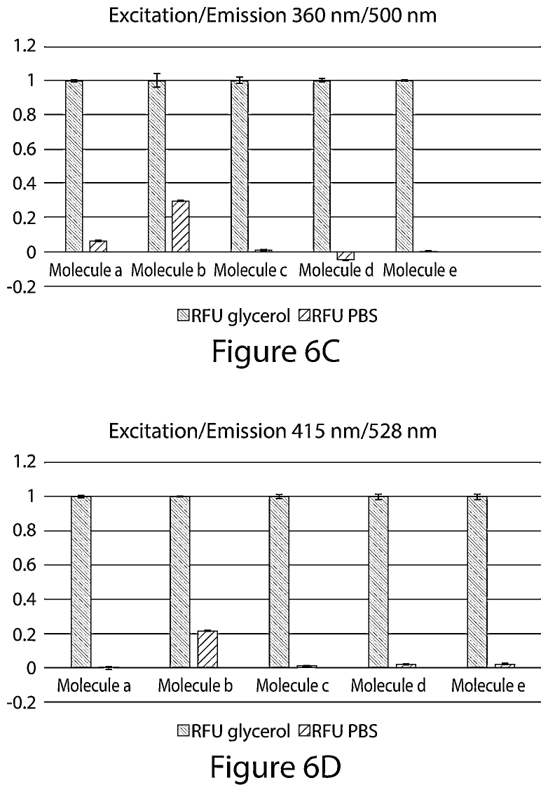

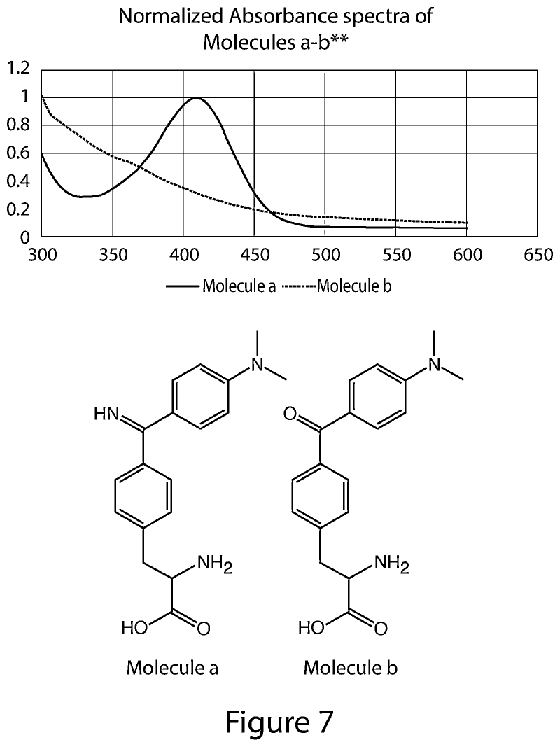

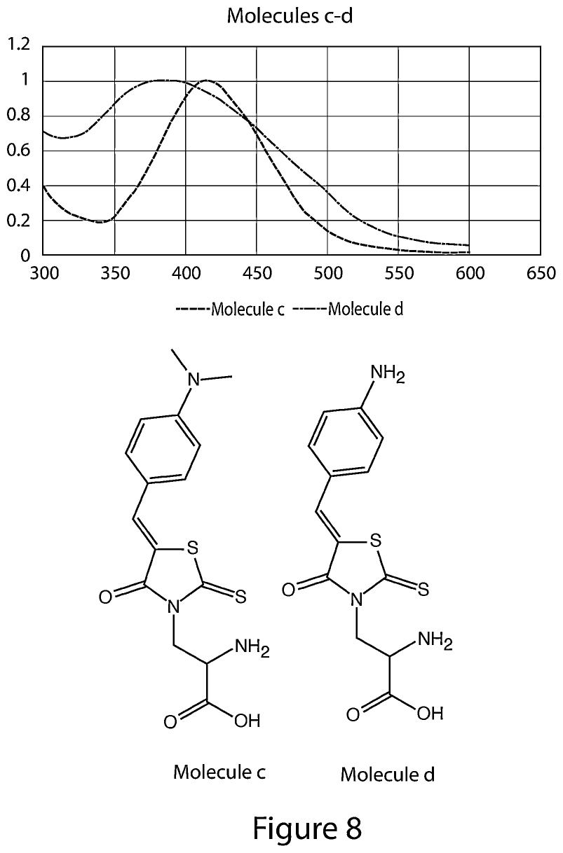

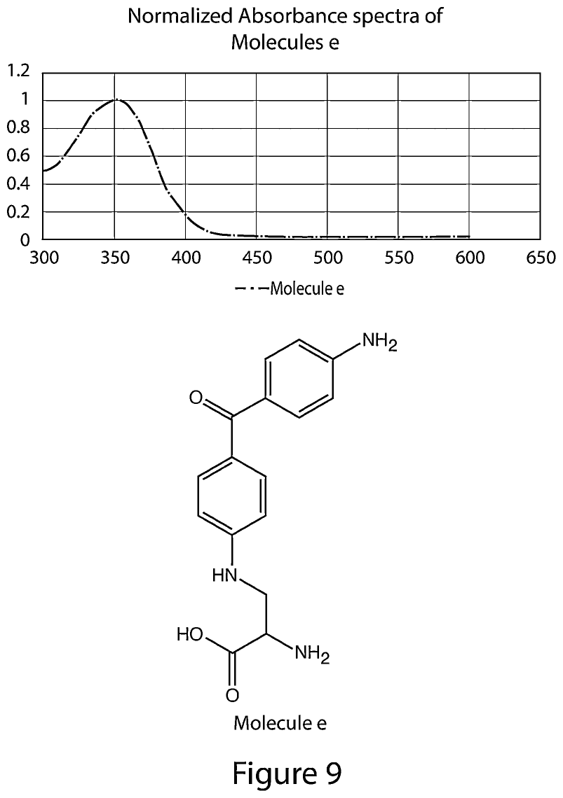

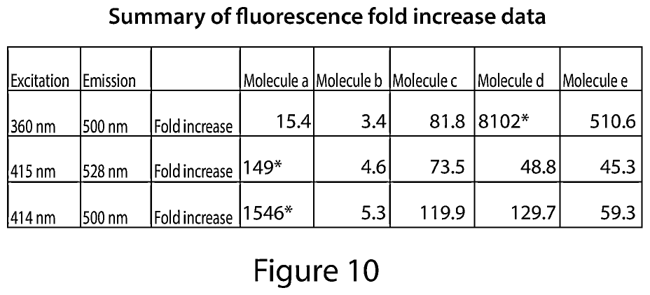

Previously, it has been demonstrated that the bacterial cell wall machinery has an unprecedented, inherent promiscuity to incorporate synthetic D-amino acids with substantial side groups. In comparison, the protein translation machinery has a much narrower tolerance to large synthetic L-amino acids such as non-standard amino acids (nsAAs). Described herein is the design and testing of new fluorogenic amino acids (FgAAs) that are small enough to be tolerated by translation machinery. New fluorogenic amino acids (FgAAs) that are smaller, distinctly colored, significantly more fluorogenic, and harbor different geometries than state-of-the-art FgAAs were prepared (compounds v.2a-e, FIG. 2). These VFgAAs are virtually dark in aqueous buffer, or when incubated with live cells, unless they are in viscous environments, e.g., in glycerol, in the cytoplasm of a cell, or covalently linked to bacterial cell walls (FIGS. 3B-3C).

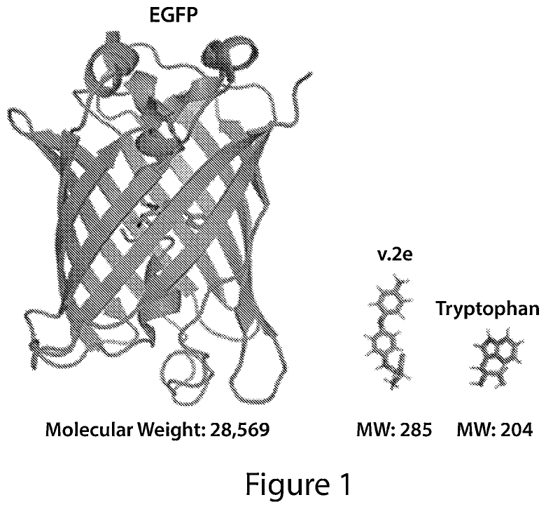

The compounds described herein can replace fluorescent proteins (FPs) in many bimolecular and cellular labeling applications. In certain embodiments, the compounds described herein are advantageous because: (1) they are orders of magnitude smaller than FPs resulting in minimal perturbation to tagged proteins (see, e.g., FIG. 1); and/or (2) the compounds are rapidly visible upon biomolecule incorporation as they do not require maturation nor oxygen to turn on. In other embodiments, incorporating the compounds into antibodies or nanobodies can help evaluate antibodies against different antigens (i.e., the tighter such an antibody binds to its target, the brighter the labeled biomolecule or cell).

Compound v.2e, the smallest far-red fluorescing FgAA now known, has a counter-intuitive fluorogenic compound design. Based on the structure of the red fluorescent dye tetramethylrhodamine (TAMRA), this new amino acid reduces TAMRA to a bare minimum scaffold. This scaffold is a small structural mimic of known nsAAs such as BpA (See FIG. 2), but is also fluorogenic. TAMRA without the two carbonyl groups is still fluorescent. However, absent its oxygen bridge, the intramolecular rotations of the now free aromatic rings turn the fluorescence off in environments that are not spatially constrained (See, e.g., FIG. 3). This molecule resembles the dye Malachite Green (MG). This sizable dye is fluorogenic in that it fluoresces only when its intramolecular rotations are restricted in viscous environments or when bound to macromolecules. Shedding the phenyl and the tetramethyl groups of MG are counter-intuitive steps. However, this attempt not only made these molecules much smaller; but it also rendered these fluorophores functionalizable through their now free amines. Indeed, functionalization of these molecules to compounds v.2b and v.2e did not impact the fluorogenicity of these molecules and resulted in the smallest far-red fluorescing FgAAs currently known (See, e.g., FIG. 3B). Significantly, compound v.2e (and its derivative v.2d) are structurally similar to BpA (See, e.g., FIG. 2), an nsAA that can efficiently be encoded into proteins. Finally, v.2d in D-chirality also allowed wash-free visualization of PG biosynthesis indicating that these new FgAAs behave as expected in live bacteria (See, e.g., FIG. 3C).

### Synthesis of FgAAs

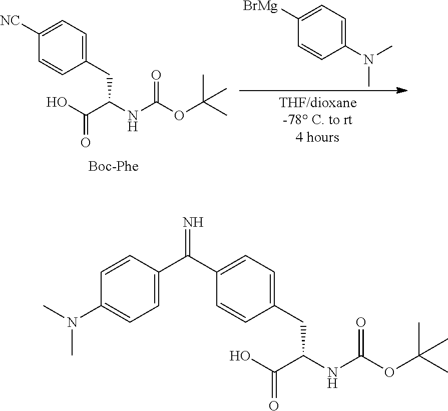

To a stirring solution of the protected amino acid (circa 1 gram) in THF (20 mL solvent) at −78° C. was added Grignard reagent (25 mL, 0.5 M). 20 mL of dioxane was added and the cooling bath was removed to allow the reaction to warm to room temperature and continue for 4 hours. The reaction was stopped by pouring into mildly acid water (circa pH 3, HCl). The compound—which stayed in the water at acidic and basic pHs was washed with ethyl acetate and DCM at both acidities. The compound was then extracted out of the acidified solution using several portions of IPA:EtOAc:AcOH (1:4:1%). The compound was washed with brine and dried over MgS04. Upon concentration the product solidifies to a greenish/white flacks. Recrystallizing out of DCM provides the pure product in good yield (circa 700 mg).

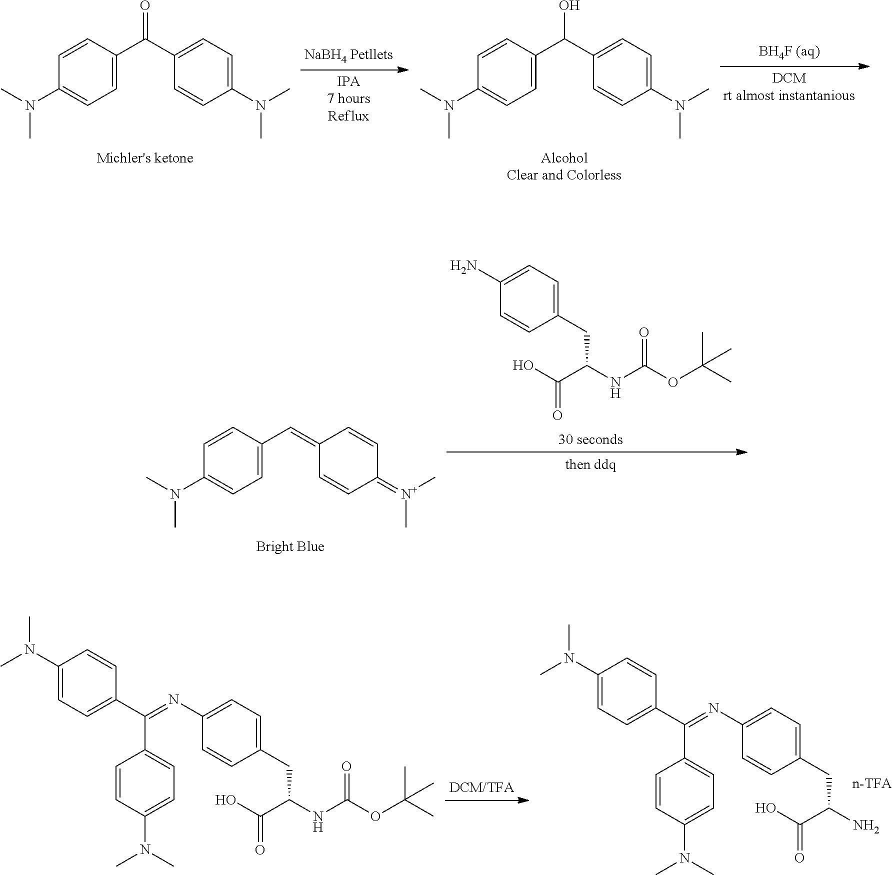

To Michler's ketone in IPA was added a NaBH₄ (gram pellet). The reaction was heated to reflux and allowed to continue for 6 hours. The product was washed with NaOH (aq), extracted with EtOAc washed with brine and dried over Na₂SO₄. A portion of the alcohol product was diluted with DCM (clear and colorless resultant solution) and several drops of BH₄F (aq) was added and the resulting deep blue solution was mixed vigorously. To this was added Boc-Phe(4-aminio)OH. The solution turned clear and almost colorless and DDQ was added in one portion and mixed vigorously. The reaction solution was diluted with basic was washed with EtOAc and acidified, extracted into EtOAc, washed with brine and dried over Na₂SO₄. The crude product was loaded onto a silica column and a gradient of hexane to 100%. Reverse phase HPLC-MS showed a mostly pure peak for 531.1 DA at 9.29 minutes. This purified compound was concentrated in vacuo and stirred in 1:1 DCM:TFA for 2 hours at 0 degrees to remove the Boc protecting group. The isolated compound was run on LCMS which showed a mostly pure compound (431.3 Da, RT=5.98 min).

### Equivalents and Scope

Text here. In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

What is claimed is:

1. A compound of Formula (I): 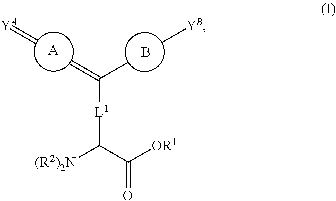
or a salt, tautomer, or isotopically labeled derivative thereof, wherein:
═Y^{A} is ═N⁺(R^{N1})₂, ═NR^{N1}, ═O⁺R^{O1}, ═O, or ═S⁺R^{S1}, or ═S;
Ring A is an optionally substituted carbocyclic, optionally substituted heterocyclic, optionally substituted aryl, or optionally substituted heteroaryl ring comprising at least one double bond in conjugation with ═Y^{A} and the group: 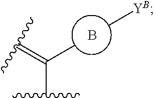
Ring B is optionally substituted aryl or optionally substituted heteroaryl ring;
Y^{B} is —N(R^{N1})₂, —OR^{O1}, or —SR^{S1};
L¹ is a bond, optionally substituted alkylene, optionally substituted heteroalkylene, optionally substituted alkenylene, optionally substituted alkynylene, optionally substituted carbocyclylene, optionally substituted arylene, optionally substituted heterocyclylene optionally substituted heteroarylene, optionally substituted acylene, or a combination thereof;
R¹ is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, an oxygen protecting group, an amino acid, or a polypeptide;
each instance of R² is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, a nitrogen protecting group, an amino acid, or a polypeptide; or two R² bonded to the same nitrogen atom are taken together with the intervening atoms to form optionally substituted heterocyclyl or optionally substituted heteroaryl;
each instance of R^{N1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N1} bonded to the same nitrogen atom are taken together with the intervening atoms to form optionally substituted heterocyclyl or optionally substituted heteroaryl;
each instance of R^{O1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group; and
each instance of R^{S1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group.

2. The compound of the preceding claim, wherein Ring A is a 6-membered optionally substituted carbocyclic or 6-membered optionally substituted heterocyclic ring.

3. The compound of any one of the preceding claims, wherein the compound is of the formula: 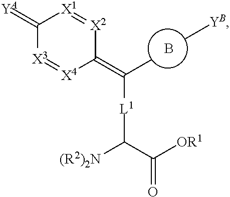
or a salt, tautomer, or isotopically labeled derivative thereof, wherein:
each of X¹, X², X³, and X⁴ are independently N or CR⁴;
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group; and
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group.

4. The compound of any one of the preceding claims, wherein X¹ is CR⁴.

5. The compound of any one of the preceding claims, wherein X² is CR⁴.

6. The compound of any one of the preceding claims, wherein X³ is CR⁴.

7. The compound of any one of the preceding claims, wherein X⁴ is CR⁴.

8. The compound of any one of the preceding claims, wherein Ring A is an optionally substituted C₆ carbocyclic ring.

9. The compound of any one of the preceding claims, wherein Ring A is an optionally substituted cyclohexadienyl ring.

10. The compound of any one of the preceding claims, wherein Ring A is of the formula: 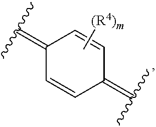
wherein:
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
m is 0, 1, 2, 3, or 4.

11. The compound of any one of the preceding claims, wherein Ring B is optionally substituted aryl.

12. The compound of any one of the preceding claims, wherein Ring B is optionally substituted phenyl.

13. The compound of any one of the preceding claims, wherein Ring B is of the formula: 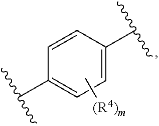
wherein:
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
m is 0, 1, 2, 3, or 4.

14. The compound of any one of the preceding claims, wherein the compound is of the formula: 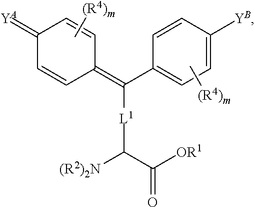
or a salt, tautomer, or isotopically labeled derivative thereof.

15. The compound of any one of the preceding claims, wherein ═Y^{A} is ═N⁺(R^{N1})₂.

16. The compound of any one of the preceding claims, wherein ═Y^{A} is ═O.

17. The compound of any one of the preceding claims, wherein Y^{B} is —N(R^{N1})₂.

18. The compound of any one of the preceding claims, wherein Y^{B} is —OR^{O1}.

19. The compound of any one of the preceding claims, wherein the compound is of one of the following formulae: 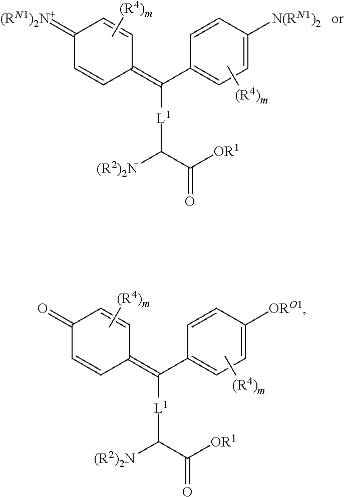
or a salt, tautomer, or isotopically labeled derivative thereof.

20. The compound of any one of the preceding claims, wherein L¹ is optionally substituted alkylene.

21. The compound of any one of the preceding claims, wherein L¹ is optionally substituted C₁₋₆ alkylene.

22. The compound of any one of the preceding claims, wherein L¹ is unsubstituted C₁₋₆ alkylene.

23. The compound of any one of the preceding claims, wherein L¹ is of the formula:

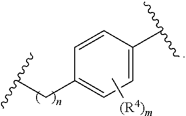

24. The compound of any one of the preceding claims, wherein L¹ is of the formula:

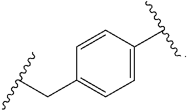 [SMILES: *Cc1ccc(*)cc1]

25. The compound of any one of the preceding claims, wherein L¹ is of the formula:

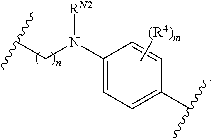

26. The compound of any one of the preceding claims, wherein L¹ is of the formula:

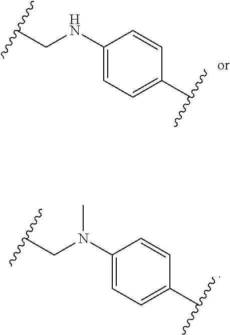 [SMILES: *CNc1ccc(*)cc1 ; *CN(C)c1ccc(*)cc1]

27. The compound of any one of the preceding claims, wherein the compound is of one of the following formulae: 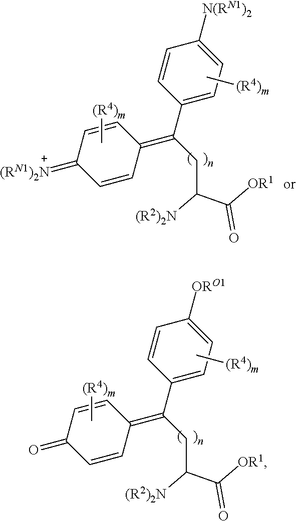
or a salt, tautomer, or isotopically labeled derivative thereof, wherein:
n is an integer from 1-6, inclusive.

28. The compound of any one of the preceding claims, wherein the compound is of one of the following formulae: 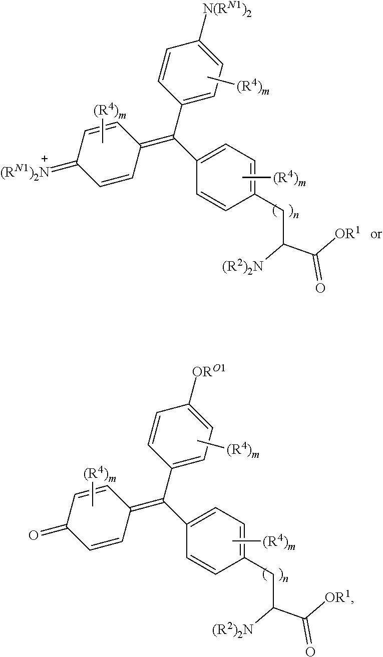
or a salt, tautomer, or isotopically labeled derivative thereof, wherein:
n is an integer from 1-6, inclusive.

29. The compound of any one of the preceding claims, wherein the compound is of the following formula: 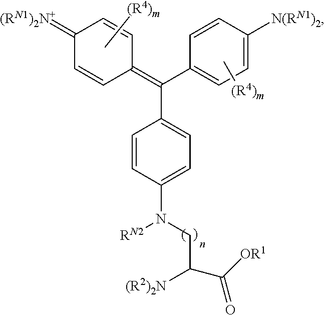
or a salt, tautomer, or isotopically labeled derivative thereof, wherein:
n is an integer from 1-6, inclusive.

30. The compound of claim 1, wherein the compound is of one of the following formulae: 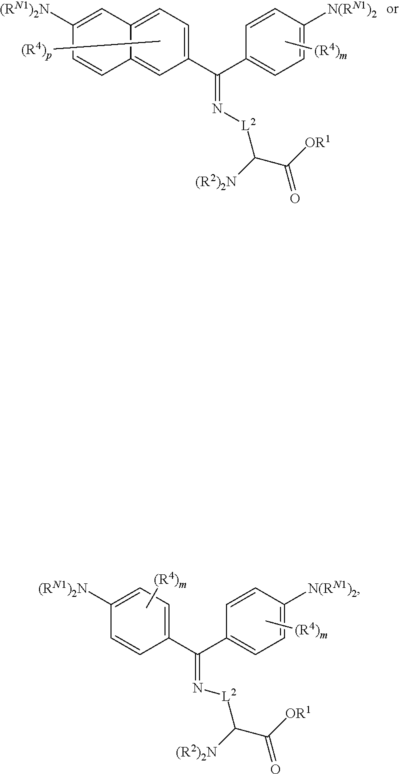
or a salt, tautomer, or isotopically labeled derivative thereof, wherein p is 0, 1, 2, 3, 4, 5, or 6.

31. The compound of claim 1, wherein the compound is of the following formula: 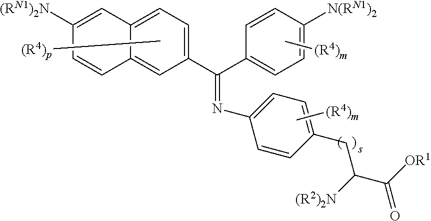
or a salt, tautomer, or isotopically labeled derivative thereof; wherein s is 0, 1, 2, 3, 4, 5, or 6;
and p is 0, 1, 2, 3, 4, 5, or 6.

32. The compound of claim 1, wherein the compound is of the following formula: 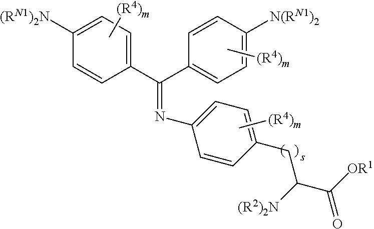
or a salt, tautomer, or isotopically labeled derivative thereof; wherein s is 0, 1, 2, 3, 4, 5, or 6.

33. The compound of claim 1, wherein the compound is of the following formula: 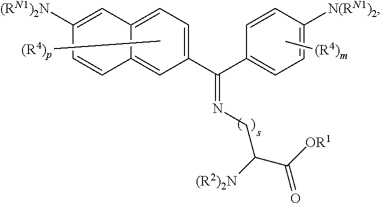
or a salt, tautomer, or isotopically labeled derivative thereof; wherein s is 0, 1, 2, 3, 4, 5, or 6;
and p is 0, 1, 2, 3, 4, 5, or 6.

34. The compound of claim 1, wherein the compound is of the following formula: 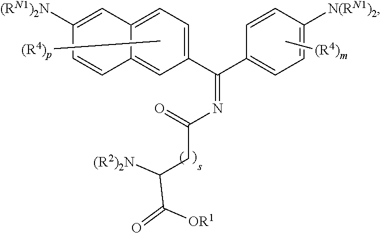
or a salt, tautomer, or isotopically labeled derivative thereof; wherein s is 0, 1, 2, 3, 4, 5, or 6;
and p is 0, 1, 2, 3, 4, 5, or 6.

35. The compound of claim 1, wherein the compound is of the following formula: 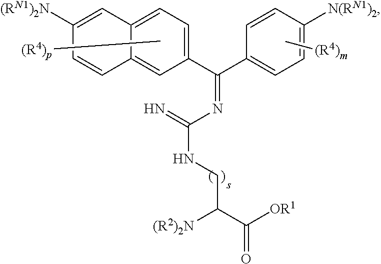
or a salt, tautomer, or isotopically labeled derivative thereof; wherein s is 0, 1, 2, 3, 4, 5, or 6;
and p is 0, 1, 2, 3, 4, 5, or 6.

36. The compound of any one of the preceding claims, wherein each instance of m is 0.

37. The compound of any one of the preceding claims, wherein at least one instance of R^{N1} is optionally substituted alkyl.

38. The compound of any one of the preceding claims, wherein at least one instance of R^{N1} is optionally substituted C₁₋₆ alkyl.

39. The compound of any one of the preceding claims, wherein at least one instance of R^{N1} is unsubstituted C₁₋₆ alkyl.

40. The compound of any one of the preceding claims, wherein at least one instance of R^{N1} is methyl.

41. The compound of any one of the preceding claims, wherein each instance of R^{N1} is methyl.

42. The compound of any one of the preceding claims, wherein at least one instance of R^{O1} is hydrogen.

43. The compound of any one of the preceding claims, wherein the compound is of one of the following formulae: 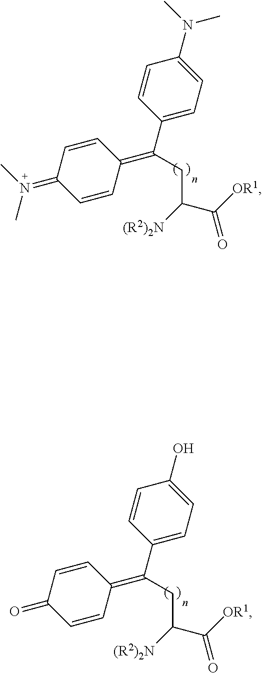
or a salt, tautomer, or isotopically labeled derivative thereof, wherein:
n is an integer from 1-6, inclusive.

44. The compound of any one of the preceding claims, wherein the compound is of one of the following formulae: 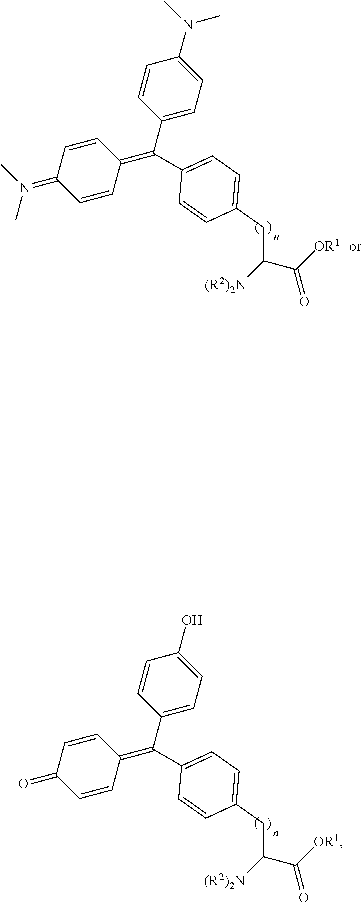
or a salt, tautomer, or isotopically labeled derivative thereof, wherein:
n is an integer from 1-6, inclusive.

45. The compound of any one of the preceding claims, wherein the compound is of the following formula: 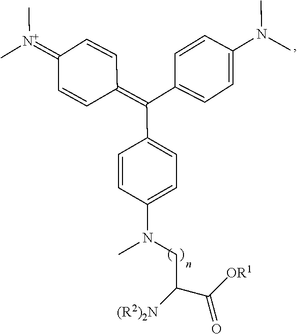
or a salt, tautomer, or isotopically labeled derivative thereof, wherein:

46. The compound of any one of the preceding claims, wherein n is 1, 2, or 3.

47. The compound of any one of the preceding claims, wherein the compound is of one of the following formulae: 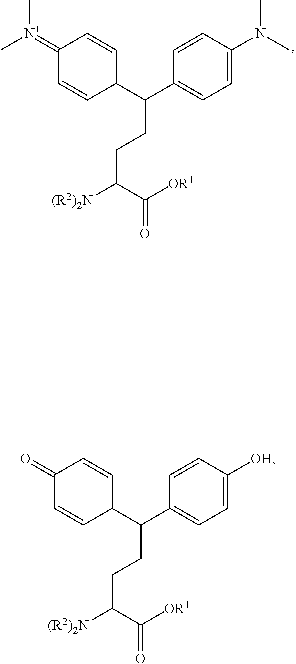
or a salt, tautomer, or isotopically labeled derivative thereof.

48. The compound of any one of the preceding claims, wherein the compound is of one of the following formulae: 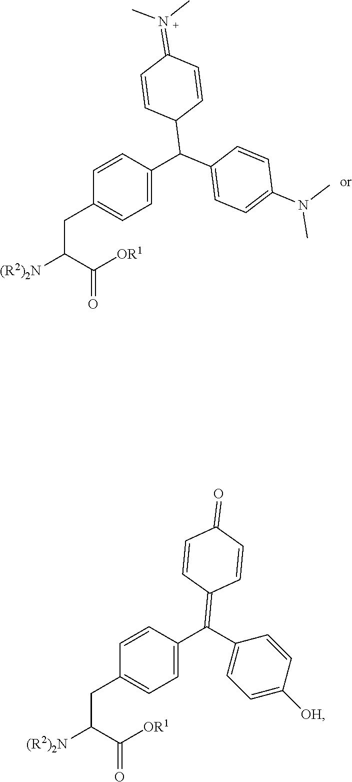
or a salt, tautomer, or isotopically labeled derivative thereof.

49. The compound of any one of the preceding claims, wherein the compound is of the formula: 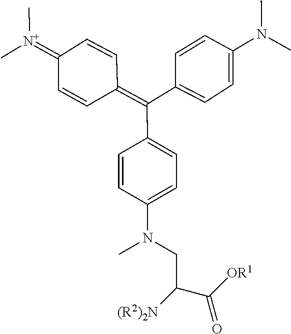
or a salt, tautomer, or isotopically labeled derivative thereof.

50. The compound of any one of the preceding claims, wherein R¹ is hydrogen.

51. The compound of any one of the preceding claims, wherein at least one instance of R² is hydrogen.

52. The compound of any one of the preceding claims, wherein each instance of R² is hydrogen.

53. The compound of claim 1, wherein the compound is selected from the group consisting of: 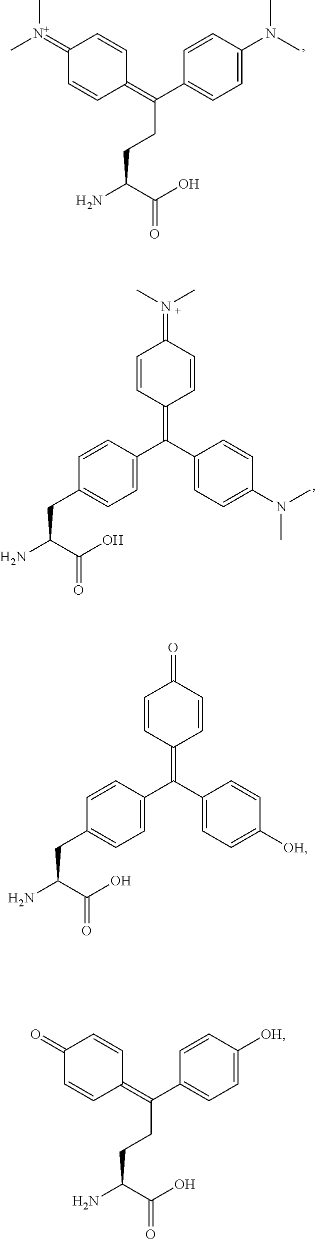 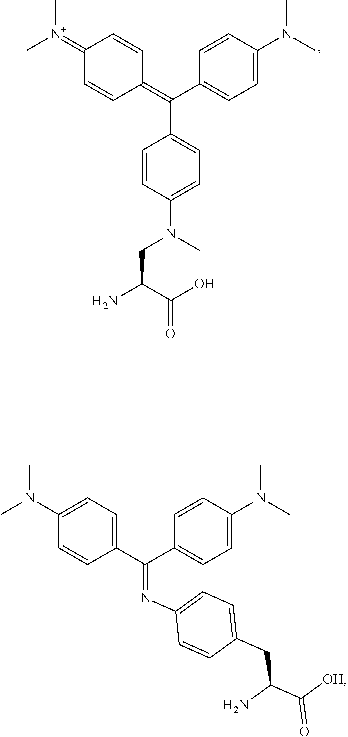
and salts, tautomers, or isotopically labeled derivatives thereof.

54. A compound of Formula (II): 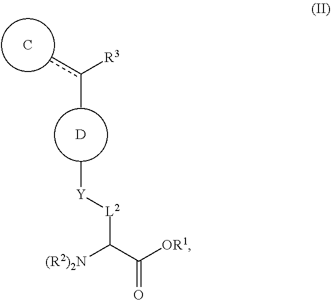
or a salt, tautomer, or isotopically labeled derivative thereof, wherein:
Ring D is optionally substituted aryl or optionally substituted heteroaryl;
R³ is hydrogen, ═NR^{NX}, —N—R^{NX}, ═S, —S⁻, ═O, —O⁻, ═C(R^{C})₂, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl; [symbol]
is a single or double bond, provided that when [symbol] is a single bond, R³ is ═NR^{NX} ═S, ═O or ═C(R^{C})₂, and provided that when [symbol] is a double bond, R³ is not ═NR^{NX}, ═S, ═O or ═C(R^{C})₂;
Ring C is an optionally substituted heterocyclic or heteroaryl ring comprising at least one N, S, or O atom; wherein the heterocyclic or heteroaryl ring is in conjugation with the group: 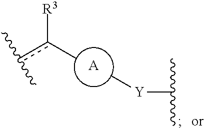
Ring C is an optionally substituted carbocyclic, optionally substituted heterocyclic, optionally substituted aryl, or optionally substituted heteroaryl ring substituted with [symbol] Y^{C} and comprising at least one double bond in conjugation with Y^{C} and the group: 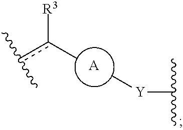 [symbol]
Y^{C} is —N(R^{N1})₂, ═N⁺(R^{N1})₂, ═NR^{N1}₂—OR^{O1}, ═O⁺R^{O1}, ═O, —SR^{S1}, ═S⁺R^{S1}, or ═S;
Y is a bond, —O—, —NR^{N2}—, or —S—;
L² is a bond, optionally substituted alkylene, optionally substituted heteroalkylene, optionally substituted alkenylene, optionally substituted alkynylene, optionally substituted carbocyclylene, optionally substituted arylene, optionally substituted heterocyclylene, optionally substituted heteroarylene, optionally substituted acylene, or a combination thereof;
R¹ is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, an oxygen protecting group, an amino acid, or a polypeptide;
each instance of R² is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, a nitrogen protecting group, an amino acid, or a polypeptide; or two R² bonded to the same nitrogen atom are taken together with the intervening atoms to form optionally substituted heterocyclyl or optionally substituted heteroaryl;
each instance of R^{N1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N1} bonded to the same nitrogen atom are taken together with the intervening atoms to form optionally substituted heterocyclyl or optionally substituted heteroaryl;
R^{N2} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group;
R^{NX} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group;
each instance of R^{O1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
each instance of R^{C} is independently hydrogen, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl; optionally wherein two R^{C} on the same carbon atom are joined together with the intervening atoms to form optionally substituted carbocyclyl or optionally substituted heterocyclyl.

55. The compound of any one of the preceding claims, wherein Ring C is a 6-membered optionally substituted carbocyclic or 6-membered optionally substituted heterocyclic ring substituted with [symbol] Y^{C}.

56. The compound of any one of the preceding claims, wherein the compound is of one of the following formula: 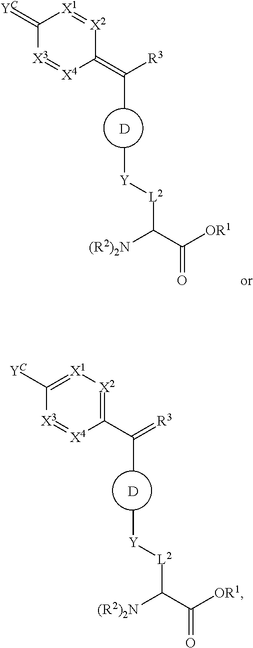
or a salt, tautomer, or isotopically labeled derivative thereof, wherein:
each of X¹, X², X³, and X⁴ are independently N or CR⁴;
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group; and
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group.

57. The compound of any one of the preceding claims, wherein the compound is of the formula: 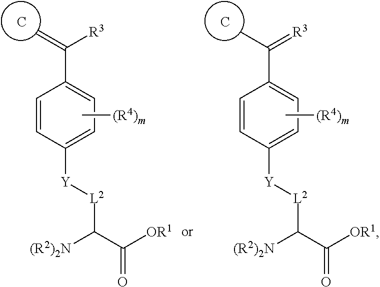
or a salt, tautomer, or isotopically labeled derivative thereof, wherein:
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
m is 0, 1, 2, 3, or 4.

58. The compound of any one of the preceding claims, wherein the compound is of the formula: 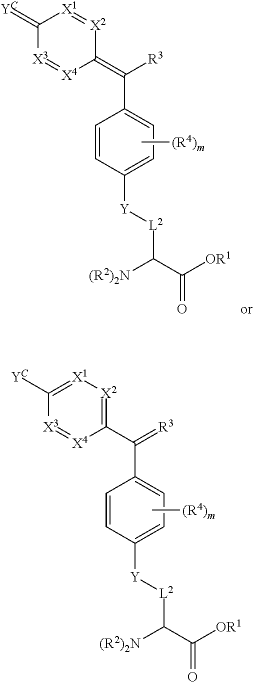
or a salt, tautomer, or isotopically labeled derivative thereof.

59. The compound of any one of the preceding claims, wherein X¹ is CR⁴.

60. The compound of any one of the preceding claims, wherein X² is CR⁴.

61. The compound of any one of the preceding claims, wherein X³ is CR⁴.

62. The compound of any one of the preceding claims, wherein X⁴ is CR⁴.

63. The compound of any one of the preceding claims, wherein Ring C is an optionally C₆ carbocyclic ring.

64. The compound of any one of the preceding claims, wherein Ring C is an optionally substituted cyclohexadienyl ring.

65. The compound of any one of the preceding claims, wherein Ring C is of the formula: 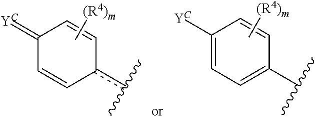
wherein:
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
m is 0, 1, 2, 3, or 4.

66. The compound of any one of the preceding claims, wherein the compound is of the formula: 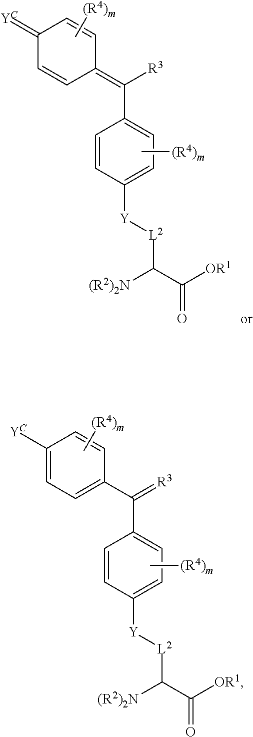
or a salt, tautomer, or isotopically labeled derivative thereof.

67. The compound of any one of the preceding claims, wherein ═Y^{C} is ═N⁺(R^{N1})₂.

68. The compound of any one of the preceding claims, wherein the compound is of the formula: 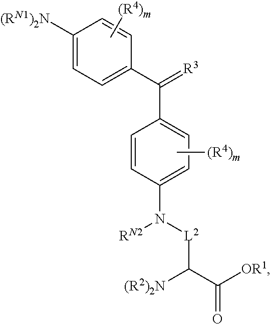
or a salt, tautomer, or isotopically labeled derivative thereof.

69. The compound of any one of the preceding claims, wherein the compound is of the formula: 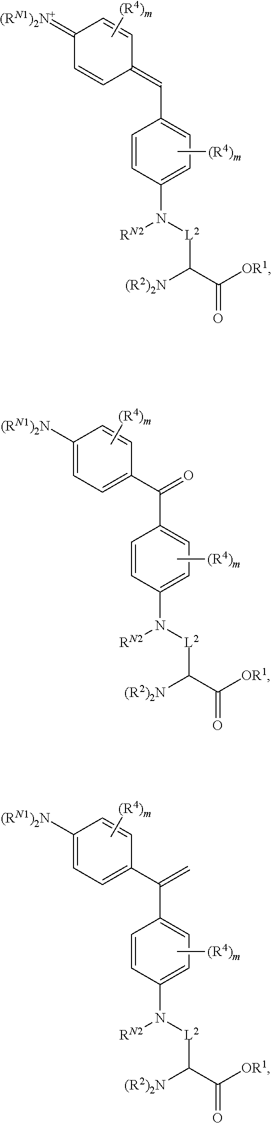
or a salt, tautomer, or isotopically labeled derivative thereof.

70. The compound of any one of the preceding claims, wherein the compound is of the formula: 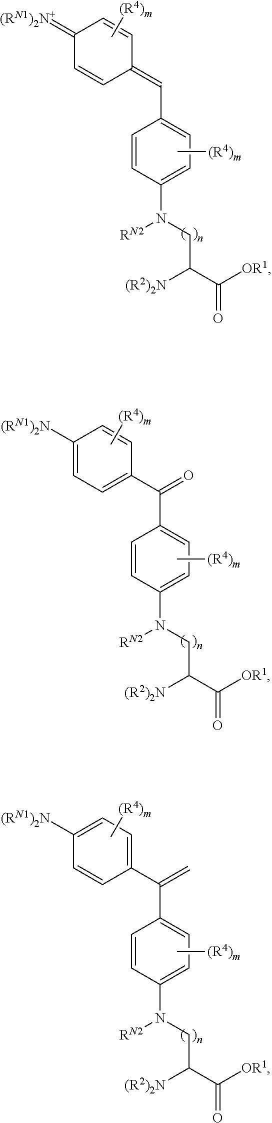
or a salt, tautomer, or isotopically labeled derivative thereof,
wherein n is an integer from 1-6, inclusive.

71. The compound of any one of the preceding claims, wherein the compound is of the following formula: 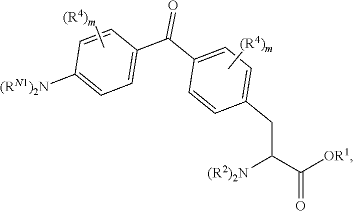
or a salt, tautomer, or isotopically labeled derivative thereof.

72. The compound of any one of the preceding claims, wherein the compound is of the formula: 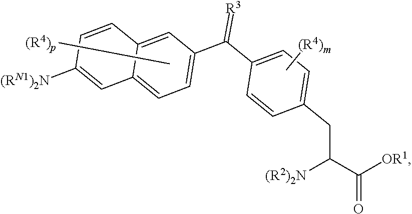
or a salt, tautomer, or isotopically labeled derivative thereof, wherein p is 0, 1, 2, 3, 4, 5, or 6.

73. The compound of any one of the preceding claims, wherein at least one instance of R^{N1} is hydrogen.

74. The compound of any one of the preceding claims, wherein each instance of R^{N1} is hydrogen.

75. The compound of any one of the preceding claims, wherein the compound is of the formula: 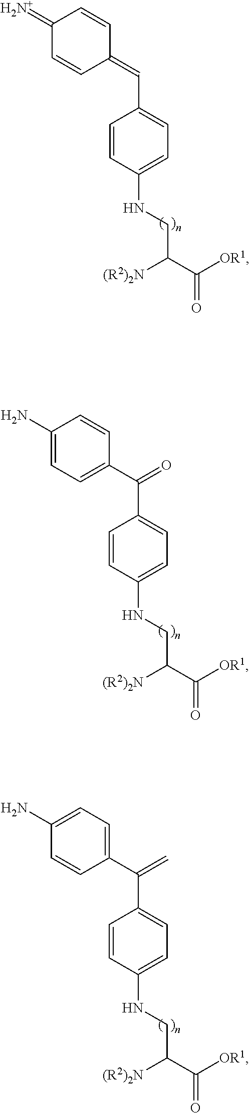
or a salt, tautomer, or isotopically labeled derivative thereof.

76. The compound of any one of the preceding claims, wherein the compound is of the formula: 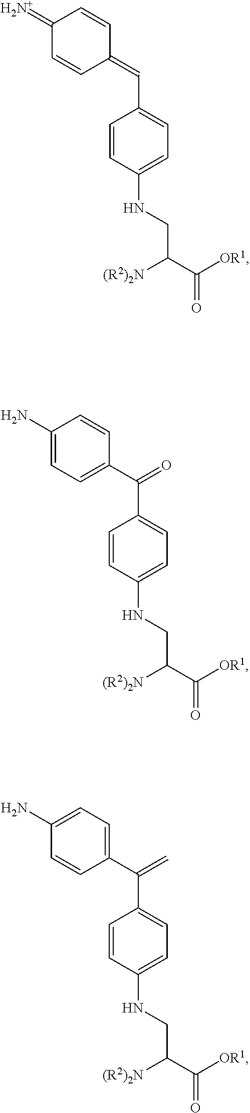
or a salt, tautomer, or isotopically labeled derivative thereof.

77. The compound of any one of the preceding claims, wherein Ring C is an optionally substituted heterocyclic ring.

78. The compound of any one of the preceding claims, wherein Ring C is an optionally substituted 5-membered heterocyclic ring.

79. The compound of any one of the preceding claims, wherein Ring C is of the formula: 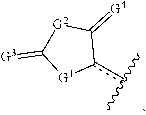
wherein each of G¹, G², G³, and G⁴ is independently selected from the group consisting of O, S, and NR^{N3}; and
each instance of R^{N3} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group.

80. The compound of any one of the preceding claims, wherein the compound is of the formula: 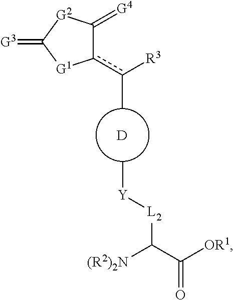
or a salt, tautomer, or isotopically labeled derivative thereof.

81. The compound of any one of the preceding claims, wherein Ring D is optionally substituted aryl.

82. The compound of any one of the preceding claims, wherein Ring D is optionally substituted phenyl.

83. The compound of any one of the preceding claims, wherein Ring D is of the formula: 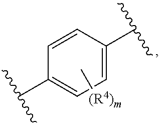
wherein:
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group;
and m is 0, 1, 2, 3, or 4.

84. The compound of any one of the preceding claims, wherein the compound is of the formula: 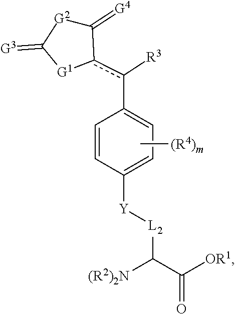
or a salt, tautomer, or isotopically labeled derivative thereof.

85. The compound of any one of the preceding claims, wherein the compound is of the formula: 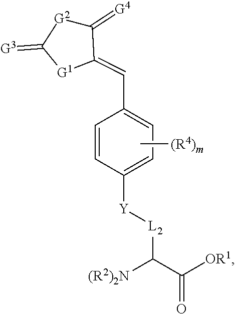
or a salt, tautomer, or isotopically labeled derivative thereof.

86. The compound of any one of the preceding claims, wherein G¹ is S.

87. The compound of any one of the preceding claims, wherein G² is NR^{N3}.

88. The compound of any one of the preceding claims, wherein G³ is S.

89. The compound of any one of the preceding claims, wherein G⁴ is O.

90. The compound of any one of the preceding claims, wherein the compound is of the formula: 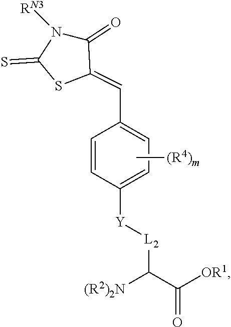
or a salt, tautomer, or isotopically labeled derivative thereof.

91. The compound of any one of the preceding claims, wherein Y is —NR^{N2}—.

92. The compound of any one of the preceding claims, wherein the compound is of the formula: 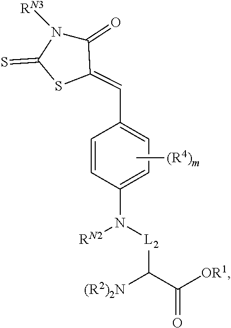
or a salt, tautomer, or isotopically labeled derivative thereof.

93. The compound of any one of the preceding claims, wherein L² is optionally substituted alkylene.

94. The compound of any one of the preceding claims, wherein L² is optionally substituted C₁₋₆ alkylene.

95. The compound of any one of the preceding claims, wherein L² is unsubstituted C₁₋₆ alkylene.

96. The compound of any one of the preceding claims, wherein the compound is of the formula: 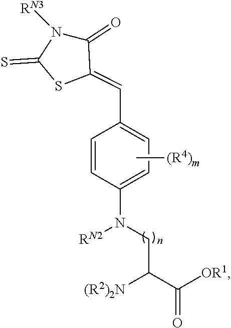
or a salt, tautomer, or isotopically labeled derivative thereof,
wherein n is an integer from 1-6, inclusive.

97. The compound of any one of the preceding claims, wherein each instance of m is 0.

98. The compound of any one of the preceding claims, wherein each instance of R⁴ is hydrogen.

99. The compound of any one of the preceding claims, wherein R^{N2} is hydrogen.

100. The compound of any one of the preceding claims, wherein each instance of R^{N3} is hydrogen.

101. The compound of any one of the preceding claims, wherein the compound is of the formula: 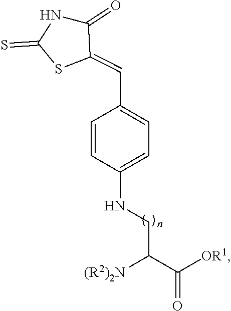
or a salt, tautomer, or isotopically labeled derivative thereof.

102. The compound of any one of the preceding claims, wherein n is 1, 2, or 3.

103. The compound of any one of the preceding claims, wherein the compound is of the formula: 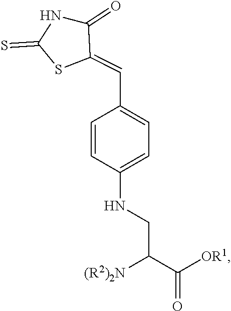
or a salt, tautomer, or isotopically labeled derivative thereof.

104. The compound of any one of the preceding claims, wherein R¹ is hydrogen.

105. The compound of any one of the preceding claims, wherein at least one instance of R² is hydrogen.

106. The compound of any one of the preceding claims, wherein each instance of R² is hydrogen.

107. The compound of any one of the preceding claims, wherein [symbol] is a single bond; and
R³ is ═O.

108. The compound of any one of the preceding claims, wherein [symbol] a double bond.

109. The compound of any one of the preceding claims, wherein [symbol] is a double bond; and
R³ is hydrogen.

110. The compound of any one of the preceding claims, wherein the compound is selected from the group consisting of: 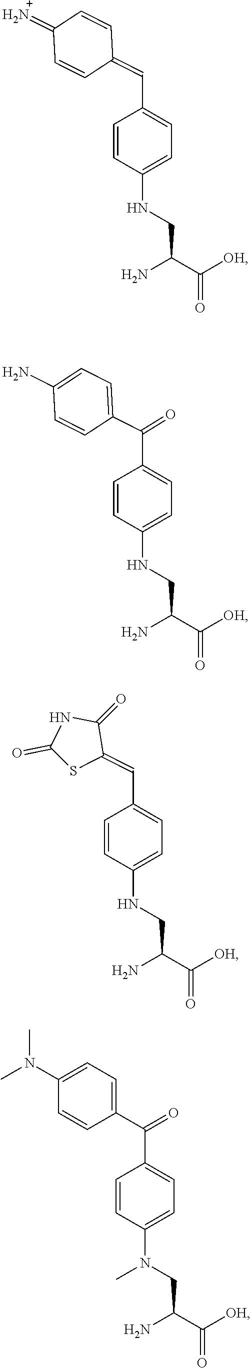 [SMILES: N[C@@H](CNc1ccc(C=C2C=CC(=[NH2+])C=C2)cc1)C(=O)O ; Nc1ccc(C(=O)c2ccc(NC[C@H](N)C(=O)O)cc2)cc1 ; N[C@@H](CNc1ccc(/C=C2\SC(=O)NC2=O)cc1)C(=O)O ; CN(C)c1ccc(C(=O)c2ccc(N(C)C[C@H](N)C(=O)O)cc2)cc1] 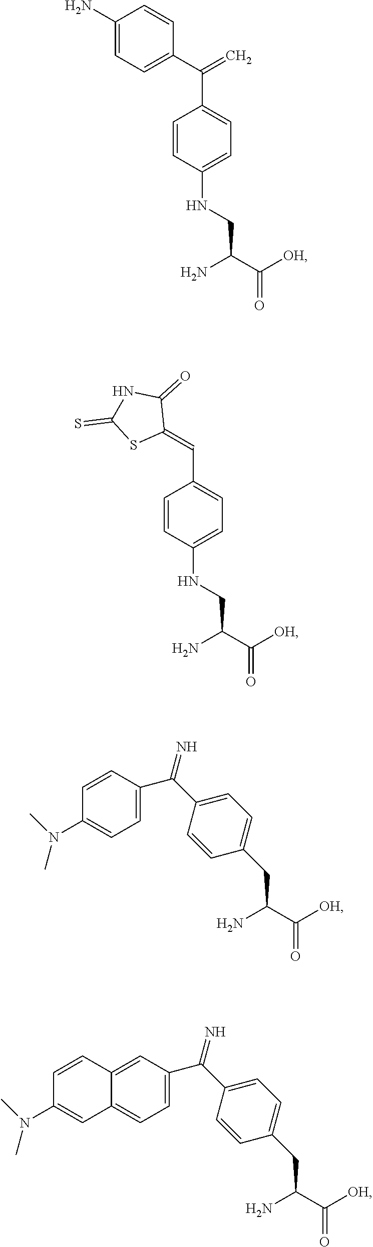 [SMILES: C=C(c1ccc(N)cc1)c1ccc(NC[C@H](N)C(=O)O)cc1 ; N[C@@H](CNc1ccc(/C=C2\SC(=S)NC2=O)cc1)C(=O)O ; CN(C)c1ccc(C(=N)c2ccc(C[C@H](N)C(=O)O)cc2)cc1 ; CN(C)c1ccc2cc(C(=N)c3ccc(C[C@H](N)C(=O)O)cc3)ccc2c1]
and salts, tautomers, and isotopically labeled derivatives thereof.

111. A compound of Formula (III): 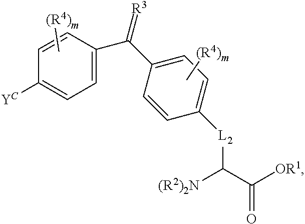
and salts, tautomers, and isotopically labeled derivatives thereof, wherein:
R³ is ═NR^{NX}, ═S, ═O, or ═C(R^{C})₂;
—Y^{C} is —N(R^{N1})₂, —OR^{O1}, or —SR^{S1};
L² is a bond, optionally substituted alkylene, optionally substituted heteroalkylene, optionally substituted alkenylene, optionally substituted alkynylene, optionally substituted carbocyclylene, optionally substituted arylene, optionally substituted heterocyclylene, optionally substituted heteroarylene, optionally substituted acylene, or a combination thereof;
R¹ is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, an oxygen protecting group, an amino acid, or a polypeptide;
each instance of R² is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, a nitrogen protecting group, an amino acid, or a polypeptide; or two R² bonded to the same nitrogen atom are taken together with the intervening atoms to form optionally substituted heterocyclyl or optionally substituted heteroaryl;
each instance of R^{N1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N1} bonded to the same nitrogen atom are taken together with the intervening atoms to form optionally substituted heterocyclyl or optionally substituted heteroaryl;
R^{N2} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group;
R^{NX} is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group;
each instance of R^{O1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group;
each instance of R^{C} is independently hydrogen, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl, optionally wherein two R^{C} on the same carbon atom are joined together with the intervening atoms to form optionally substituted carbocyclyl or optionally substituted heterocyclyl;
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
m is 0, 1, 2, 3, or 4.

112. The compound of any one of the preceding claims, wherein compound is of one of the following formulae: 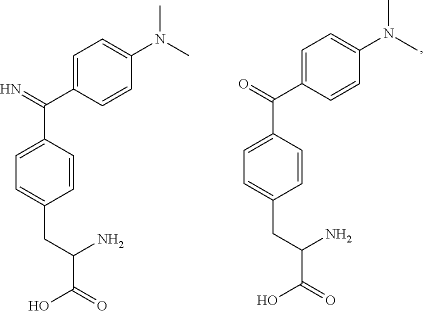 [SMILES: CN(C)c1ccc(C(=N)c2ccc(CC(N)C(=O)O)cc2)cc1 ; CN(C)c1ccc(C(=O)c2ccc(CC(N)C(=O)O)cc2)cc1]
or a salt, tautomer, or isotopically labeled derivative thereof.

113. A compound of Formula (IV): 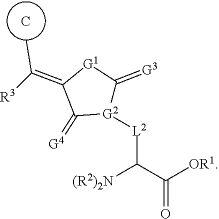
or a salt, tautomer, or isotopically labeled derivative thereof, wherein:
Ring C is an optionally substituted aryl ring, or optionally substituted heteroaryl ring comprising at least one N, S, or O atom; wherein Ring C is substituted with —Y^{C};
Y^{C} is —N(R^{N1})₂, —OR^{O1}, —SR^{S1},
each of G¹, G³, and G⁴ is independently selected from the group consisting of O, S, and NR^{N3}; G² is N;
R³ is hydrogen, halogen, —CN, optionally substituted alkyl, optionally substituted alkenyl, optionally substituted alkynyl, optionally substituted aryl, optionally substituted heteroaryl, optionally substituted carbocyclyl, optionally substituted heterocyclyl, or optionally substituted acyl;
L² is a bond, optionally substituted alkylene, optionally substituted heteroalkylene, optionally substituted alkenylene, optionally substituted alkynylene, optionally substituted carbocyclylene, optionally substituted arylene, optionally substituted heterocyclylene, optionally substituted heteroarylene, optionally substituted acylene, or a combination thereof;
R¹ is hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, an oxygen protecting group, an amino acid, or a polypeptide;
each instance of R² is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, a nitrogen protecting group, an amino acid, or a polypeptide; or two R² bonded to the same nitrogen atom are taken together with the intervening atoms to form optionally substituted heterocyclyl or optionally substituted heteroaryl;
each instance of R^{N1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N1} bonded to the same nitrogen atom are taken together with the intervening atoms to form optionally substituted heterocyclyl or optionally substituted heteroaryl;
each instance of R^{O1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S1} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group;
each instance of R^{N3} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group.

114. The compound of any one of the preceding claims, wherein the compound is of the formula: 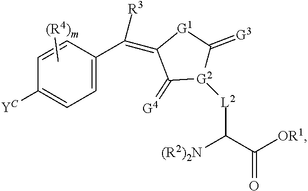
or a salt, tautomer, or isotopically derivative thereof, wherein:
each instance of R⁴ is independently hydrogen, halogen, —CN, —NO₂, —N₃, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl optionally substituted sulfonyl, optionally substituted sulfinyl, sulfate, sulfonate, —N(R^{N})₂, —OR^{O}, or —SR^{S};
each instance of R^{N} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a nitrogen protecting group; or two R^{N} bonded to the same nitrogen atom are taken together with the intervening atoms to form optionally substituted heterocyclyl or optionally substituted heteroaryl;
each instance of R^{O} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or an oxygen protecting group;
each instance of R^{S} is independently hydrogen, optionally substituted alkyl, optionally substituted alkenyl, optionally substituted alkynyl, optionally substituted aryl, optionally substituted heteroaryl, optionally substituted carbocyclyl, optionally substituted heterocyclyl, optionally substituted acyl, or a sulfur protecting group; and
m is 0, 1, 2, 3, or 4.

115. The compound of any one of the preceding claims, wherein the compound is one of the following formulae: 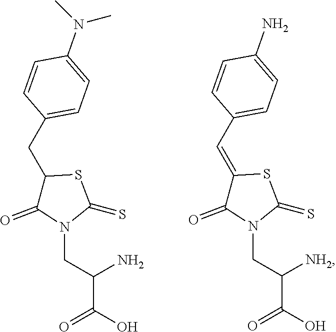 [SMILES: CN(C)c1ccc(CC2SC(=S)N(CC(N)C(=O)O)C2=O)cc1 ; Nc1ccc(/C=C2\SC(=S)N(CC(N)C(=O)O)C2=O)cc1]
or a salt, tautomer, or isotopically derivative thereof.

116. The compound of any one of the preceding claims, wherein the compound is a D-amino acid.

117. The compound of any one of the preceding claims, wherein the compound is an L-amino acid.

118. A composition comprising a compound of any one of the preceding claims; and a solvent or excipient.

119. A biomolecule comprising a compound of any one of the preceding claims, or a salt or a tautomer thereof, wherein the compound is covalently attached to to the biomolecule.

120. The biomolecule of any one of the preceding claims, wherein the biomolecule is a protein, polypeptide, glycan, peptidoglycan, antibody, or nucleic acid.

121. The biomolecule of any one of the preceding claims, wherein the biomolecule is a protein.

122. The biomolecule of any one of the preceding claims, wherein the biomolecule is peptidoglycan.

123. A cell comprising a compound of any one of the preceding claims, or a salt, tautomer, or isotopically labeled derivative thereof.

124. The cell of any one of the preceding claims, wherein the cell is a mammalian cell.

125. The cell of any one of the preceding claims, wherein the cell is a bacterial cell.

126. A method of labeling a biomolecule, the method comprising exposing the biomolecule and/or cell to a compound of any one of the preceding claims, or a salt, tautomer, or isotopically labeled derivative thereof.

127. The method of any one of the preceding claims, wherein the compound is covalently incorporated into the biomolecule.

128. The method of any one of the preceding claims, wherein the compound is incorporated into biomolecule via enzymatic incorporation.

129. The method of any one of the preceding claims, where the compound is incorporated into the biomolecule through transpeptidation.

130. The method of any one of the preceding claims, wherein the compound is incorporated into a protein, polypeptide, or peptidoglycan via transpeptidation.

131. The method of any one of the preceding claims, wherein the compound is incorporated into peptidoglycan.

132. The method of any one of the preceding claims, where the compound is incorporated into the biomolecule and/or cell through D,D-transpeptidation or L,D-transpeptidation.

133. A method of labeling a cell, the method comprising exposing the cell to a compound of any one of the preceding claims, or a salt, tautomer, or isotopically labeled derivative thereof.

134. The method of any one of the preceding claims, wherein the compound is covalently incorporated into the cell.

135. The method of any one of the preceding claims, wherein the compound is incorporated into the cell via enzymatic incorporation.

136. The method of any one of the preceding claims, where the compound is incorporated into the cell through transpeptidation.

137. The method of any one of the preceding claims, wherein the compound is incorporated into a protein, polypeptide, or peptidoglycan via transpeptidation.

138. The method of any one of the preceding claims, wherein the compound is incorporated into peptidoglycan.

139. The method of any one of the preceding claims, where the compound is incorporated into the biomolecule and/or cell through D,D-transpeptidation or L,D-transpeptidation.

140. A method of detecting a biomolecule and/or cell comprising:
(a) labeling the biomolecule or cell according to a method of any one of the preceding claims; and
(b) measuring the fluorescence of the biomolecule and/or cell.

141. The method of any one of the preceding claims, wherein the biomolecule is a protein, polypeptide, or peptidoglycan

142. A method of detecting a labeled biomolecule or cell of any one of the preceding claims, the method comprising measuring or observing the fluorescence of the biomolecule or cell.

143. The method of any one of the preceding claims, wherein the biomolecule is a protein.

144. The method of any one of the preceding claims, wherein the biomolecule is peptidoglycan.

145. The method of any one of the preceding claims, wherein the cell is mammalian cell.

146. The method of any one of the preceding claims, wherein the cell is a bacterial cell.

147. A kit comprising a compound of any one of the preceding claims, or a salt, tautomer, or isotopically labeled derivative thereof, or a composition thereof; and one or more chemical reagents or enzymes.
